(19) United States
(12) Patent Application Publication
(10) Pub. No.: US 2021/0095610 A1
(43) Pub. Date: Apr. 1, 2021

(54) INTERNAL COMBUSTION ENGINE, STATE DETERMINATION SYSTEM FOR INTERNAL COMBUSTION ENGINE, DATA ANALYSIS DEVICE, AND CONTROL DEVICE FOR INTERNAL COMBUSTION ENGINE

(71) Applicant: TOYOTA JIDOSHA KABUSHIKI KAISHA, Toyota-shi (JP)

(72) Inventors: Yohsuke HASHIMOTO, Nagakute-shi (JP); Akihiro KATAYAMA, Toyota-shi (JP); Yuta OSHIRO, Nagoya-shi (JP); Kazuki SUGIE, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 16/922,259

(22) Filed: Jul. 7, 2020

(30) Foreign Application Priority Data
Sep. 27, 2019 (JP) 2019-177442

(51) Int. Cl. F02D 41/22; F02D 41/26; F02D 41/14; F02D 41/00; F02D 41/30; F02D 41/02; F02D 41/24; F02M 26/49; F02D 9/08; F02M 25/06; F02M 25/08; F02M 39/02; F01P 5/10; F01P 3/02; F01P 3/18; F01P 7/16

(52) U.S. Cl. CPC F02D 41/22; F01P 2025/66; F02D 41/1498; F02D 41/009; F02D 41/1454; F02D 41/3005; F02D 41/024; F02D 41/2438; F02D 41/2477; F02D 41/0077; F02M 26/49; F02D 9/08; F02M 25/06; F02M 25/0836; F02M 25/0818; F02M 39/02; F01P 5/10; F01P 3/02; F01P 3/18; F01P 7/161; F02D 41/0085; F02D 41/0295; F02D 41/0032; F02D 2200/703; F02D 2200/101; F02D 2200/0614; F02D 2200/04; F02D 2200/0812; F02D 2200/0804; F02D 2200/021; F02D 2200/025; F02D 2200/0606; F01P 2007/168; F01P 2003/028; F01P 2025/13; F02D 41/26

(57) ABSTRACT

An internal combustion engine includes a state determination device. The state determination device includes a storage device and an execution device. The execution device executes an acquisition process, and a determination process. The execution device executes a guard process of bringing an internal combustion engine state variable closer to an allowable range or a value within the allowable range when the internal combustion engine state variable acquired in the acquisition process is out of the predetermined allowable range. The execution device determines the state of the internal combustion engine based on the internal combustion engine state variable after the guard process in the subsequent determination process when the guard process is executed.

### INCORPORATION BY REFERENCE

The disclosure of Japanese Patent Application No. 2019-177442 filed on Sep. 27, 2019 including the specification, drawings and abstract is incorporated herein by reference in its entirety.

### BACKGROUND

### 1. Technical Field

The disclosure relates to an internal combustion engine, a state determination system for an internal combustion engine, a data analysis device, and a control device for an internal combustion engine.

### 2. Description of Related Art

In a misfire detection system disclosed in Japanese Unexamined Patent Application Publication No. 4-91348 (JP 4-91348 A), a hierarchical neural network model configured to input, to an input layer, time-series data of a rotation speed of a crankshaft of an internal combustion engine sampled at each specified cycle and output information on a cylinder in which a misfire has occurred from an output layer is used. The hierarchical neural network model has been subjected to supervised learning.

### SUMMARY

In the misfire detection system as disclosed in JP 4-91348 A, in the hierarchical neural network model, a parameter corresponding to the rotation speed of the crankshaft of the internal combustion engine may exceed an allowable data range, and data may be input to the input layer. In the misfire detection system using the hierarchical neural network model, even when data exceeding an allowable range is input to the input layer as described above, processing is performed based on learned information, and the information is output from the output layer. However, when data exceeding an allowable range is input to the input layer, there is a possibility that unexpected information is output as information output from the output layer by the hierarchical neural network model.

A first aspect of the disclosure is an internal combustion engine. The internal combustion engine includes a state determination device. The state determination device includes a storage device and an execution device. The storage device is configured to store mapping data that is data defining a mapping that outputs a determination result of a state of the internal combustion engine by using, as an input, an internal combustion engine state variable that is a parameter indicating the state of the internal combustion engine. The execution device is configured to execute an acquisition process of acquiring the internal combustion engine state variable, and a determination process of determining the state of the internal combustion engine based on an output of the mapping using the internal combustion engine state variable as an input. The mapping data is data that has been learned by machine learning. The execution device is configured to, when the internal combustion engine state variable acquired in the acquisition process is out of a predetermined allowable range, execute a guard process of bringing the internal combustion engine state variable closer to the allowable range or making the internal combustion engine state variable be a value within the allowable range. The execution device is configured to, when the guard process is executed, determine the state of the internal combustion engine based on the internal combustion engine state variable acquired after the guard process, in the subsequent determination process.

With the above configuration, in a case where the value input when executing the determination process is out of the allowable range, the value is set closer to or within the allowable range than the acquired value of the internal combustion engine state variable. Therefore, it is possible to suppress the value input to the mapping from being excessively large or small. As a result, the output of the mapping is suppressed from becoming an unexpected value.

In the internal combustion engine, the allowable range may be set within a range of data input when the data is learned by the machine learning. With the above configuration, when the internal combustion engine state variable acquired in the acquisition process is out of the range of the data input when the mapping defined by the mapping data is learned, the guard process is performed. Therefore, it is possible to suppress the value input to the mapping from becoming excessively large with respect to the data input at the time of learning.

In the internal combustion engine, the execution device may be configured to, when the internal combustion engine state variable acquired in the acquisition process is larger than the allowable range, execute a guard process of matching the internal combustion engine state variable to an upper limit value of the allowable range. The execution device may be configured to, when the internal combustion engine state variable acquired in the acquisition process is smaller than the allowable range, execute a guard process of matching the internal combustion engine state variable to a lower limit value of the allowable range.

With the above configuration, when the internal combustion engine state variable outside the allowable range is acquired, the internal combustion engine state variable is set to a value closest to the value before the guard process which is a value within the allowable range. While following the value of the internal combustion engine state variable before the guard process, the output of the mapping is suppressed from becoming an unexpected result.

In the internal combustion engine, the state of the internal combustion engine may be an estimated value of a temperature of a catalyst provided in an exhaust passage of the internal combustion engine. The mapping data may be data defining a mapping that outputs the estimated value of the temperature of the catalyst by using, as an input, at least one of an outside air temperature variable and an excess amount variable, a fluid energy variable, and a previous value of the estimated value of the temperature of the catalyst, the outside air temperature variable being a variable related to a temperature of outside air around the internal combustion engine. The excess amount variable may be a variable corresponding to an excess amount of an actual injection amount with respect to an amount of fuel needed for setting an air-fuel ratio of an air-fuel mixture in a combustion chamber of the internal combustion engine to a stoichiometric air-fuel ratio, the fluid energy variable being a state variable related to an energy of a fluid flowing into the catalyst. The execution device may be configured to acquire the at least one variable, the fluid energy variable, and the previous value of the estimated value, in the acquisition process. With the above configuration, the technique for the guard process can be applied in estimating a temperature of a catalyst.

In the internal combustion engine, the state of the internal combustion engine may be a presence or absence of a misfire of the internal combustion engine. The mapping data may be data defining a mapping that outputs a probability that the misfire has occurred in the internal combustion engine by using, as an input, time-series data that is an instantaneous speed parameter at each of a plurality of continuous second intervals included in a first interval. The execution device may be configured to acquire the instantaneous speed parameter based on a detection value of a sensor that detects a rotation behavior of a crankshaft of the internal combustion engine in the acquisition process. The instantaneous speed parameter may be a parameter corresponding to a rotation speed of the crankshaft of the internal combustion engine. The first interval may be a rotation angle interval of the crankshaft and includes a compression top dead center. The second interval may be smaller than an appearance interval of the compression top dead center. The mapping may output a probability that the misfire has occurred in at least one cylinder in which the compression top dead center appears within the first interval. With the above configuration, the technique for the guard process can be applied in making a misfire determination.

In the internal combustion engine, the state of the internal combustion engine may be a variation in air-fuel ratio between a plurality of cylinders included in the internal combustion engine. The mapping data may be data defining a mapping that outputs an imbalance variable by using, as an input, a rotation waveform variable and an air-fuel ratio detection variable. The imbalance variable may be a variable indicating a degree of variation between actual air-fuel ratios when a fuel injection valve is operated to control air-fuel ratios of air-fuel mixtures in the respective cylinders to be equal to each other. The air-fuel ratio detection variable may be a variable corresponding to an output of an air-fuel ratio sensor at each of a plurality of third intervals. The execution device may be configured to acquire the rotation waveform variable based on a detection value of a sensor that detects a rotation behavior of a crankshaft, in the acquisition process and the air-fuel ratio detection variable at each of the third intervals. The rotation waveform variable may be a variable indicating a difference between instantaneous speed variables that are variables corresponding to the rotation speed of the crankshaft at each of a plurality of fourth intervals. Both the third interval and the fourth interval may be angle intervals of the crankshaft smaller than an appearance interval of a compression top dead center. The rotation waveform variable and a plurality of the air-fuel ratio detection variables that are used as an input of the mapping may be time-series data within a predetermined angle interval larger than the appearance interval. With the above configuration, the technique for the guard process can be applied in detecting a variation in air-fuel ratio between a plurality of cylinders.

In the internal combustion engine, the state of the internal combustion engine may be a degree of deterioration of a catalyst provided in an exhaust passage of the internal combustion engine. The mapping data is data defining a mapping that outputs a deterioration degree variable by using, as an input, time-series data of an excess amount variable in a first predetermined period, and time-series data of a downstream detection value in a second predetermined period. The deterioration degree variable may be a variable related to the degree of deterioration of the catalyst. The excess amount variable may be a variable corresponding to an excess amount of an actual injection amount with respect to an amount of fuel needed for setting an air-fuel ratio of an air-fuel mixture in a combustion chamber of the internal combustion engine to a stoichiometric air-fuel ratio, the downstream detection variable being a variable corresponding to a detection value of an air-fuel ratio sensor on a downstream side of the catalyst. The execution device may be configured to acquire the time-series data of the excess amount variable in the first predetermined period and the time-series data of the downstream detection variable in the second predetermined period, in the acquisition process. With the above configuration, the technique for the guard process can be applied in determining the degree of deterioration of the catalyst provided in an exhaust passage of the internal combustion engine.

In the internal combustion engine, the state of the internal combustion engine may be a presence or absence of an abnormality in a warm-up process of a catalyst provided in an exhaust passage of the internal combustion engine. The storage device may be configured to store association data that associates an integrated value of an intake air amount of the internal combustion engine from a start of the internal combustion engine with a temperature of the catalyst. The mapping data may be data defining a mapping that outputs an estimated value of the temperature of the catalyst by using, as an input, a warm-up operation amount variable and a previous value of the estimated value of the temperature of the catalyst. The warm-up operation amount variable may be a variable related to an operation amount of an operation unit of the internal combustion engine that is used for the warm-up process of the catalyst. The execution device may be configured to: acquire the warm-up operation amount variable and the previous value of the estimated value of the temperature of the catalyst, in the acquisition process; and determine that the warm-up process is abnormal when a correspondence between the integrated value of the intake air amount of the internal combustion engine from the start of the internal combustion engine and the estimated value of the temperature of the catalyst is different from a correspondence between the integrated value of the intake air amount of the internal combustion engine from the start of the internal combustion engine and the temperature of the catalyst in the association data, in the determination process. With the above configuration, the technique for the guard process can be applied in determining the presence or absence of an abnormality in a warm-up process of the catalyst provided in the exhaust passage of the internal combustion engine.

In the internal combustion engine, the state of the internal combustion engine may be an estimated value of an oxygen storage amount of a catalyst provided in an exhaust passage of the internal combustion engine. The mapping data may be data defining a mapping that outputs a storage amount variable by using, as an input, an excess or deficiency amount variable and a plurality of variables including some of previous values of the storage amount variable that is a variable related to the oxygen storage amount of the catalyst. The storage amount variable may be a variable corresponding to an excess or deficiency amount of an actual fuel amount with respect to an amount of fuel that reacts with an oxygen contained in a fluid flowing into the catalyst without excess or deficiency. The execution device may be configured to acquire the plurality of variables in the acquisition process. With the above configuration, the technique for the guard process can be applied in determining an estimated value of an oxygen storage amount of the catalyst provided in the exhaust passage of the internal combustion engine.

In the internal combustion engine, the state of the internal combustion engine may be an estimated value of an amount of PM collected by a filter that collects PM in an exhaust gas discharged into an exhaust passage of the internal combustion engine. The mapping data may be data defining a mapping that outputs the amount of PM collected by the filter by using, as an input, at least one of an intake air temperature variable and a wall variable, and a flow rate variable. The intake air temperature variable may be a variable related to a temperature of air taken into the internal combustion engine. The wall variable may be a variable related to a cylinder wall temperature of the internal combustion engine, the flow rate variable being a variable indicating a flow rate of a fluid flowing into the filter. The execution device may be configured to acquire the at least one variable and the flow rate variable in the acquisition process. With the above configuration, the technique for the guard process can be applied in determining an estimated value of the amount of PM collected by a filter that collects PM in the exhaust gas discharged into the exhaust passage of the internal combustion engine.

In the internal combustion engine, the state of the internal combustion engine may be a presence or absence of an abnormality of an air-fuel ratio sensor provided in an exhaust passage of the internal combustion engine. The mapping data may be data defining a mapping that outputs an abnormality determination variable by using, as an input, time-series data of an excess amount variable in a third predetermined period, and time-series data of an air-fuel ratio detection variable in a fourth predetermined period. The abnormality determination variable may be a variable related to a presence or absence of an abnormality in which responsiveness of the air-fuel ratio sensor is reduced. The excess amount variable may be a variable corresponding to an excess amount of an actual injection amount with respect to an amount of fuel needed for setting an air-fuel ratio of an air-fuel mixture in a combustion chamber of the internal combustion engine to a stoichiometric air-fuel ratio. The air-fuel ratio detection variable may be a variable related to a detection value of the air-fuel ratio sensor. The execution device may be configured to acquire the time-series data of the excess amount variable in the third predetermined period and the time-series data of the air-fuel ratio detection variable in the fourth predetermined period, in the acquisition process. With the above configuration, the technique for the guard process can be applied in determining the presence or absence of an abnormality of an air-fuel ratio sensor provided in the exhaust passage of the internal combustion engine.

The internal combustion engine may include an exhaust gas recirculation passage connected to an exhaust passage and an intake passage, and an exhaust gas recirculation valve that adjusts a flow rate of exhaust gas flowing into the intake passage from the exhaust passage via the exhaust gas recirculation passage. The state of the internal combustion engine may be a presence or absence of an abnormality of at least one of the exhaust gas recirculation passage or the exhaust gas recirculation valve. The storage device may be configured to store an exhaust gas recirculation rate as a function of a variable related to an engine load and a variable related to a rotation speed of a crankshaft of the internal combustion engine. The exhaust gas recirculation rate may be a ratio of an amount of exhaust gas recirculation to a sum of air taken into the intake passage and the amount of exhaust gas recirculation flowing into the intake passage via the exhaust gas recirculation passage. An opening degree of the exhaust gas recirculation valve may be controlled such that the exhaust gas recirculation rate becomes a target exhaust gas recirculation rate. The mapping data may be data defining a mapping that outputs an estimated value of the target exhaust gas recirculation rate by using, as an input, the variable related to the engine load, the rotation speed of the crankshaft of the internal combustion engine, an intake pressure in the intake passage downstream of a throttle valve, and an intake air amount of the internal combustion engine. The execution device may be configured to acquire the variable related to the engine load, the rotation speed of the crankshaft of the internal combustion engine, the intake pressure in the intake passage downstream of the throttle valve, and the intake air amount of the internal combustion engine, in the acquisition process. The execution device may be configured to determine a presence or absence of an abnormality of at least one of the exhaust gas recirculation passage or the exhaust gas recirculation valve based on a difference between the estimated value of the target exhaust gas recirculation rate and the target exhaust gas recirculation rate, in the determination process. With the above configuration, the technique for the guard process can be applied in determining the presence or absence of an abnormality of at least one of an exhaust gas recirculation passage or an EGR valve of the internal combustion engine.

In the internal combustion engine, the state of the internal combustion engine may be an estimated value of a knocking intensity of the internal combustion engine. The mapping data may be data defining a mapping that outputs an estimated value of the knocking intensity by using, as an input, a variable representing a vibration of the internal combustion engine detected by a knocking sensor that detects the vibration of the internal combustion engine. In a learning stage, a value representing the knocking intensity may be acquired from an output value of a pressure sensor that detects a pressure in the combustion chamber of the internal combustion engine, and machine learning may be performed using the acquired value representing the knocking intensity as teacher data. The execution device may be configured to acquire the variable representing the vibration of the internal combustion engine detected by the knocking sensor, in the acquisition process. With the above configuration, the technique for the guard process can be applied in determining an estimated value of a knocking intensity of the internal combustion engine.

The internal combustion engine may include an intake air amount detector provided in the intake passage, a throttle valve provided downstream of the intake air amount detector in the intake passage, and a blow-by gas delivery path. The state of the internal combustion engine may be a presence or absence of a leakage abnormality of blow-by gas from a blow-by gas delivery path. The blow-by gas may be sent downstream of a throttle valve in the intake passage via the blow-by gas delivery path. The mapping data may be data defining a mapping that outputs a leakage determination value of the blow-by gas from the blow-by gas delivery path by using, as an input, an intake air amount difference between an amount of intake air passing through the throttle valve and an intake air amount detected by the intake air amount detector, a variable related to an engine load, and a variable related to a rotation speed of a crankshaft of the internal combustion engine. The execution device may be configured to acquire the intake air amount difference, the variable related to the engine load, and the variable related to the rotation speed, in the acquisition process. With the above configuration, the technique for the guard process can be applied in determining the presence or absence of a leakage abnormality of blow-by gas from a blow-by gas delivery path of the internal combustion engine.

The internal combustion engine may be a canister collecting fuel vapor in a fuel tank that stores fuel injected from a fuel injection valve, a purge passage connecting the canister and an intake passage of the internal combustion engine, and a purge control valve provided in the purge passage. The state of the internal combustion engine may be a presence or absence of a perforation abnormality that causes the fuel vapor to leak. The mapping data may be data defining a mapping that outputs a leakage determination value of the fuel vapor by using, as an input, a pressure in the canister detected by a pressure sensor at a predetermined time interval and an atmospheric pressure when an inside of the fuel tank and an inside of the canister are controlled to a negative pressure when drive of the internal combustion engine is stopped. The execution device may be configured to acquire the pressure in the canister detected by the pressure sensor at the predetermined time interval and the atmospheric pressure when the inside of the fuel tank and the inside of the canister are controlled to a negative pressure when drive of the internal combustion engine is stopped, in the acquisition process. With the above configuration, the technique for the guard process can be applied in determining the presence or absence of a perforation abnormality that causes fuel vapor of the internal combustion engine to leak.

The internal combustion engine may include a high-pressure fuel pump for fuel injection that is driven by rotation of a crankshaft and supplies fuel to a fuel injection valve. The state of the internal combustion engine may be an estimated value of a discharge fuel temperature of the high-pressure fuel pump after a predetermined time. The mapping data may be data defining a mapping that outputs the estimated value of the discharge fuel temperature of the high-pressure fuel pump after the predetermined time by using, as an input, a plurality of variables including a variable related to a rotation speed of the crankshaft of the internal combustion engine, a variable related to an engine load, a variable related a lubricating oil temperature, a variable related to a supply fuel amount to the high-pressure fuel pump, a variable related to an intake air temperature of the internal combustion engine, a variable related to the discharge fuel temperature from the high-pressure fuel pump, and a variable related to a vehicle speed. The execution device may be configured to acquire the variables in the acquisition process. With the above configuration, the technique for the guard process can be applied in determining an estimated value of the discharge fuel temperature of the high-pressure fuel pump of the internal combustion engine after a predetermined time.

The internal combustion engine may include an engine coolant circulation system for cooling the internal combustion engine. The engine coolant circulation system may include a water pump, a main passage through which a coolant flowing out of the water pump returns to the water pump via a water jacket and a radiator inside the internal combustion engine, a bypass passage branched from the main passage and bypassing the radiator, and a thermostat that adjusts a flow of the coolant returning from the main passage and the bypass passage to the water pump. The state of the internal combustion engine may be a presence or absence of an abnormality of the thermostat. The mapping data may be data defining a mapping that outputs an estimated value of a coolant temperature by using, as an input, a previous value of the estimated value of the coolant temperature of the internal combustion engine, an intake air amount of the internal combustion engine, a variable related to a fuel injection amount of the internal combustion engine, an outside air temperature, and a variable related to a vehicle speed. The execution device may be configured to acquire the previous value of the estimated value of the coolant temperature of the internal combustion engine, the intake air amount of the internal combustion engine, the variable related to the fuel injection amount of the internal combustion engine, the outside air temperature, and the variable related to the vehicle speed, in the acquisition process. With the above configuration, the technique for the guard process can be applied in determining the presence or absence of an abnormality of a thermostat of the internal combustion engine.

A second aspect of the disclosure is a state determination system for an internal combustion engine. The state determination system includes a storage device and an execution device. The storage device is configured to store mapping data that is data defining a mapping that outputs a determination result of a state of the internal combustion engine by using, as an input, an internal combustion engine state variable that is a parameter indicating the state of the internal combustion engine. The execution device is configured to execute an acquisition process of acquiring the internal combustion engine state variable, and a determination process of determining the state of the internal combustion engine based on an output of the mapping using the internal combustion engine state variable as an input. The mapping data is data that has been learned by machine learning. The execution device is configured to, when the internal combustion engine state variable acquired in the acquisition process is out of a predetermined allowable range, execute a guard process of bringing the internal combustion engine state variable closer to the allowable range or making the internal combustion engine state variable be a value within the allowable range. The execution device is configured to, when the guard process is executed, determine the state of the internal combustion engine based on the internal combustion engine state variable acquired after the guard process, in the subsequent determination process. The execution device includes a first execution device and a second execution device. The first execution device is mounted on a vehicle, and is configured to execute the acquisition process, a vehicle-side transmission process of transmitting data acquired in the acquisition process to an outside of the vehicle, a vehicle-side reception process of receiving a signal based on an output determined in the determination process. The second execution device is disposed outside the vehicle, and is configured to execute an external reception process of receiving the data transmitted in the vehicle-side transmission process, the determination process, and an external transmission process of transmitting a signal based on an output detected in the determination process to the vehicle. With the above configuration, the calculation load of an in-vehicle device can be reduced by executing the determination process outside the vehicle.

A third aspect of the disclosure is a control device for an internal combustion engine. The control device includes a storage device and an execution device. The storage device is configured to store mapping data that is data defining a mapping that outputs a determination result of a state of the internal combustion engine by using, as an input, an internal combustion engine state variable that is a parameter indicating the state of the internal combustion engine. The execution device is configured to execute a determination process of determining the state of the internal combustion engine based on an output of the mapping using the internal combustion engine state variable as an input. The mapping data is data that has been learned by machine learning. The execution device is configured to, when the internal combustion engine state variable acquired in the acquisition process is out of a predetermined allowable range, execute a guard process of bringing the internal combustion engine state variable closer to the allowable range or making the internal combustion engine state variable be a value within the allowable range. The execution device is configured to, when the guard process is executed, determine the state of the internal combustion engine based on the internal combustion engine state variable acquired after the guard process, in the subsequent determination process. The execution device is disposed outside the vehicle, and is configured to execute an external reception process of receiving the data that acquired in the acquisition process and transmitted in the vehicle-side transmission process, the determination process, and an external transmission process of transmitting a signal based on an output detected in the determination process to the vehicle.

A fourth aspect of the disclosure is a state determination system for an internal combustion engine. The state determination system includes a storage device and an execution device. The storage device is configured to store mapping data that is data defining a mapping that outputs a determination result of a state of the internal combustion engine by using, as an input, an internal combustion engine state variable that is a parameter indicating the state of the internal combustion engine. The execution device is configured to execute an acquisition process of acquiring the internal combustion engine state variable, and a determination process of determining the state of the internal combustion engine based on an output of the mapping using the internal combustion engine state variable as an input. The mapping data is data that has been learned by machine learning. The execution device is configured to, when the internal combustion engine state variable acquired in the acquisition process is out of a predetermined allowable range, execute a guard process of bringing the internal combustion engine state variable closer to the allowable range or making the internal combustion engine state variable be a value within the allowable range. The execution device is configured to, when the guard process is executed, determine the state of the internal combustion engine based on the internal combustion engine state variable acquired after the guard process, in the subsequent determination process. The execution device is mounted on a vehicle, and is configured to execute the acquisition process, a vehicle-side transmission process of transmitting data acquired in the acquisition process to an outside of the vehicle, a vehicle-side reception process of receiving a signal based on an output determined in the determination process.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of a control device and a drive system of a vehicle according to a first embodiment;

FIG. 2 is a flowchart illustrating a procedure of an estimated value determination process of a catalyst temperature according to the first embodiment;

FIG. 3 is a diagram illustrating a system that generates mapping data according to the first embodiment;

FIG. 4 is a flowchart illustrating a procedure of a learning process of the mapping data according to the first embodiment;

FIG. 5 is a diagram illustrating a configuration of a state determination system according to a second embodiment;

FIG. 6 is a flowchart illustrating a procedure of each process according to the second embodiment;

FIG. 7 is a flowchart illustrating a procedure of each process according to a third embodiment;

FIG. 8 is a flowchart illustrating a procedure of each process according to a fourth embodiment;

FIG. 9 is a flowchart illustrating a procedure of each process according to a fifth embodiment;

FIG. 10 is a flowchart illustrating a procedure of each process according to a sixth embodiment;

FIG. 11 is a diagram illustrating a partial region of a catalyst according to the sixth embodiment;

FIG. 12 is a flowchart illustrating a procedure of a catalyst warm-up monitoring process according to the sixth embodiment;

FIG. 13 is a flowchart illustrating a procedure of each process according to a seventh embodiment;

FIG. 14 is a flowchart illustrating a procedure of each process according to an eighth embodiment;

FIG. 15 is a flowchart illustrating a procedure of each process according to a ninth embodiment;

FIG. 16 is a flowchart illustrating a procedure of each process according to a tenth embodiment;

FIG. 17 is a flowchart illustrating a procedure of each process according to an eleventh embodiment;

FIG. 18 is a flowchart illustrating a procedure of each process according to a twelfth embodiment;

FIG. 19 is a flowchart illustrating a procedure of each process according to a thirteenth embodiment;

FIG. 20 is a flowchart illustrating a procedure of each process according to a fourteenth embodiment;

FIG. 21 is a diagram illustrating a configuration of an internal combustion engine according to a fifteenth embodiment; and

FIG. 22 is a flowchart illustrating a procedure of each process according to the fifteenth embodiment.

### DETAILED DESCRIPTION OF EMBODIMENTS

### First Embodiment

Hereinafter, a first embodiment of a state determination device for an internal combustion engine will be described with reference to the drawings.

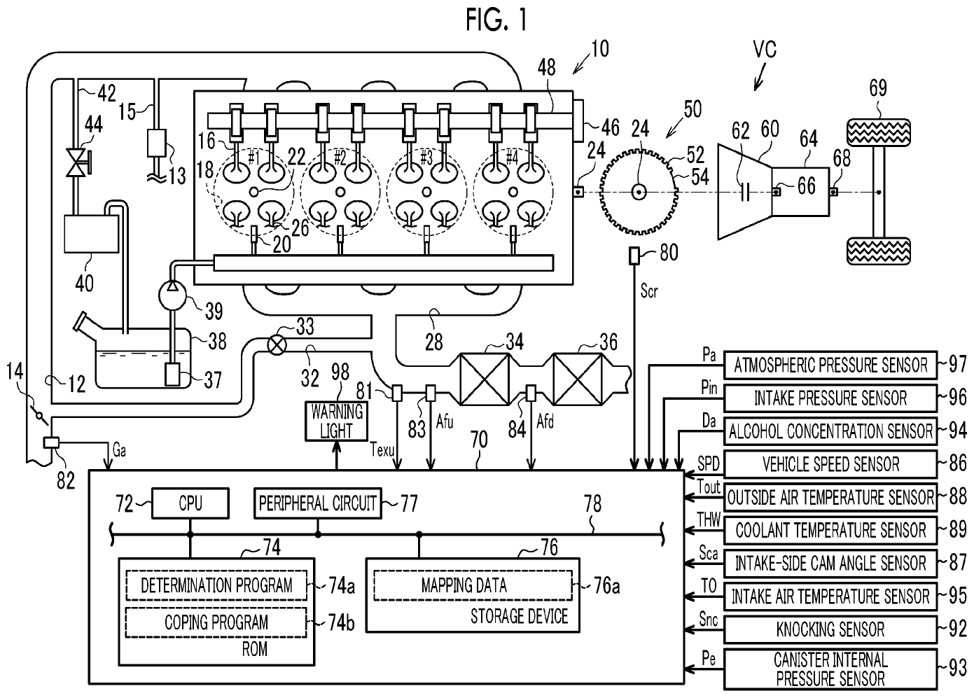

In an internal combustion engine 10 mounted on a vehicle VC illustrated in FIG. 1, a throttle valve 14 is provided in an intake passage 12. Air sucked from the intake passage 12 flows into a combustion chamber 18 of each of cylinders #1 to #4 when an intake valve 16 opens. Fuel is injected into the combustion chamber 18 by a fuel injection valve 20. In the combustion chamber 18, an air-fuel mixture of air and fuel is provided for combustion by spark discharge from an ignition device 22, and energy generated by the combustion is taken out as rotation energy of a crankshaft 24. The air-fuel mixture provided for the combustion is discharged into an exhaust passage 28 as exhaust gas in accordance with the opening of an exhaust valve 26. The exhaust passage 28 is provided with an upstream catalyst 34 which is a filter that collects particulate matter in the exhaust gas and that supports a three-way catalyst having an oxygen storage capacity. In addition, downstream of the upstream catalyst 34, a downstream catalyst 36, which is a three-way catalyst having an oxygen storage capacity, is provided. An exhaust gas recirculation (EGR) passage 32 is connected to the exhaust passage 28 at a position upstream of the upstream catalyst 34. The exhaust passage 28 communicates with the intake passage 12 via the EGR passage 32. The EGR passage 32 is provided with an EGR valve 33 that adjusts a flow passage cross-sectional area of the passage.

The fuel stored in a fuel tank 38 is supplied to the fuel injection valve 20 via a low-pressure fuel pump 37 and a high-pressure fuel pump 39. Fuel vapor generated in the fuel tank 38 is collected in a canister 40. The canister 40 is connected to the intake passage 12 via a purge passage 42, and a flow passage cross-sectional area of the purge passage 42 is adjusted by a purge valve 44.

In addition, an upstream end of a blow-by gas delivery path 15 for supplying blow-by gas is connected to a downstream side of the throttle valve 14 in the intake passage 12. A downstream end of the blow-by gas delivery path 15 is connected to an engine crankcase (not illustrated). A positive crankcase ventilation (PCV) valve 13 is attached to the blow-by gas delivery path 15.

The rotation power of the crankshaft 24 is transmitted to an intake-side camshaft 48 via an intake-side variable valve timing device 46. The intake-side variable valve timing device 46 changes a relative rotation phase difference between the intake-side camshaft 48 and the crankshaft 24.

An input shaft 66 of a transmission 64 can be connected to the crankshaft 24 of the internal combustion engine 10 via a torque converter 60. The torque converter 60 includes a lock-up clutch 62, and when the lock-up clutch 62 is engaged, the crankshaft 24 and the input shaft 66 are connected to each other. Drive wheels 69 are mechanically connected to an output shaft 68 of the transmission 64.

A crank rotor 50 provided with a plurality of (here, 34) tooth portions 52 indicating the rotation angle of the crankshaft 24 is coupled to the crankshaft 24. Although the crank rotor 50 is basically provided with the tooth portions 52 at intervals of 10° CA, one toothless portion 54 which is a place where an interval between adjacent tooth portions 52 is 30° CA is provided in the crank rotor 50. The toothless portion is for indicating the reference rotation angle of the crankshaft 24. A crank angle sensor 80 is provided near the crank rotor 50. The crank angle sensor 80 converts a change in magnetic flux according to the approach and separation of the tooth portion 52 into a pulse signal of a rectangular wave and outputs the pulse signal. In the following description, such an output signal of the crank angle sensor 80 is referred to as a crank signal Scr.

A control device 70 controls the internal combustion engine 10 and operates the throttle valve 14, the fuel injection valve 20, the ignition device 22, the EGR valve 33, the intake-side variable valve timing device 46, and the like in order to control a torque, an exhaust component ratio, and the like, which are control amounts of the internal combustion engine.

In controlling the control amount, the control device 70 refers to the crank signal Scr which is an output signal of the crank angle sensor 80 and an intake air amount Ga detected by an air flow meter 82. In addition, the control device 70 refers to an exhaust temperature Texu detected by an exhaust temperature sensor 81 provided upstream of the upstream catalyst 34 and an upstream detection value Afu which is a detection value of an upstream air-fuel ratio sensor 83 provided upstream of the upstream catalyst 34. In addition, the control device 70 refers to a downstream detection value Afd which is a detection value of a downstream air-fuel ratio sensor 84 provided between the upstream catalyst 34 and the downstream catalyst 36, a vehicle speed SPD detected by a vehicle speed sensor 86, and an outside air temperature Tout detected by an outside air temperature sensor 88. In addition, the control device 70 refers to an output signal Sca of an intake-side cam angle sensor 87 and a coolant temperature THW detected by a coolant temperature sensor 89. In addition, the control device 70 refers to an alcohol concentration Da of the fuel detected by an alcohol concentration sensor 94. In addition, the control device 70 refers to an intake air temperature TO detected by an intake air temperature sensor 95, an intake pressure Pin detected by an intake pressure sensor 96 provided in the intake passage 12 downstream of the throttle valve 14, and an atmospheric pressure Pa detected by an atmospheric pressure sensor 97. In addition, the control device 70 refers to a detection signal Snc from a knocking sensor 92 that detects the vibration of the internal combustion engine 10. In addition, the control device 70 refers to a canister internal pressure Pe detected by a canister internal pressure sensor 93.

The control device 70 includes a CPU 72, a ROM 74, a storage device 76 which is an electrically rewritable nonvolatile memory, and a peripheral circuit 77, which can be communicated by a local network 78. Note that, the peripheral circuit 77 includes a circuit that generates a clock signal defining an internal operation, a power supply circuit, a reset circuit, and the like.

The control device 70 determines a state of the internal combustion engine and controls the control amount by causing the CPU 72 to execute a program stored in the ROM 74. In the present embodiment, the control device 70 determines an estimated value of a catalyst temperature and controls the control amount.

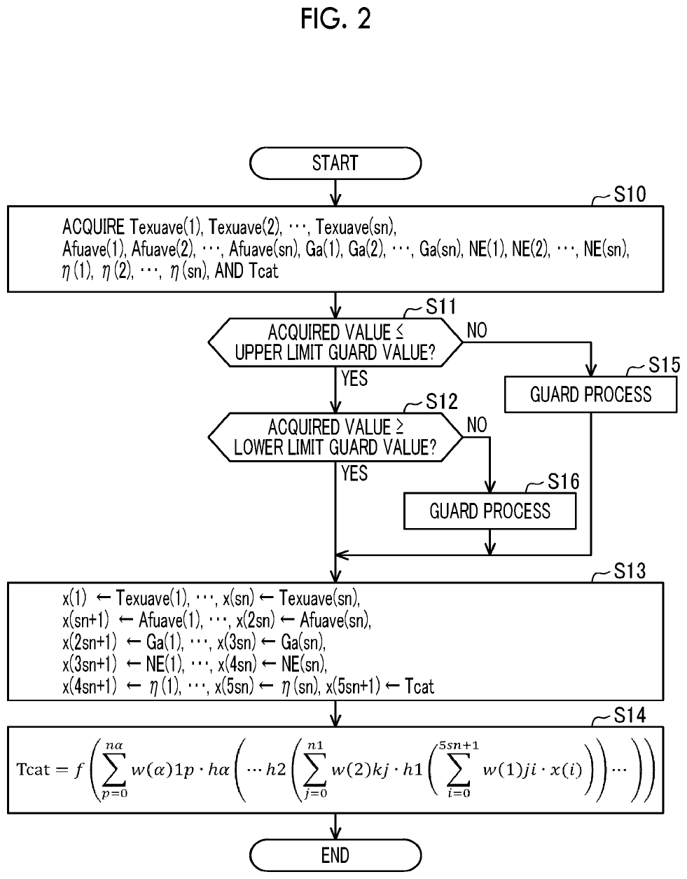

FIG. 2 illustrates a procedure of a catalyst temperature estimating process of calculating an estimated value of the temperature of the upstream catalyst 34. The process illustrated in FIG. 2 is realized by the CPU 72 repeatedly executing a determination program 74a stored in the ROM 74 illustrated in FIG. 1 at a predetermined cycle, for example. Note that, in the following description, the step number of each process is represented by a number prefixed with “S”.

In the series of processes illustrated in FIG. 2, the CPU 72 firstly acquires time-series data in a predetermined period, for each of an exhaust temperature average value Texuave, an upstream average value Afuave, the intake air amount Ga, a rotation speed NE, and a charging efficiency and the previous value of an upstream catalyst temperature Tcat, which is the catalyst temperature calculated in the previous process of FIG. 2 (S10). In the following, for example, the time-series data of the rotation speed NE is described as “NE(1) to NE(sn)” as “1, 2, . . . , Sn” in ascending order of sampling timing. Here, “sn” is the number of data included in the time-series data of each variable.

The exhaust temperature average value Texuave is an average value of the exhaust temperature Texu at the sampling interval of the time-series data. That is, the CPU 72 samples the exhaust temperature Texu a plurality of times during the sampling interval of the time-series data, calculates the average value thereof, and sets the average value as the exhaust temperature average value Texuave. Similarly, the upstream average value Afuave is an average value of the upstream detection value Afu at the sampling interval of the time-series data. The rotation speed NE is calculated by the CPU 72 based on the crank signal Scr of the crank angle sensor 80. The charging efficiency η is a parameter defining the amount of air charged into the combustion chamber 18, and is calculated by the CPU 72 based on the rotation speed NE and the intake air amount Ga.

Next, the CPU 72 determines whether or not each of the values acquired in S10 is equal to or less than an upper limit guard value determined according to each acquired value (S11). The upper limit guard value is set for each type of the acquired values, and an upper limit guard value of the exhaust temperature average value Texuave, an upper limit guard value of the upstream average value Afuave, an upper limit guard value of the intake air amount Ga, an upper limit guard value of the rotation speed NE, and an upper limit guard value of the charging efficiency η are set. Note that, each upper limit guard value is within the range of data input when mapping data 76a stored in the storage device 76 is learned by machine learning, and is defined as the upper limit value of the input data.

When the acquired value is equal to or less than the upper limit guard value (S11: YES), the CPU 72 determines whether or not each of the values acquired in S10 is equal to or greater than a lower limit guard value predetermined as a value less than the upper limit guard value according to each acquired value (S12). The lower limit guard value is set for each type of the acquired values, and a lower limit guard value of the exhaust temperature average value Texuave, a lower limit guard value of the upstream average value Afuave, a lower limit guard value of the intake air amount Ga, a lower limit guard value of the rotation speed NE, and a lower limit guard value of the charging efficiency η are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value (here, the range includes the lower limit guard value and the upper limit guard value) is an allowable range of the input value, and the allowable range matches the range of data input when the data is learned by machine learning.

When the acquired value is equal to or greater than the lower limit guard value (S12: YES), the CPU 72 assigns the values acquired in the process of S10 to input variables x(1) to x(5sn+1) of a mapping that outputs the upstream catalyst temperature Tcat (S13). That is, assuming that m=1 to sn, the CPU 72 assigns the exhaust temperature average value Texuave(m) to the input variable x(m), assigns the upstream average value Afuave(m) to the input variable x(sn+m), assigns the intake air amount Ga(m) to the input variable x(2sn+m), and assigns the rotation speed NE(m) to the input variable x(3sn+m). In addition, the CPU 72 assigns the charging efficiency η(m) to the input variable x(4sn+m), and assigns the previous value of the upstream catalyst temperature Tcat to the input variable x(5sn+1).

Next, the CPU 72 calculates the upstream catalyst temperature Tcat by inputting the input variables x(1) to x(5sn+1) to the mapping defined by the mapping data 76a stored in the storage device 76 illustrated in FIG. 1 (S14).

In the present embodiment, the mapping includes a neural network in which the number of intermediate layers is “α”, activation functions h1 to hα of each intermediate layer are hyperbolic tangents, and an activation function f of the output layer is ReLU. Note that, ReLU is a function that outputs the greater of the input and zero, or zero when the input is zero. For example, the value of each node in a first intermediate layer is generated by inputting the output when the input variables x(1) to x(5sn+1) are input to the linear mapping defined by coefficients w(1)ji (j=0 to n1, i=0 to 5sn+1) to the activation function h1. That is, assuming that m=1, 2, . . . , α, the value of each node of the m-th intermediate layer is generated by inputting the output of the linear mapping defined by the coefficient w(m) to the activation function hm. The values n1, n2, . . . , nα illustrated in FIG. 2 are the numbers of nodes of the first, second, . . . , α-th intermediate layers, respectively. Incidentally, w(1)j0 and the like are bias parameters, and the input variable x(0) is defined as “1”.

Note that, when the process of S14 is completed, the CPU 72 temporarily ends the series of processes illustrated in FIG. 2. Incidentally, when the process of FIG. 2 is executed first, a predetermined default value may be used as the previous value of the upstream catalyst temperature Tcat. Even when the default value deviates from the actual temperature, the process of FIG. 2 is repeated, so that the upstream catalyst temperature Tcat converges to a correct value.

When the value acquired in S10 exceeds the upper limit guard value (S11: NO), the CPU 72 performs a guard process of matching the acquired value to the upper limit guard value (S15). As a result, the acquired value exceeding the upper limit guard value is reset as the same value as the upper limit guard value, and then the above-described processes of S13 and S14 are performed.

When the value acquired in S10 is less than the lower limit guard value (S12: NO), the CPU 72 performs a guard process of matching the acquired value to the lower limit guard value (S16). As a result, the acquired value less than the lower limit guard value is reset as the same value as the lower limit guard value, and then the above-described processes of S13 and S14 are performed.

Then, the CPU 72 repeatedly executes a coping program 74b stored in the ROM 74 illustrated in FIG. 1 at a predetermined cycle based on, for example, the upstream catalyst temperature Tcat calculated in S14 to realize a coping process. In the present embodiment, when the upstream catalyst temperature Tcat becomes equal to or higher than a predetermined temperature, the coping process is performed by the coping program 74b in order to protect the upstream catalyst 34. Specifically, the CPU 72 performs control such that the injection amount of fuel injected from the fuel injection valve 20 is reduced.

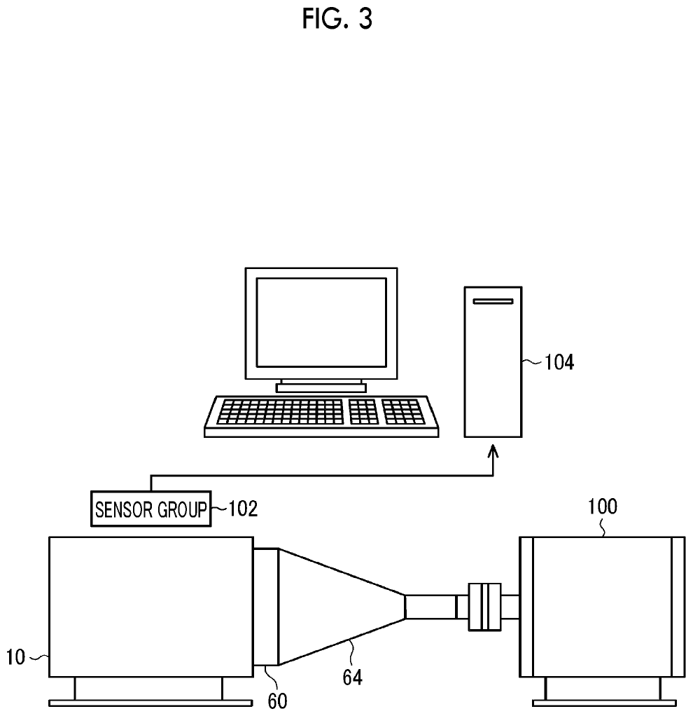

Next, a method of generating the mapping data 76a will be described. FIG. 3 illustrates a system that generates the mapping data 76a. As illustrated in FIG. 3, in the present embodiment, a dynamometer 100 is mechanically connected to the crankshaft 24 of the internal combustion engine 10 via the torque converter 60 and the transmission 64. Then, various state variables when the internal combustion engine 10 is operated are detected by a sensor group 102, and the detection results are input to an adaptation device 104 which is a computer that generates the mapping data 76a. Note that, the sensor group 102 includes the air flow meter 82, the exhaust temperature sensor 81, the upstream air-fuel ratio sensor 83, and the like, which are sensors that detect a value for generating an input to the mapping. The sensor group 102 includes a catalyst temperature sensor that detects the temperature of the upstream catalyst 34.

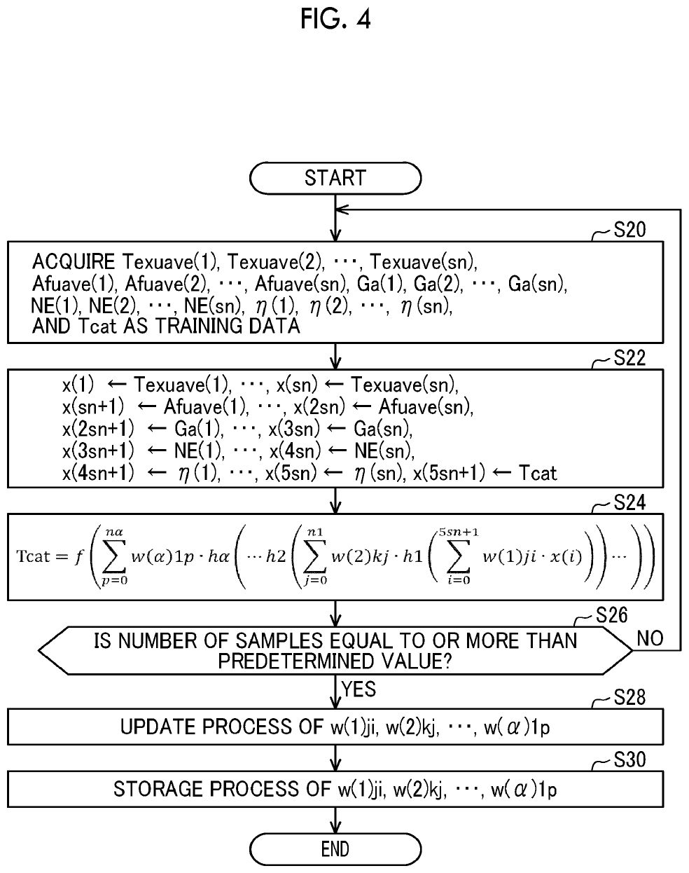

FIG. 4 illustrates a procedure of a generation process of the mapping data. The process illustrated in FIG. 4 is executed by the adaptation device 104. Note that, the process illustrated in FIG. 4 may be realized by, for example, providing the adaptation device 104 with a CPU and a ROM, and executing a program stored in the ROM by the CPU.

In the series of processes illustrated in FIG. 4, the adaptation device 104 first acquires the same data as that acquired in the process of S10 as training data based on the detection result of the sensor group 102 (S20). Note that, here, in synchronization with the acquired timing, the detection value of the above-described catalyst temperature sensor is acquired as teacher data of the training data.

Next, the adaptation device 104 assigns training data other than the teacher data to the input variables x(1) to x(5sn+1) in the same manner as the process of S12 (S22). Then, the adaptation device 104 calculates the upstream catalyst temperature Tcat using the input variables x(1) to x(5sn+1) obtained in the process of S22 in the same manner as the process of S14 (S24). Then, the CPU 72 determines whether or not the number of samples of the upstream catalyst temperature Tcat calculated in the process of S24 is equal to or more than a predetermined value (S26). Here, in order to make the number of samples of the upstream catalyst temperature Tcat be equal to or more than a predetermined value, the upstream catalyst temperature Tcat is needed to be calculated at various operating points defined by the rotation speed NE and the charging efficiency η by changing the operating state of the internal combustion engine 10.

When determination is made that the number of samples of the upstream catalyst temperature Tcat is not equal to or more than a predetermined value (S26: NO), the adaptation device 104 returns to the process of S20. On the other hand, when determination is made that the number of samples of the upstream catalyst temperature Tcat is equal to or more than the predetermined value (S26: YES), the CPU 72 updates the coefficients w(1)ji, w(2)kj, . . . , w(α)lp so as to minimize the square sum of differences between the detection value of the catalyst temperature sensor as teacher data and each upstream catalyst temperature Tcat calculated in process of S24 (S28). Then, the adaptation device 104 stores the coefficients w(1)ji, w(2)kj, . . . , w(α)lp as the learned mapping data 76a (S30).

Next, the operation and effect of the present embodiment will be described. According to the embodiment, when the value acquired in the process of S10 is greater than the upper limit guard value or less than the lower limit guard value, that is, when the acquired value is out of the allowable range, the acquired value is brought closer to the allowable range than the value acquired by the guard process. Therefore, it is possible to suppress the value input to the mapping from being excessively large or small. As a result, the output of the mapping is suppressed from becoming an unexpected value.

According to the embodiment, when the value acquired in the process of S10 is out of the range of the training data input when the mapping data 76a defining the mapping is learned, the guard process is performed. Therefore, it is possible to suppress the value input to the mapping from becoming excessively large with respect to the training data input at the time of learning.

According to the embodiment, when the value outside the allowable range is acquired in the process of S10, the acquired value is set to a value closest to the value before the guard process, which is a value within the allowable range. Therefore, while following the value of the acquired value before the guard process, the output of the mapping is suppressed from becoming an unexpected result.

### Second Embodiment

Hereinafter, a second embodiment will be described with reference to the drawings, focusing on differences from the first embodiment.

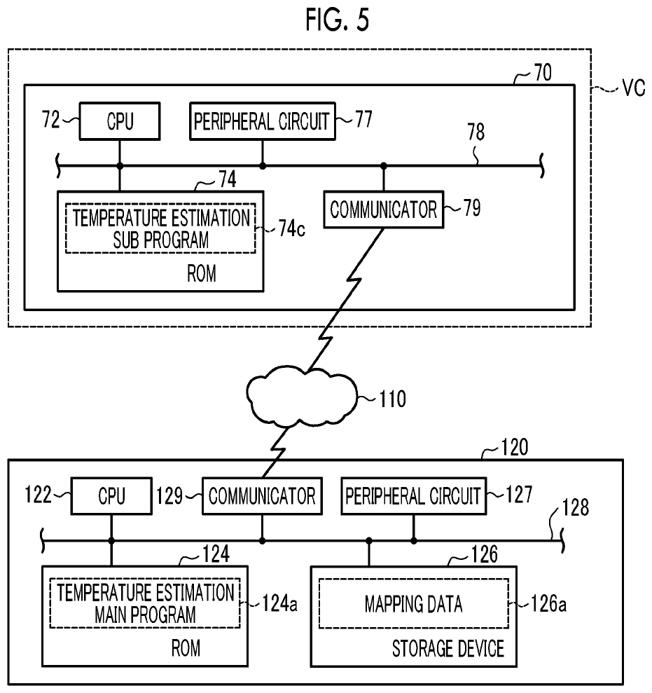

In the present embodiment, the process of calculating the upstream catalyst temperature Tcat, which is the catalyst temperature, is performed outside the vehicle. FIG. 5 illustrates a temperature estimation system according to the present embodiment. Note that, in FIG. 5, members corresponding to the members illustrated in FIG. 1 are denoted by the same reference numerals for convenience.

The control device 70 in the vehicle VC illustrated in FIG. 5 includes a communicator 79. The communicator 79 is a device for communicating with a center 120 via a network 110 outside the vehicle VC. The center 120 analyzes data transmitted from a plurality of the vehicles VC. The center 120 includes a CPU 122, a ROM 124, a storage device 126, a peripheral circuit 127, and a communicator 129, and the CPU 122, the ROM 124, the storage device 126, the peripheral circuit 127, and the communicator 129 can be communicated by a local network 128. The ROM 124 stores a temperature estimation main program 124a, and the storage device 126 stores mapping data 126a.

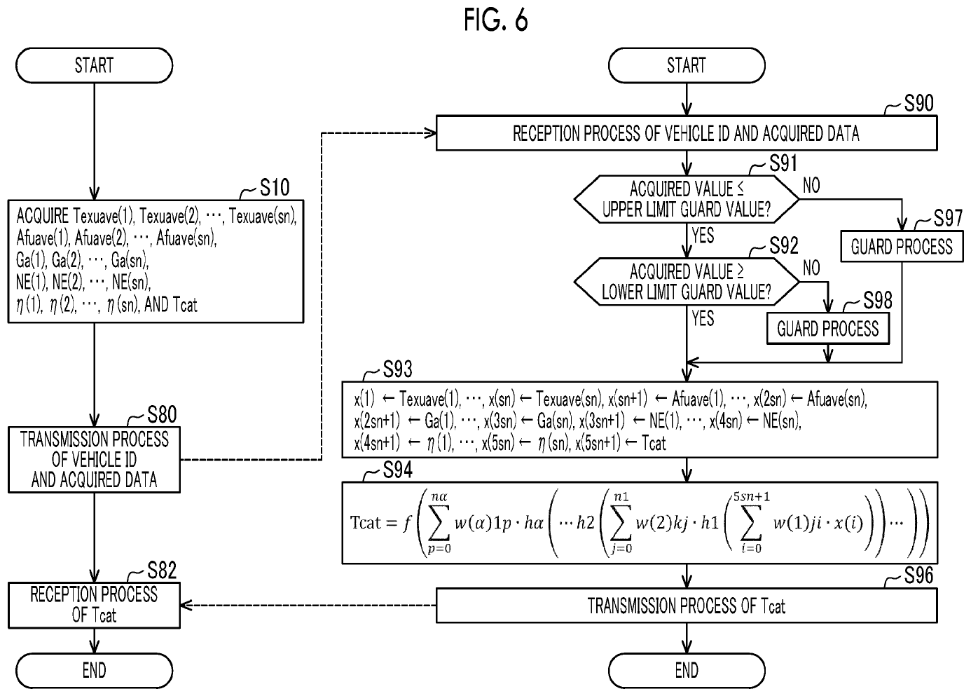

FIG. 6 illustrates procedures of processes executed by the system illustrated in FIG. 5. The process illustrated in FIG. 6 is realized by the CPU 72 executing a temperature estimation sub program 74c stored in the ROM 74 illustrated in FIG. 5. The process illustrated in FIG. 6 is realized by the CPU 122 executing the temperature estimation main program 124a stored in the ROM 124. Hereinafter, the processes illustrated in FIG. 6 will be described along the time series of processes.

As illustrated in FIG. 6, in the vehicle VC, the CPU 72 firstly acquires time-series data in a predetermined period, for each of the exhaust temperature average value Texuave, the upstream average value Afuave, the intake air amount Ga, the rotation speed NE, and the charging efficiency η, and a previous value of the upstream catalyst temperature Tcat, which is the catalyst temperature calculated in the previous process of FIG. 6 (S10).

Next, the CPU 72 transmits the data acquired in the process of S10 to the center 120 together with a vehicle ID which is data indicating identification information on the vehicle (S80). On the other hand, as illustrated in FIG. 6, the CPU 122 of the center 120 receives the transmitted data (S90). Next, the CPU 122 determines whether or not each of the acquired values received in S90 is equal to or less than an upper limit guard value determined according to each acquired value (S91). The upper limit guard value is set for each type of the acquired values, and an upper limit guard value of the exhaust temperature average value Texuave, an upper limit guard value of the upstream average value Afuave, an upper limit guard value of the intake air amount Ga, an upper limit guard value of the rotation speed NE, and an upper limit guard value of the charging efficiency η are set. Note that, each upper limit guard value is within the range of data input when mapping data 126a stored in the storage device 126 is learned by machine learning, and is defined as the upper limit value of the input data.

When the acquired value is equal to or less than the upper limit guard value (S91: YES), the CPU 72 determines whether or not each of the values acquired in S10 is equal to or greater than a lower limit guard value determined according to each acquired value (S92). The lower limit guard value is set for each type of the acquired values, and a lower limit guard value of the exhaust temperature average value Texuave, a lower limit guard value of the upstream average value Afuave, a lower limit guard value of the intake air amount Ga, a lower limit guard value of the rotation speed NE, and a lower limit guard value of the charging efficiency η are set. Note that, each lower limit guard value is within the range of data input when mapping data 126a stored in the storage device 126 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S92: YES), the CPU 122 assigns the acquired values received in S90 to the input variable x of the mapping (S93). Here, the CPU 122 assigns the same values as in the process of S13 to the input variables x(1) to x(5sn). The previous value of the upstream catalyst temperature Tcat is assigned for the input variable x(5sn+1).

Then, the CPU 122 calculates the upstream catalyst temperature Tcat by inputting the input variables x(1) to x(5sn+1) generated by S93 to the mapping defined by the mapping data 126a (S94). Here, the mapping defined by the mapping data 126a is the same as that used in the process of S14.

Then, by operating the communicator 129, the CPU 122 transmits a signal related to the upstream catalyst temperature Teat to the vehicle VC to which the data received in the process of S90 has been transmitted (S96), and temporarily ends the series of processes illustrated in FIG. 6. On the other hand, as illustrated in FIG. 6, the CPU 72 receives the upstream catalyst temperature Tcat (S82), and temporarily ends the series of processes illustrated in FIG. 6.

When the value acquired in S10 exceeds the upper limit guard value (S91: NO), the CPU 122 performs a guard process of matching the acquired value to the upper limit guard value (S97). As a result, the acquired value exceeding the upper limit guard value is reset as the same value as the upper limit guard value, and then the above-described processes of S93 and S94 are performed.

When the acquired value received in S90 is less than the lower limit guard value (S92: NO), the CPU 122 performs a guard process of matching the acquired value to the lower limit guard value (S98). As a result, the acquired value less than the lower limit guard value is reset as the same value as the lower limit guard value, and then the above-described processes of S93 to S96, and S82 are performed.

Next, the operation and effect of the present embodiment will be described. In the embodiment, the upstream catalyst temperature Tcat is calculated in the center 120, so that the calculation load on the CPU 72 can be reduced.

### Third Embodiment

Hereinafter, a third embodiment will be described with reference to the drawings, focusing on differences from the above-described first embodiment.

In the present embodiment, the state determination device for an internal combustion engine is configured as a device that determines a misfire occurring in the internal combustion engine 10. In the ROM 74 of the state determination device for the internal combustion engine 10 according to the present embodiment, a program for determining a misfire occurring in the internal combustion engine 10 is stored as the determination program 74a.

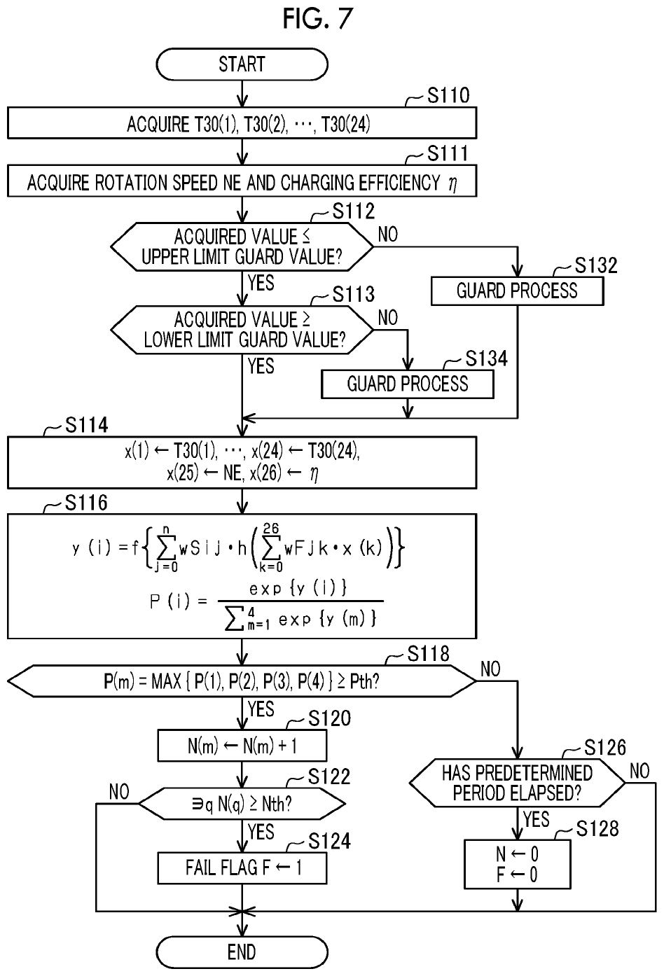

FIG. 7 illustrates a procedure of processes executed by the control device 70 in the present embodiment. The process illustrated in FIG. 7 is realized by the CPU 72 repeatedly executing the determination program 74a stored in the ROM 74 illustrated in FIG. 1 at a predetermined cycle, for example.

In the series of processes illustrated in FIG. 7, the CPU 72 first acquires minute rotation times T30(1), T30(2), . . . , T30(24) (S110). The minute rotation time T30 is calculated by the CPU 72 measuring the time needed for the crankshaft 24 to rotate by 30° CA based on the crank signal Scr of the crank angle sensor 80. Here, when the numbers in parentheses such as the minute rotation times T30(1), T30(2) are different, the number indicates that rotation angle intervals are different within 720° CA which is one combustion cycle. That is, the minute rotation times T30(1) to T30(24) indicate the rotation time at each angle interval obtained by equally dividing the rotation angle region of 720° CA by 30° CA. Next, the CPU 72 acquires the rotation speed NE and the charging efficiency η (S111).

Next, the CPU 72 determines whether or not each of the values acquired in S110 is equal to or less than an upper limit guard value determined according to each acquired value (S112). The upper limit guard value is set for each type of acquired values, and an upper limit guard value of the minute rotation time T30, an upper limit guard value of the rotation speed NE, and an upper limit guard value of the charging efficiency η are set. Note that, each upper limit guard value is within the range of data input when mapping data 76a stored in the storage device 76 is learned by machine learning, and is defined as the upper limit value of the input data.

When the acquired value is equal to or less than the upper limit guard value (S112: YES), the CPU 72 determines whether or not each of the values acquired in S110 is equal to or greater than a lower limit guard value determined according to each acquired value (S113). The lower limit guard value is set for each type of acquired values, and a lower limit guard value of the minute rotation time T30, a lower limit guard value of the rotation speed NE, and a lower limit guard value of the charging efficiency are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S113. YES), the CPU 72 assigns the values acquired in the processes of S110 and S112 to the input variables x(1) to x(26) of a mapping for calculating a probability that a misfire has occurred (S114). Specifically, assuming that “s=1 to 24”, the CPU 72 assigns the minute rotation time T30(s) to the input variable x(s). That is, the input variables x(1) to x(24) are time-series data of the minute rotation time T30. The CPU 72 assigns the rotation speed NE to the input variable x(25) and assigns the charging efficiency η to the input variable x(26).

Next, the CPU 72 calculates a probability P(i) that a misfire has occurred in the cylinders #i (i=1 to 4) by inputting the input variables x(1) to x(26) to the mapping defined by the mapping data 76a stored in the storage device 76 illustrated in FIG. 1 (S116) The mapping data 76a is data defining a mapping capable of outputting the probability P(i) that a misfire has occurred in the cylinder #i in the period corresponding to the minute rotation times T30(1) to T30(24) acquired in the process of S110. Here, the probability P(i) is obtained by quantifying the degree of plausibility that a misfire has actually occurred based on the input variables x(1) to x(26). However, in the present embodiment, the maximum value of the probability P(i) that a misfire has occurred in the cylinder #i is less than “1”, and the minimum value thereof is greater than “0”. That is, in the present embodiment, the probability P(i) is obtained by quantifying the degree of plausibility that a misfire has actually occurred as a continuous value within a predetermined region greater than “0” and less than “1”.

In the present embodiment, the mapping includes a neural network having a single intermediate layer and a softmax function for setting the sum of the probabilities P(1) to P(4) that a misfire has occurred to “1” by standardizing an output of the neural network. The neural network includes the input-side coefficient wFjk (j=0 to n, k=0 to 26) and the activation function h(x) as an input-side nonlinear mapping that nonlinearly transforms each output of an input-side linear mapping, which is a linear mapping defined by the input-side coefficient wFjk. In the present embodiment, the hyperbolic tangent “tan h(x)” is exemplified as the activation function h(x). The neural network includes the output-side coefficient wSij (i=1 to 4, j=0 to n) and the activation function f(x) as an output-side nonlinear mapping that nonlinearly transforms each output of an output-side linear mapping, which is a linear mapping defined by the output-side coefficient wSij. In the present embodiment, the hyperbolic tangent “tan h(x)” is exemplified as the activation function f(x). Note that, the value n indicates the dimension of the intermediate layer. In the present embodiment, the value n is less than the dimension (here, 26 dimensions) of the input variable x. An input-side coefficient wFj0 is a bias parameter, and is used as a coefficient of the input variable x(0) by defining the input variable x(0) as “1”. An output-side coefficient wSi0 is a bias parameter, and multiplied by “1”. This can be achieved, for example, by defining “wF00·x(0)+wF01·x(1)+ . . . ” as being infinitely constant.

Specifically, the CPU 72 calculates a probability prototype y(i) which is an output of the neural network defined by the input-side coefficient wFjk, the output-side coefficient wSij, and the activation functions h(x), f(x). The probability prototype y(i) is a parameter having a positive correlation with a probability that a misfire has occurred in the cylinder #i. Then, the CPU 72 calculates the probability P(i) that a misfire has occurred in the cylinder #i based on the output of the softmax function having the probability prototypes y(1) to y(4) as inputs.

Next, the CPU 72 determines whether or not the maximum value P(m) of the probabilities P(1) to P(4) that a misfire has occurred is equal to or greater than a threshold Pth (S118). Here, a variable m takes one of values from 1 to 4, and the threshold Pth is set to a value equal to or greater than “½”. Then, when determination is made that the maximum value P(m) is equal to or greater than the threshold Pth (S118: YES), the CPU 72 increments the number of times N(m) of a misfire of the cylinder #m having the highest probability (S120). Then, the CPU 72 determines whether or not there is a cylinder having a predetermined number of times Nth or more among the number of times N(1) to N(4) of a misfire (S122). Then, when determination is made that there is a cylinder having the predetermined number of times Nth or more (S122: YES), the CPU 72 assigns “1” to a fail flag F (S124) on the assumption that a misfire has occurred at a frequency exceeding an allowable range in a specific cylinder #q (q is one of 1 to 4). Note that, at this time, the CPU 72 stores information on the cylinder #q in which a misfire has occurred in the storage device 76 and holds the information until at least the misfire is eliminated in the cylinder #q.

On the other hand, when determination is made that the maximum value P(m) is less than the threshold Pth (S118: NO), the CPU 72 determines whether or not a predetermined period has elapsed since the process of S124 or a process of S128 (to be described later) is performed (S126). Here, the predetermined period is longer than the period of one combustion cycle, and desirably has a length of 10 times or more of one combustion cycle.

When determination is made that the predetermined period has elapsed (S126: YES), the CPU 72 initializes the number of times N(1) to N(4) of a misfire and initializes the fail flag F (S128). Note that, when the processes of S124 and S128 are completed, or when a negative determination is made in the processes of S122 and S126, the CPU 72 temporarily ends the series of processes illustrated in FIG. 7.

When the values acquired in S110 and S111 exceed the upper limit guard value (S112: NO), the CPU 72 performs a guard process of matching the acquired value to the upper limit guard value (S132). As a result, the acquired value exceeding the upper limit guard value is reset as the same value as the upper limit guard value, and then the above-described processes of S114 and S116 are performed.

When the value acquired in S110 is less than the lower limit guard value (S113: NO), the CPU 72 performs a guard process of matching the acquired value to the lower limit guard value (S134). As a result, the acquired value less than the lower limit guard value is reset as the same value as the lower limit guard value, and then the above-described processes of S114 to S128 are performed.

Then, when a misfire has occurred, the CPU 72 executes a coping process of coping with the misfire. The coping process is realized by the CPU 72 executing the coping program 74b stored in the ROM 74 illustrated in FIG. 1 with the switching of the fail flag F from “0” to “1” as a trigger. In the present embodiment, the CPU 72 uses the operation unit as the ignition device 22 to advance the ignition timing of the cylinder in which a misfire has occurred.

Next, a method of generating the mapping data 76a will be described focusing on differences from the first embodiment. The sensor group 102 illustrated in FIG. 3 includes the air flow meter 82, and the crank angle sensor 80, which are sensors that detect a value for generating an input to the mapping. Here, for example, an in-cylinder pressure sensor or the like is included in the sensor group 102 in order to reliably determine whether or not a misfire has occurred.

In addition, data to be acquired for generating mapping data 76a are different. In the present embodiment, the adaptation device 104 acquires a plurality of sets of the minute rotation times T30(1) to T30(24), the rotation speed NE, the charging efficiency η, and a true probability Pt(i) of a misfire, as training data determined based on the detection result of the sensor group 102. Here, the true probability Pt(i) is “1” when a misfire has occurred and “0” when no misfire has occurred, and is calculated based on a detection value or the like of an in-cylinder pressure sensor that uses a parameter other than the parameters defining the input variables x(1) to x(26) in the sensor group 102 as a detection value. However, in generating the training data, for example, the fuel injection may be intentionally stopped in a predetermined cylinder, and a phenomenon similar to that when a misfire occurs may be generated. Even in such a case, an in-cylinder pressure sensor or the like is used in detecting whether or not a misfire has occurred in a cylinder in which fuel is being injected.

Next, the operation and effect of the present embodiment will be described. In particular, in a case where the state of the internal combustion engine 10 typified by the presence or absence of a misfire is determined, an engine stall or the like may occur when the internal combustion engine 10 is controlled based on the determination result. Therefore, in determining the state of the internal combustion engine using the hierarchical neural network model, high reliability is demanded. According to the above embodiment, the technique for the guard process can be applied in determining whether or not a misfire has occurred in the internal combustion engine 10 as the state of the internal combustion engine 10.

### Fourth Embodiment

Hereinafter, a fourth embodiment will be described with reference to the drawings, focusing on differences from the above-described first embodiment.

In the present embodiment, the state determination device for an internal combustion engine is configured as a device that determines an imbalance, which is a variation between actual air-fuel ratios, when the fuel injection valve 20 is operated to control air-fuel ratios of air-fuel mixtures in a plurality of cylinders to be equal to each other. In the ROM 74 of the state determination device for the internal combustion engine 10 according to the present embodiment, a program for determining an imbalance, which is a variation in air-fuel ratio between the cylinders, is stored as the determination program 74a.

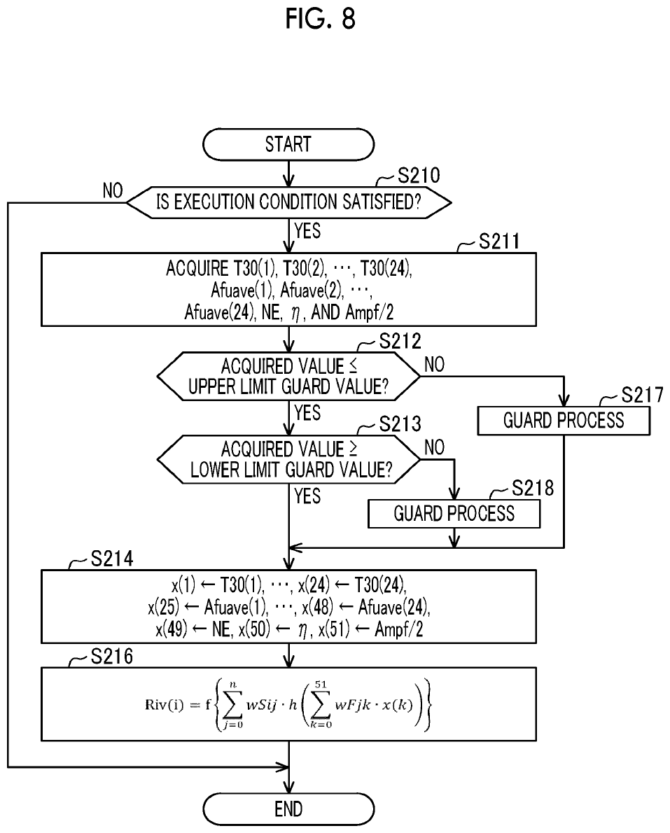

FIG. 8 illustrates a procedure of processes executed by the control device 70 in the present embodiment. The process illustrated in FIG. 8 is realized by the CPU 72 repeatedly executing the determination program 74a stored in the ROM 74 illustrated in FIG. 1 at a predetermined cycle, for example.

In the series of processes illustrated in FIG. 8, the CPU 72 first determines whether or not an execution condition of an imbalance detection process is satisfied (S210). Examples of the execution condition include that the purge of the fuel vapor and the recirculation of the exhaust gas with respect to the intake air of the internal combustion engine 10 are not performed.

Next, the CPU 72 acquires the minute rotation times T30(1), T30(2), . . . , T30(24), upstream average values Afuave(1), Afuave(2), . . . , Afuave(24), the rotation speed NE, the charging efficiency η, and a 0.5th-order amplitude Ampf/2 (S211). The minute rotation time T30 is calculated by the CPU 72 measuring the time needed for the crankshaft 24 to rotate by 30° CA based on the crank signal Scr of the crank angle sensor 80.

Assuming that m=1 to 24, the upstream average value Afuave(m) is an average value of the upstream detection values Afu at the angle interval of the same 30° CA as each minute rotation time T30(m).

The 0.5th-order amplitude Ampf/2 is an intensity of a 0.5th-order component of a rotation frequency of the crankshaft 24, and is calculated by the CPU 72 by the Fourier transform of the time-series data of the minute rotation time T30. It can be considered that a linear relationship is established between an imbalance rate Riv and the 0.5th-order amplitude which is the magnitude of the 0.5th-order component of the rotation frequency, and when the imbalance exists, the amplitude of the rotation frequency has a particularly large 0.5th-order component. This is considered to be because a generated torque is shifted once in one combustion cycle when an imbalance occurs in any one of the cylinders.

Next, the CPU 72 determines whether or not each of the values acquired in S211 is equal to or less than an upper limit guard value determined according to each acquired value (S212). The upper limit guard value is set for each type of the acquired values, and an upper limit guard value of the minute rotation time T30, an upper limit guard value of the upstream average value Afuave, an upper limit guard value of the rotation speed NE, an upper limit guard value of the charging efficiency η, and an upper limit guard value of the 0.5th-order amplitude Ampf/2 are set. Note that, each upper limit guard value is within the range of data input when mapping data 76a stored in the storage device 76 is learned by machine learning, and is defined as the upper limit value of the input data.

When the acquired value is equal to or less than the upper limit guard value (S212: YES), the CPU 72 determines whether or not each of the values acquired in S211 is equal to or greater than a lower limit guard value determined according to each acquired value (S213). The lower limit guard value is set for each type of the acquired values, and a lower limit guard value of the minute rotation time T30, a lower limit guard value of the upstream average value Afuave, a lower limit guard value of the rotation speed NE, a lower limit guard value of the charging efficiency η, and a lower limit guard value of the 0.5th-order amplitude Ampf/2 are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S213: YES), the CPU 72 inputs the acquired values to input variables x(1) to x(51) of a mapping that outputs the imbalance rate Riv (S214). Specifically, assuming that “m=1 to 24”, the CPU 72 assigns the minute rotation time T30(m) to the input variable x(m), assigns the upstream average value Afuave(m) to the input variable x(24+m), assigns the rotation speed NE to the input variable x(49), assigns the charging efficiency η to the input variable x(50), and assigns the 0.5th-order amplitude Ampf/2 to the input variable x(51).

In the present embodiment, the imbalance rate Riv is set to “0” in the cylinder in which the target injection amount of fuel is being injected, becomes a positive value when the actual injection amount is greater than the target injection amount, and becomes a negative value when the actual injection amount is less than the target injection amount.

Next, the CPU 72 calculates the respective imbalance rates Riv(1) to Riv(4) of the cylinders #i (i=1 to 4) by inputting the input variables x(1) to x(51) to the mapping defined by the mapping data 76a stored in the storage device 76 illustrated in FIG. 1 (S216).

In the present embodiment, the mapping includes a neural network having a single intermediate layer. The neural network includes an input-side coefficient wFjk (j=0 to n, k=0 to 51) and an activation function h(x) as an input-side nonlinear mapping that nonlinearly transforms each output of an input-side linear mapping, which is a linear mapping defined by the input-side coefficient wFjk. In the present embodiment, a hyperbolic tangent “tan h(x)” is exemplified as the activation function h(x). The neural network includes the output-side coefficient wSij (i=1 to 4, j=0 to n) and the activation function f(x) as an output-side nonlinear mapping that nonlinearly transforms each output of an output-side linear mapping, which is a linear mapping defined by the output-side coefficient wSij. In the present embodiment, the hyperbolic tangent “tan h(x)” is exemplified as the activation function f(x). Note that, the value n indicates the dimension of the intermediate layer.

When the value acquired in S211 exceeds the upper limit guard value (S212: NO), the CPU 72 performs a guard process of matching the acquired value to the upper limit guard value (S217). As a result, the acquired value exceeding the upper limit guard value is reset as the same value as the upper limit guard value, and then the above-described processes of S214 and S216 are performed.

When the value acquired in S211 is less than the lower limit guard value (S212: NO), the CPU 72 performs a guard process of matching the acquired value to the lower limit guard value (S218). As a result, the acquired value less than the lower limit guard value is reset as the same value as the lower limit guard value, and then the above-described processes of S214 and S216 are performed.

Then, the CPU 72 repeatedly executes the coping program 74b stored in the ROM 74 illustrated in FIG. 1 at a predetermined cycle based on, for example, the imbalance rate Riv calculated in S216 to realize a coping process. In the present embodiment, when the imbalance rate Riv is out of the predetermined variation range, a warning light 98 is operated by the coping program 74b in order to prompt the user for repair, and a coping process is performed.

Next, a method of generating the mapping data 76a will be described focusing on differences from the first embodiment. Data to be acquired for generating mapping data 76a are different. In the present embodiment, the adaptation device 104 acquires the minute rotation times T30(1), T30(2), . . . , T30(24), the upstream average values Afuave(1), Afuave(2), . . . , Afuave(24), the rotation speed NE, the charging efficiency and the 0.5th-order amplitude Ampf/2, as training data determined based on the detection result of the sensor group 102. In addition, this process is performed in a state where a plurality of the fuel injection valves 20 having the imbalance rate Riv of various values different from zero and three fuel injection valves 20 having an imbalance rate of zero are prepared in advance by single measurement, and three fuel injection valves 20 having an imbalance rate of zero and one fuel injection valve 20 having an imbalance rate different from zero are mounted on the internal combustion engine 10. Note that, an imbalance rate Rivt of each of the mounted fuel injection valves 20 is used as teacher data.

Next, the operation and effect of the present embodiment will be described. According to the above embodiment, the technique for the guard process can be applied in determining imbalance, which is a variation in air-fuel ratio between the cylinders, as the state of the internal combustion engine 10.

### Fifth Embodiment

Hereinafter, a fifth embodiment will be described with reference to the drawings, focusing on differences from the above-described first embodiment.

In the present embodiment, the state determination device for an internal combustion engine is configured as a device that determines catalyst deterioration. In the ROM 74 of the state determination device for the internal combustion engine 10 according to the present embodiment, a program for determining catalyst deterioration is stored as the determination program 74a.

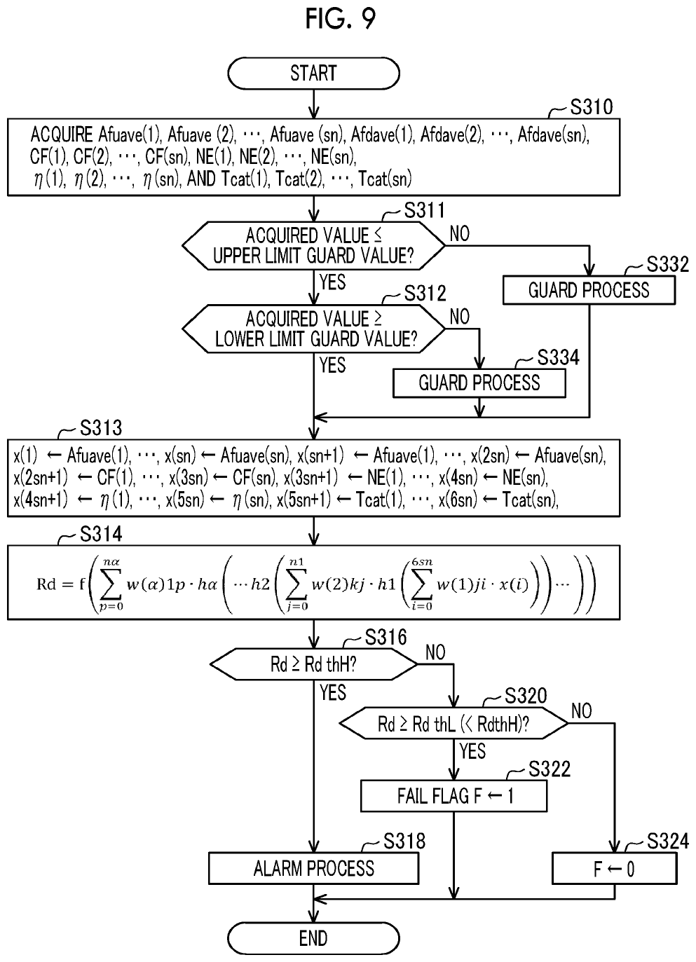

FIG. 9 illustrates a procedure of processes executed by the control device 70 in the present embodiment. The process illustrated in FIG. 9 is realized by the CPU 72 repeatedly executing the determination program 74a stored in the ROM 74 illustrated in FIG. 1 at a predetermined cycle, for example.

In the series of processes illustrated in FIG. 9, the CPU 72 firstly acquires time-series data in a predetermined period, for each of the upstream average value Afuave, a downstream average value Afdave, an in-catalyst flow rate CF, the rotation speed NE, the charging efficiency η, and the upstream catalyst temperature Tcat (S310) Similarly to the upstream average value Afuave, the downstream average value Afdave is an average value of the downstream detection value Afd at the sampling interval of the time-series data. The in-catalyst flow rate CF is a volume flow rate of the fluid flowing through the upstream catalyst 34, and is calculated by the CPU 72 based on the rotation speed NE and the charging efficiency η. In the present embodiment, the upstream catalyst temperature Tcat is calculated by the CPU 72 based on the rotation speed NE and the charging efficiency η.

Next, the CPU 72 determines whether or not each of the values acquired in S310 is equal to or less than an upper limit guard value determined according to each acquired value (S311). The upper limit guard value is set for each type of the acquired values, and an upper limit guard value of the upstream average value Afuave, an upper limit guard value of the downstream average value Afdave, an upper limit guard value of the in-catalyst flow rate CF, an upper limit guard value of the rotation speed NE, an upper limit guard value of the charging efficiency and an upper limit guard value of the upstream catalyst temperature Tcat are set. Note that, each upper limit guard value is within the range of data input when mapping data 76a stored in the storage device 76 is learned by machine learning, and is defined as the upper limit value of the input data.

When the acquired value is equal to or less than the upper limit guard value (S311: YES), the CPU 72 determines whether or not each of the values acquired in S310 is equal to or greater than a lower limit guard value determined according to each acquired value (S312). The lower limit guard value is set for each type of the acquired values, and a lower limit guard value of the upstream average value Afuave, a lower limit guard value of the downstream average value Afdave, a lower limit guard value of the in-catalyst flow rate CF, a lower limit guard value of the rotation speed NE, a lower limit guard value of the charging efficiency η, and a lower limit guard value of the upstream catalyst temperature Tcat are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S312: YES), the CPU 72 assigns the acquired values to the input variables x(1) to x(6sn) of the mapping that outputs a deterioration degree variable Rd, which is a variable indicating the degree of deterioration of the upstream catalyst 34 (S313). That is, assuming that m=1 to sn, the CPU 72 assigns the upstream average value Afuave(m) to the input variable x(m), assigns the downstream average value Afdave(m) to the input variable x(sn+m), assigns the in-catalyst flow rate CF(m) to the input variable x(2sn+m), and assigns the rotation speed NE(m) to the input variable x(3sn+m). In addition, the CPU 72 assigns the charging efficiency η(m) to the input variable x(4sn+m), and assigns the upstream catalyst temperature Tcat(m) to the input variable x(5sn+m).

Next, the CPU 72 calculates the deterioration degree variable Rd, which is the output value of the mapping, by inputting the input variables x(1) to x(6sn) to the mapping defined by the mapping data 76a stored in the storage device 76 illustrated in FIG. 1 (S314). Here, calculating the output value of the mapping refers to calculating the variable, which means calculating the value of the variable. In the present embodiment, the deterioration degree variable Rd is quantified as follows.

Rd=1−RR

RR=(a maximum value of an actual oxygen storage amount of the upstream catalyst 34 at a predetermined temperature)/(a maximum value of an oxygen storage amount of a reference catalyst at a predetermined temperature)

Accordingly, the deterioration degree variable Rd represents that the larger the value is, the larger the degree of deterioration is, and particularly, becomes “0” when the maximum value of the oxygen storage amount of the upstream catalyst 34 is equal to the maximum value of the oxygen storage amount of the reference catalyst.

In the present embodiment, the mapping includes a neural network in which the number of intermediate layers is “α”, activation functions h1 to hα of each intermediate layer are hyperbolic tangents, and an activation function f of the output layer is ReLU. Note that, the ReLU is a function that outputs the greater of the input and zero, or zero when the input is zero. For example, the value of each node in the first intermediate layer is generated by inputting the output when the input variables x(1) to x(6sn) are input to the linear mapping defined by coefficients w(1)ji (j=0 to n1, i=0 to 6sn) to the activation function h1. That is, assuming that m=1, 2, . . . , α, the value of each node of the m-th intermediate layer is generated by inputting the output of the linear mapping defined by the coefficient w(m) to the activation function hm. Here, the values n1, n2, . . . , nα are the numbers of nodes of the first, second, . . . , α-th intermediate layers, respectively. Incidentally, w(1)j0 and the like are bias parameters, and the input variable x(0) is defined as “1”.

Next, the CPU 72 determines whether or not the deterioration degree variable Rd is equal to or greater than a specified value RdthH (S316). When determination is made that the deterioration degree variable Rd is equal to or greater than the specified value RdthH (S316: YES), the CPU 72 operates the warning light 98 illustrated in FIG. 1 to execute an alarm process of notifying the outside in order to prompt a user for repair (S318).

On the other hand, when determination is made that the deterioration degree variable Rd is less than a specified value RdthH (S316: NO), the CPU 72 determines whether or not the deterioration degree variable Rd is equal to or greater than the predetermined value RdthL (S320). Here, the predetermined value RdthL is a value less than the specified value RdthH. When determination is made that the deterioration degree variable Rd is equal to or greater than the predetermined value RdthL (S320: YES), the CPU 72 sets the fail flag F to “1” (S322). Note that, when the process of S318 is performed, it is assumed that the fail flag F has already been set to “1”. Meanwhile, when determination is made that the deterioration degree variable Rd is less than the predetermined value RdthL (S320: NO), the CPU 72 assigns “0” to the fail flag F (S324).

Note that, when the processes of S318, S322, and S324 are completed, the CPU 72 temporarily ends the series of processes illustrated in FIG. 9. When the value acquired in S310 exceeds the upper limit guard value (S311: NO), the CPU 72 performs a guard process of matching the acquired value to the upper limit guard value (S332). As a result, the acquired value exceeding the upper limit guard value is reset as the same value as the upper limit guard value, and then the above-described processes of S313 to S324 are performed.

When the value acquired in S310 is less than the lower limit guard value (S312: NO), the CPU 72 performs a guard process of matching the acquired value to the lower limit guard value (S334). As a result, the acquired value less than the lower limit guard value is reset as the same value as the lower limit guard value, and then the above-described processes of S313 to S324 are performed.

Next, a method of generating the mapping data 76a will be described focusing on differences from the first embodiment. The sensor group 102 illustrated in FIG. 3 includes the upstream air-fuel ratio sensor 83, the downstream air-fuel ratio sensor 84, the crank angle sensor 80, and the like, which are sensors that detect a value for generating an input to the mapping.

In addition, data to be acquired for generating mapping data 76a are different. In the present embodiment, the adaptation device 104 acquires the same data as that acquired in the process of S310 as training data based on the detection result of the sensor group 102. Note that, the process is performed in a state where a plurality of the upstream catalysts 34 having different values of the deterioration degree variable Rd measured separately in advance are prepared, and one of the upstream catalysts 34 is selectively mounted on the internal combustion engine 10, and a deterioration degree variable Rdt of the mounted upstream catalyst 34 is used as teacher data.

Next, the operation and effect of the present embodiment will be described. According to the above embodiment, the technique for the guard process can be applied in determining imbalance, which is a variation in air-fuel ratio between the cylinders, as the state of the internal combustion engine 10.

### Sixth Embodiment

Hereinafter, a sixth embodiment will be described with reference to the drawings, focusing on differences from the above-described first embodiment.

In the present embodiment, the state determination device for an internal combustion engine is configured as a device that determines the presence or absence of an abnormality in a warm-up process of the upstream catalyst 34 provided in the exhaust passage 28 of the internal combustion engine 10. In the ROM 74 of the state determination device for the internal combustion engine 10 according to the present embodiment, a temperature estimation program, which is a program for estimating the temperature of the catalyst, and a monitoring program for monitoring the presence or absence of an abnormality in the warm-up process of the upstream catalyst 34 are stored as the determination program 74a.

In the present embodiment, when the internal combustion engine 10 is cold started, the control device 70 allows the ignition timing to be retarded by a predetermined amount with respect to the normal ignition timing determined by the rotation speed NE and the charging efficiency η, and executes a warm-up process of increasing the amount of heat, which does not contribute to torque, in the combustion energy of the air-fuel mixture. Specifically, the warm-up process is a process of allowing the ignition timing to be retarded when the coolant temperature THW at the time of starting is equal to or lower than a specified temperature, assuming that the engine is in cold start mode.

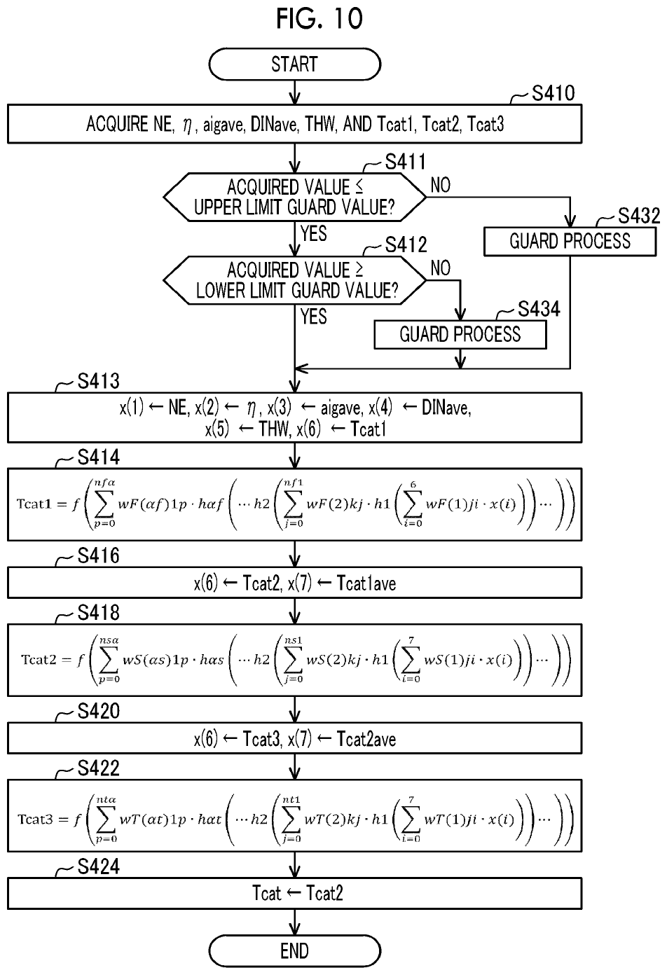

FIG. 10 illustrates a procedure of processes executed by the control device 70 in the present embodiment. The process illustrated in FIG. 10 is realized by the CPU 72 repeatedly executing the temperature estimation program stored in the ROM 74 illustrated in FIG. 1 at a predetermined cycle, for example.

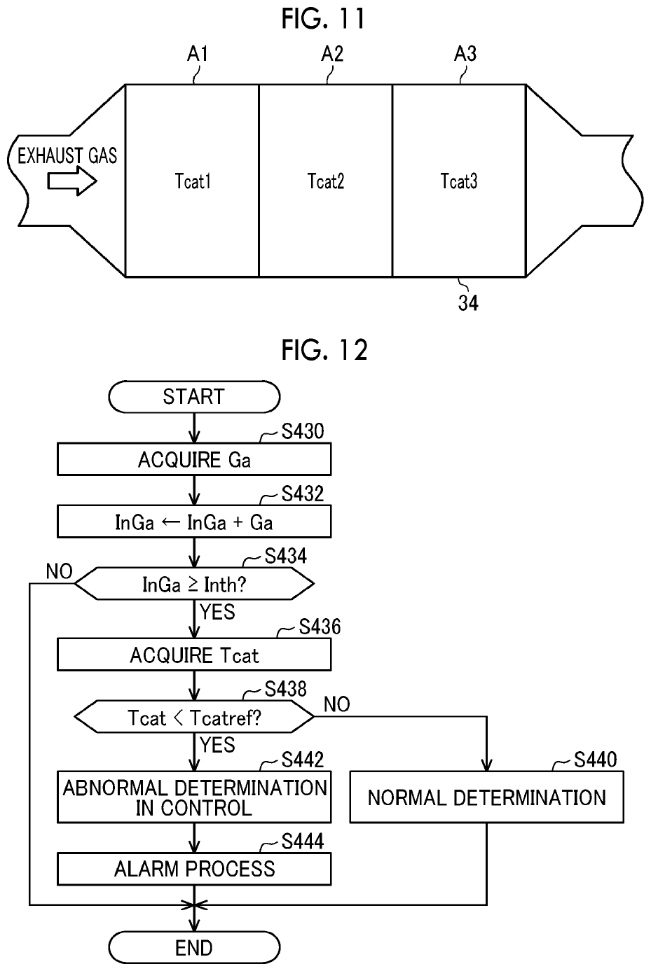

In the series of processes illustrated in FIG. 10, the CPU 72 first acquires the rotation speed NE, the charging efficiency η, an ignition timing average value aigave, an intake phase difference average value DINave, the coolant temperature THW, a previous value of a first temperature Tcat1, a previous value of a second temperature Tcat2, and a previous value of a third temperature Tcat3 (S410). Here, the ignition timing average value aigave and the intake phase difference average value DINave are an average value of an ignition timing aig and an average value of an intake phase difference DIN at the processing cycle of S410, respectively. As illustrated in FIG. 11, the first temperature Tcat1, the second temperature Tcat2, and the third temperature Tcat3 are temperatures of respective partial regions obtained by dividing a region from the upstream side to the downstream side of the upstream catalyst 34 into three partial regions, which are a first partial region A1, a second partial region A2, and a third partial region A3 in order from the upstream side. Note that, the previous value is a value calculated at the time of the previous execution of the series of processes illustrated in FIG. 10. The intake phase difference DIN is a phase difference between the rotation angle of the crankshaft 24 and the rotation angle of the intake-side camshaft 48 based on the crank signal Scr of the crank angle sensor 80 and the output signal Sca of the intake-side cam angle sensor 87.

Next, the CPU 72 determines whether or not each of the values acquired in S410 is equal to or less than an upper limit guard value determined according to each acquired value (S411). The upper limit guard value is set for each type of the acquired values, and an upper limit guard value of the rotation speed NE, an upper limit guard value of the charging efficiency η, an upper limit guard value of the ignition timing average value aigave, an upper limit guard value of the intake phase difference average value DINave, and an upper limit guard value of the coolant temperature THW are set. In addition, an upper limit guard value of the first temperature Tcat1, an upper limit guard value of the second temperature Tcat2, and an upper limit guard value of the third temperature Tcat3 are set. Note that, each upper limit guard value is within the range of data input when mapping data 76a stored in the storage device 76 is learned by machine learning, and is defined as the upper limit value of the input data.

When the acquired value is equal to or less than the upper limit guard value (S411: YES), the CPU 72 determines whether or not each of the values acquired in S410 is equal to or greater than a lower limit guard value determined according to each acquired value (S412). The lower limit guard value is set for each type of the acquired values, and a lower limit guard value of the rotation speed NE, a lower limit guard value of the charging efficiency η, a lower limit guard value of the ignition timing average value aigave, a lower limit guard value of the intake phase difference average value DINave, and a lower limit guard value of the coolant temperature THW are set. In addition, a lower limit guard value of the first temperature Tcat1, a lower limit guard value of the second temperature Tcat2, and a lower limit guard value of the third temperature Tcat3 are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S412: YES), the CPU 72 assigns values of the variables other than the second temperature Tcat2 and the third temperature Tcat3 among the acquired values to input variables of a mapping that outputs the first temperature Tcat1 (S413). That is, the CPU 72 assigns the rotation speed NE to the input variable x(1), assigns the charging efficiency η to the input variable x(2), assigns the ignition timing average value aigave to the input variable x(3), and assigns the intake phase difference average value DINave to the input variable x(4). In addition, the CPU 72 assigns the coolant temperature THW to the input variable x(5), and assigns the previous value of the first temperature Tcat1 to the input variable x(6).

Next, the CPU 72 calculates the first temperature Tcat1 by inputting the input variables x(1) to x(6) into the mapping that outputs the first temperature Tcat1 (S414). The mapping includes a neural network in which the number of intermediate layers is “αf”, activation functions h1 to hαf of each intermediate layer are hyperbolic tangents, and an activation function f of the output layer is ReLU. Note that, the ReLU is a function that outputs the greater of the input value and zero, or zero when the input value is zero.

For example, the value of each node in the first intermediate layer is generated by inputting the output when the input variables x(1) to x(6) are input to the linear mapping defined by coefficients wF(1)ji (j=0 to nf1, i=0 to 6) to the activation function h1. That is, assuming that m=1, 2, . . . , αf, the value of each node of the m-th intermediate layer is generated by inputting the output of the linear mapping defined by the coefficient wF(m) to the activation function hm. Here, the values nf1, nf2, . . . , nfα are the numbers of nodes of the first, second, . . . , αf-th intermediate layers, respectively. Incidentally, wF(1)j0 and the like are bias parameters, and the input variable x(0) is defined as “1”.

When the value acquired in S410 exceeds the upper limit guard value (S411: NO), the CPU 72 performs a guard process of matching the acquired value to the upper limit guard value (S432). As a result, the acquired value exceeding the upper limit guard value is reset as the same value as the upper limit guard value, and then the above-described processes of S413 and S414 are performed.

When the value acquired in S410 is less than the lower limit guard value (S412: NO), the CPU 72 performs a guard process of matching the acquired value to the lower limit guard value (S434). As a result, the acquired value less than the lower limit guard value is reset as the same value as the lower limit guard value, and then the above-described processes of S413 and S414 are performed.

Next, the CPU 72 generates the input variables x(1) to x(7) of the mapping that outputs the second temperature Tcat2 (S416). Here, the input variables x(1) to x(5) are the same as those generated in the process of S413. The CPU 72 assigns the previous value of the second temperature Tcat2 to the input variable x(6), and assigns a first temperature average value Tcat1ave to the input variable x(7). Note that, the first temperature average value Tcat1ave is an average value of a plurality of latest sampling values of the first temperature Tcat1 including the current value of the first temperature Tcat1, which is the first temperature Tcat1 calculated in the current process of S414.

Next, the CPU 72 calculates the second temperature Tcat2 by inputting the input variables x(1) to x(7) into the mapping that outputs the second temperature Tcat2 (S418). The mapping includes a neural network in which the number of intermediate layers is “as”, activation functions h1 to has of each intermediate layer are hyperbolic tangents, and an activation function f of the output layer is ReLU. For example, the value of each node in the first intermediate layer is generated by inputting the output when the input variables x(1) to x(7) are input to the linear mapping defined by coefficients wS(1)ji (j=0 to ns1, i=0 to 7) to the activation function h1. That is, assuming that m=1, 2, . . . , as, the value of each node of the m-th intermediate layer is generated by inputting the output of the linear mapping defined by the coefficient wS(m) to the activation function hm. Here, the values n1, n2, . . . , nαs are the numbers of nodes of the first, second, . . . , as-th intermediate layers, respectively. Incidentally, wS(1)j0 and the like are bias parameters, and the input variable x(0) is defined as “1”.

Next, the CPU 72 generates the input variables x(1) to x(7) of the mapping that outputs the third temperature Tcat3 (S420). Here, the input variables x(1) to x(5) are the same as those generated in the process of S413. The CPU 72 assigns the previous value of the third temperature Tcat3 to the input variable x(6), and assigns a second temperature average value Tcat2ave to the input variable x(7). Note that, the second temperature average value Tcat2ave is an average value of a plurality of latest sampling values of the second temperature Tcat2 including the current value of the second temperature Tcat2, which is the second temperature Tcat2 calculated in the current process of S418.

Next, the CPU 72 calculates the third temperature Tcat3 by inputting the input variables x(1) to x(7) into the mapping that outputs the third temperature Tcat3 (S422). The mapping includes a neural network in which the number of intermediate layers is “αt”, activation functions h1 to hαt of each intermediate layer are hyperbolic tangents, and an activation function f of the output layer is ReLU. For example, the value of each node in the first intermediate layer is generated by inputting the output when the input variables x(1) to x(7) are input to the linear mapping defined by coefficients wT(1)ji (j=0 to nt1, i=0 to 7) to the activation function h1. That is, assuming that m=1, 2, . . . , at, the value of each node of the m-th intermediate layer is generated by inputting the output of the linear mapping defined by the coefficient wT(m) to the activation function hm. Here, the values n1, n2, . . . , nαt are the numbers of nodes of the first, second, . . . , αt-th intermediate layers, respectively. Incidentally, wT(1)j0 and the like are bias parameters, and the input variable x(0) is defined as “1”.

Next, the CPU 72 assigns the second temperature Tcat2 calculated in the current process of S418 to the upstream catalyst temperature Tcat (S424), and temporarily ends the series of processes. Incidentally, when the process of FIG. 10 is executed first, a predetermined default value may be used as the previous value of the first temperature Tcat1, the previous value of the second temperature Tcat2, and the previous value of the third temperature Tcat3. Even when the default value deviates from the actual temperature, the process of FIG. 10 is repeated, so that the first temperature Tcat1, the second temperature Tcat2, and the third temperature Tcat3 converge to correct values.

FIG. 12 illustrates a procedure of a process of monitoring the presence or absence of an abnormality in the warm-up process of the upstream catalyst 34 according to the present embodiment. The process illustrated in FIG. 12 is realized by the CPU 72 repeatedly executing the monitoring program stored in the ROM 74 illustrated in FIG. 1 at a predetermined cycle, for example, until a normal or abnormal determination is made in accordance with the cold start of the internal combustion engine 10.

In the series of processes illustrated in FIG. 12, the CPU 72 first acquires the intake air amount Ga (S430). Then, the CPU 72 updates an integrated value InGa by adding the intake air amount Ga acquired in the process of S430 to the integrated value InGa (S432). Then, the CPU 72 determines whether or not the integrated value InGa is equal to or greater than a predetermined value Inth (S434). Here, when warm-up control of the upstream catalyst 34 is normally performed, the predetermined value Inth is set to an allowable upper limit value at which the temperature of the upstream catalyst 34 reaches a reference temperature Tcatref. That is, when the intake air amount Ga is large, the fuel injection amount is larger than when the intake air amount Ga is small, and the combustion energy generated in the combustion chamber 18 is also large. Accordingly, the total amount of heat received by the upstream catalyst 34 is also large. Therefore, the time when the integrated value InGa reaches the predetermined value Inth can be set as an allowable upper limit time for the upstream catalyst 34 to reach the reference temperature Tcatref. Note that, the reference temperature Tcatref is set in accordance with the temperature at which the upstream catalyst 34 is activated.

When determination is made that the integrated value InGa is equal to or greater than the predetermined value Inth (S434: YES), the CPU 72 acquires the upstream catalyst temperature Tcat (S436). Then, the CPU 72 determines whether or not the upstream catalyst temperature Tcat is lower than the reference temperature Tcatref (S438). The process is a process of determining whether or not the above-described warm-up process has been performed normally and an abnormality has occurred in the warm-up control of the upstream catalyst 34.

Then, when determination is made that the upstream catalyst temperature Tcat is equal to or higher than the reference temperature Tcatref (S438: NO), the CPU 72 makes a normal determination (S440). On the other hand, when determination is made that the upstream catalyst temperature Tcat is lower than the reference temperature Tcatref (S438: YES), the CPU 72 determines that there is an abnormality in the warm-up control of the upstream catalyst 34 (S442). Then, the CPU 72 executes an alarm process of operating the warning light 98 illustrated in FIG. 1 by the coping program 74b in order to prompt the user to cope with the abnormality (S444).

Note that, when the processes of S440 and S444 are completed, or when a negative determination is made in the process of S434, the CPU 72 temporarily ends the series of processes illustrated in FIG. 12. Next, a method of generating the mapping data 76a will be described focusing on differences from the first embodiment.

The sensor group 102 illustrated in FIG. 3 includes the air flow meter 82, the crank angle sensor 80, the intake-side cam angle sensor 87, the coolant temperature sensor 89, and the like, which are sensors that detect a value for generating an input to the mapping. In addition, the sensor group 102 includes a temperature sensor that detects the temperature of each of the first partial region A1, the second partial region A2, and the third partial region A3 of the upstream catalyst 34.

Data to be acquired for generating mapping data 76a are different. In the present embodiment, based on the detection result of the sensor group 102, the adaptation device 104 acquires the same data as those acquired in the process of S410 as training data, and also acquires a first temperature Tcat1t, a second temperature Tcat1t, and a third temperature Tcat3t, which are detection values of the temperature sensor as teacher data in the training data.

Next, the operation and effect of the present embodiment will be described. According to the above embodiment, the technique for the guard process can be applied in determining the presence or absence of an abnormality in the warm-up process of the upstream catalyst 34 provided in the exhaust passage 28 of the internal combustion engine 10, as the state of the internal combustion engine 10.

### Seventh Embodiment

Hereinafter, a seventh embodiment will be described with reference to the drawings, focusing on differences from the above-described first embodiment.

In the present embodiment, the state determination device for an internal combustion engine is configured as a device that determines an estimated value of the oxygen storage amount of the upstream catalyst 34 provided in the exhaust passage 28 of the internal combustion engine 10. In the ROM 74 of the state determination device for the internal combustion engine 10 according to the present embodiment, a program for determining an estimated value of the oxygen storage amount of the upstream catalyst 34 is stored as the determination program 74a.

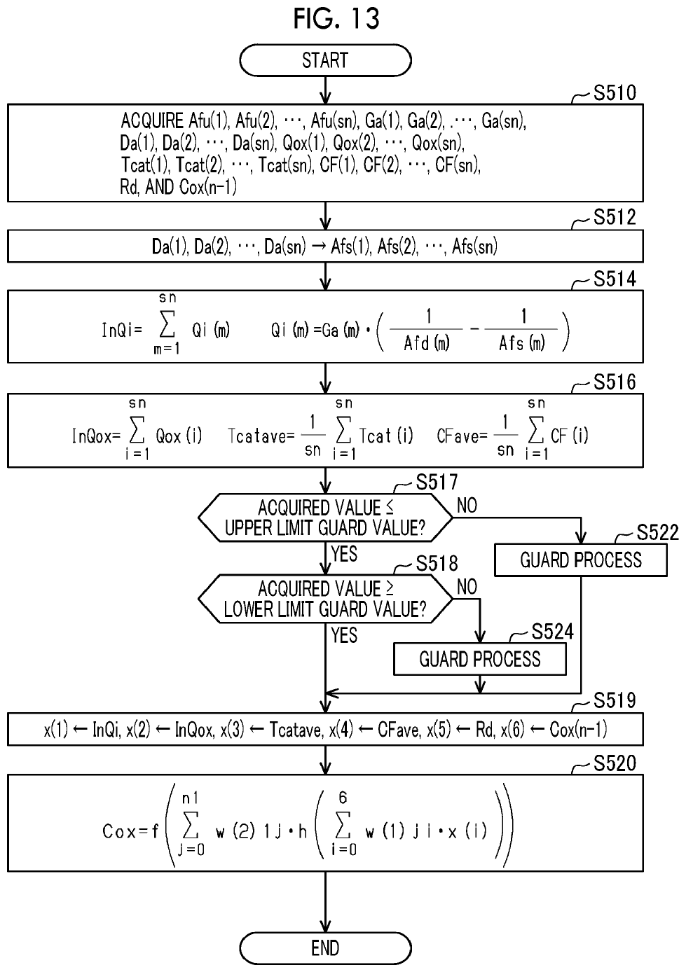

FIG. 13 illustrates a procedure of processes executed by the control device 70 in the present embodiment. The process illustrated in FIG. 13 is realized by the CPU 72 repeatedly executing the determination program 74a stored in the ROM 74 illustrated in FIG. 1 at a predetermined cycle, for example.

In the series of processes illustrated in FIG. 13, the CPU 72 first acquires time-series data in a predetermined period, for each of the upstream detection value Afu, the intake air amount Ga, the alcohol concentration Da, an oxidation amount Qox, the upstream catalyst temperature That, and the in-catalyst flow rate CF, the deterioration degree variable Rd during the same period, and a previous value of an oxygen storage amount Cox (S510). In the following, for example, the time-series data of the upstream detection value Afu is described as “Afu(1) to Afu(sn)” as “1, 2, . . . , Sn” in ascending order of sampling timing. Here, “sn” is the number of data included in the time-series data of each variable. The previous value of the oxygen storage amount Cox is a value calculated at the previous execution timing of the series of processes of FIG. 13, and is described as “Cox(n−1)” in FIG. 13. Incidentally, when the process of FIG. 13 is executed first, the oxygen storage amount Cox may be set to a default value. Here, the default value may be an assumed value when the internal combustion engine 10 has been stopped for a long time. The oxidation amount Qox is determined by the CPU 72 based on the intake air amount Ga, the upstream detection value Afu, and the upstream catalyst temperature Tcat. For example, the oxidation amount Qox is calculated to be larger when the upstream catalyst temperature Tcat is high than when it is low.

Next, assuming that m=1 to sn, the CPU 72 calculates a stoichiometric air-fuel ratio Afs(m) of the fuel having the alcohol concentration Da(m) (S512). Here, the CPU 72 calculates the stoichiometric air-fuel ratio Afs(m) to be a smaller value when the alcohol concentration Da(m) is high than when it is low.

Next, the CPU 72 calculates a fuel excess or deficiency amount-integrated value InQi, which is an integrated value of a fuel excess or deficiency amount Qi, which is an actual excess or deficiency amount of fuel with respect to the amount of fuel needed for setting the air-fuel ratio of the air-fuel mixture in the combustion chamber 18 to the stoichiometric air-fuel ratio (S514). When the fuel excess or deficiency amount Qi according to the present embodiment is a positive value, the fuel excess or deficiency amount Qi indicates an actual excess amount of fuel with respect to the amount of fuel needed for setting the air-fuel ratio of the air-fuel mixture in the combustion chamber 18 to the stoichiometric air-fuel ratio. Specifically, assuming that m=1 to sn, the CPU 72 first calculates the fuel excess or deficiency amount Qi(m) as “Ga(m)·[{1/Afd(m)}−{1/Afs(m)}]”. Then, the CPU 72 calculates the fuel excess or deficiency amount-integrated value InQi by totalizing fuel excess or deficiency amounts Qi(1) to Qi(sn).

Next, the CPU 72 calculates an oxidation amount-integrated value InQox, an upstream catalyst temperature average value Tcatave, and an in-catalyst flow rate average value CFave (S516). That is, the CPU 72 calculates the oxidation amount-integrated value InQox by totalizing oxidation amounts Qox(1) to Qox(sn). In addition, the CPU 72 calculates the upstream catalyst temperature average value Tcatave by dividing the total value of upstream catalyst temperatures Tcat(1) to Tcat(sn) by “sn”. In addition, the CPU 72 calculates the in-catalyst flow rate average value CFave by dividing the total value of in-catalyst flow rates CF(1) to CF(sn) by “sn”.

Next, the CPU 72 determines whether or not each of the values acquired in S510 to S516 is equal to or less than an upper limit guard value determined according to each acquired value (S517). The upper limit guard value is set for each type of the acquired values, and an upper limit guard value of the fuel excess or deficiency amount-integrated value InQi, an upper limit guard value of the oxidation amount-integrated value InQox, an upper limit guard value of the upstream catalyst temperature average value Tcatave, an upper limit guard value of the in-catalyst flow rate average value CFave, an upper limit guard value of the deterioration degree variable Rd, and an upper limit guard value of the oxygen storage amount Cox are set. Note that, each upper limit guard value is within the range of data input when mapping data 76a stored in the storage device 76 is learned by machine learning, and is defined as the upper limit value of the input data.

When the acquired value is equal to or less than the upper limit guard value (S517: YES), the CPU 72 determines whether or not each of the values acquired in S510 is equal to or greater than a lower limit guard value determined according to each acquired value (S518). The lower limit guard value is set for each type of the acquired values, and a lower limit guard value of the fuel excess or deficiency amount-integrated value InQi, a lower limit guard value of the oxidation amount-integrated value InQox, a lower limit guard value of the upstream catalyst temperature average value Tcatave, a lower limit guard value of the in-catalyst flow rate average value CFave, a lower limit guard value of the deterioration degree variable Rd, and a lower limit guard value of the oxygen storage amount Cox are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S518: YES), the CPU 72 assigns the values acquired in the processes of S514 and S516, the deterioration degree variable Rd, or the previous value Cox(n−1) to input variables x(1) to x(6) of a mapping that outputs the oxygen storage amount Cox (S519). That is, the CPU 72 assigns the fuel excess or deficiency amount-integrated value InQi to the input variable x(1), assigns the oxidation amount-integrated value InQox to the input variable x(2), and assigns the upstream catalyst temperature average value Tcatave to the input variable x(3). In addition, the CPU 72 assigns the in-catalyst flow rate average value CFave to the input variable x(4), assigns the deterioration degree variable Rd to the input variable x(5), and assigns the previous value Cox(n−1) to the input variable x(6).

Then, the CPU 72 calculates the oxygen storage amount Cox by assigning the input variables x(1) to x(6) to the mapping defined by the mapping data 76a illustrated in FIG. 1 (S520).

In the present embodiment, the mapping includes a neural network in which the number of intermediate layers is one, an activation function h of the intermediate layer is a hyperbolic tangent, and an activation function f of the output layer is ReLU. Note that, the ReLU is a function that outputs the greater of the input and zero, or zero when the input is zero. Here, the value of each of the “n1” nodes of the intermediate layer is generated by inputting each of n1 output values when the input variables x(1) to x(6) are input to the linear mapping defined by coefficients w(1)ji (j=0 to n1, i=0 to 6) to the activation function h. Incidentally, w(1)j0 and the like are bias parameters, and the input variable x(0) is defined as “1”.

Note that, when the process of S520 is completed, the CPU 72 temporarily ends the series of processes illustrated in FIG. 13. When the values acquired in S510 to S516 exceed the upper limit guard value (S517: NO), the CPU 72 performs a guard process of matching the acquired value to the upper limit guard value (S522). As a result, the acquired value exceeding the upper limit guard value is reset as the same value as the upper limit guard value, and then the above-described processes of S519 and S520 are performed.

When the values acquired in S510 to S516 are less than the lower limit guard value (S518: NO), the CPU 72 performs a guard process of matching the acquired value to the lower limit guard value (S524). As a result, the acquired value less than the lower limit guard value is reset as the same value as the lower limit guard value, and then the above-described processes of S519 and S520 are performed.

Incidentally, the mapping data 76a may be learned as follows. That is, the air-fuel ratio sensors are provided on the upstream side and the downstream side of the upstream catalyst 34, and the internal combustion engine 10 is operated. Then, when the above-described upstream detection value Afu, which is a detection value of the air-fuel ratio sensor on the upstream side of the upstream catalyst 34, is lean, the flow rate of oxygen flowing in the upstream catalyst 34 is calculated from the upstream detection value Afu and the intake air amount Ga, while the flow rate of oxygen flowing out of the upstream catalyst 34 is calculated from the above-described downstream detection value Afd, which is a detection value of the air-fuel ratio sensor on the downstream side of the upstream catalyst 34, and the intake air amount Ga. Thus, the amount of increase in the oxygen storage amount Cox of the upstream catalyst 34 when the upstream detection value Afu is lean is calculated. Meanwhile, when the upstream detection value Afu is rich, the flow rate of the unburned fuel to the upstream catalyst 34 is calculated from the upstream detection value Afu and the intake air amount Ga, while the flow rate of the unburned fuel flowing out of the upstream catalyst 34 is calculated from the downstream detection value Afd and the intake air amount Ga. Thus, the amount of decrease in the oxygen storage amount Cox of the upstream catalyst 34 when the upstream detection value Afu is rich is calculated. Then, while the teacher data of the oxygen storage amount Cox is calculated based on the amount of increase or decrease of the oxygen storage amount Cox, while the oxygen storage amount Cox is calculated in the same process as the process of FIG. 3, and the coefficients w(1)ji, w(2)lj are updated so as to reduce the sum of squares of those errors.

When the oxygen storage amount Cox is calculated, the CPU 72 executes an oxidation amount estimation process of calculating the oxidation amount Qox based on the oxygen storage amount Cox. Further, when the oxygen storage amount Cox is equal to or less than a predetermined value, the CPU 72 executes a process of setting a target value Af* to be leaner than normal in a period in which the target value Af* is leaner than the stoichiometric air-fuel ratio.

Next, the operation and effect of the present embodiment will be described. According to the above embodiment, the technique for the guard process can be applied in determining an estimated value of the oxygen storage amount of the upstream catalyst 34 provided in the exhaust passage 28 of the internal combustion engine 10, as the state of the internal combustion engine 10.

### Eighth Embodiment

Hereinafter, an eighth embodiment will be described with reference to the drawings, focusing on differences from the above-described first embodiment.

In the present embodiment, the state determination device for an internal combustion engine is configured as a device that determines an estimated value of the amount of PM collected by a filter that collects PM in the exhaust gas discharged into the exhaust passage 28 of the internal combustion engine 10. In the ROM 74 of the state determination device for the internal combustion engine 10 according to the present embodiment, a program for determining an estimated value of the PM amount is stored as the determination program 74a.

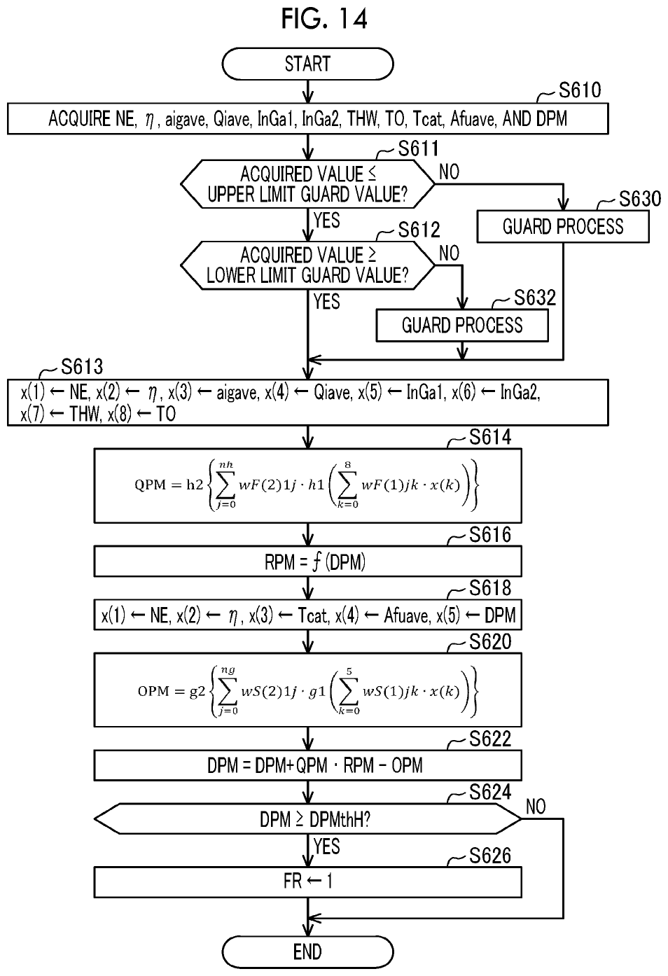

FIG. 14 illustrates a procedure of processes executed by the control device 70 in the present embodiment. The process illustrated in FIG. 14 is realized by the CPU 72 repeatedly executing the determination program 74a stored in the ROM 74 illustrated in FIG. 1 at a predetermined cycle, for example.

In the series of processes illustrated in FIG. 14, the CPU 72 acquires the rotation speed NE, the charging efficiency η, the ignition timing average value aigave, the fuel excess or deficiency amount average value Qiave, a start-up integrated air amount InGa1, a post-start integrated air amount InGa2, the coolant temperature THW, the intake air temperature TO, the upstream catalyst temperature Tcat, the upstream average value Afuave, and a PM accumulation amount DPM, which is the PM amount (S610). Note that, the PM accumulation amount DPM acquired here is the previous value calculated at the previous execution timing of the series of processes in FIG. 14. Note that, an initial value of the PM accumulation amount DPM when the processes of FIG. 14 have not been executed at all is zero. The ignition timing average value aigave, the fuel excess or deficiency amount average value Qiave, and the upstream average value Afuave are the average value of the ignition timing aig, the average value of the fuel excess or deficiency amount Qi, and the average value of the upstream detection value Afu at the processing cycle of S610, respectively. For example, the CPU 72 samples the upstream detection value Afu a plurality of times at the processing cycle of S610, calculates an average value thereof, and sets the average value as the upstream average value Afuave. The fuel excess or deficiency amount average value Qiave is an average value of the fuel excess or deficiency amount Qi of a requested injection amount Qd with respect to a base injection amount Qb, and can take a negative value. The fuel excess or deficiency amount Qi indicates an excess or deficiency with respect to the amount of fuel needed for setting the air-fuel ratio of the air-fuel mixture to the stoichiometric air-fuel ratio.

The start-up integrated air amount InGa1 is an integrated value of the amount of air taken in at the time of starting. The post-start integrated air amount InGa2 is an integrated value of the intake air amount Ga after the start.

Next, the CPU 72 determines whether or not each of the values acquired in S610 is equal to or less than an upper limit guard value determined according to each acquired value (S611). The upper limit guard value is set for each type of the acquired values, and an upper limit guard value of the rotation speed NE, an upper limit guard value of the charging efficiency an upper limit guard value of the ignition timing average value aigave, an upper limit guard value of the fuel excess or deficiency amount average value Qiave, an upper limit guard value of the start-up integrated air amount InGa1, an upper limit guard value of the post-start integrated air amount InGa2, an upper limit guard value of the coolant temperature THW, an upper limit guard value of the intake air temperature TO, an upper limit guard value of the upstream catalyst temperature Tcat, an upper limit guard value of the upstream average value Afuave, and an upper limit guard value of the PM accumulation amount DPM are set. Note that, each upper limit guard value is within the range of data input when mapping data 76a stored in the storage device 76 is learned by machine learning, and is defined as the upper limit value of the input data.

When the acquired value is equal to or less than the upper limit guard value (S611: YES), the CPU 72 determines whether or not each of the values acquired in S610 is equal to or greater than a lower limit guard value determined according to each acquired value (S612). The lower limit guard value is set for each type of the acquired values, and a lower limit guard value of the rotation speed NE, a lower limit guard value of the charging efficiency η, a lower limit guard value of the ignition timing average value aigave, a lower limit guard value of the fuel excess or deficiency amount average value Qiave, a lower limit guard value of the start-up integrated air amount InGa1, a lower limit guard value of the post-start integrated air amount InGa2, a lower limit guard value of the coolant temperature THW, a lower limit guard value of the intake air temperature TO, a lower limit guard value of the upstream catalyst temperature Tcat, a lower limit guard value of the upstream average value Afuave, and a lower limit guard value of the PM accumulation amount DPM are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S612: YES), the CPU 72 sets some variables acquired in the process of S610 as input variables of the mapping that is defined by the mapping data 76a stored in the storage device 76 illustrated in FIG. 1 and that outputs a PM discharge amount QPM which is the amount of PM discharged into the exhaust passage 28 (S613). That is, the CPU 72 assigns the rotation speed NE to the input variable x(1), assigns the charging efficiency η to the input variable x(2), assigns the ignition timing average value aigave to the input variable x(3), the fuel excess or deficiency amount average value Qiave to the input variable x(4), the start-up integrated air amount InGa1 to the input variable x(5), and the post-start integrated air amount InGa2 to the input variable x(6). In addition, the CPU 72 assigns the coolant temperature THW to the input variable x(7), and assigns the intake air temperature TO to the input variable x(8).

Next, the CPU 72 calculates the PM discharge amount QPM by inputting the input variables x(1) to x(8) into the mapping that outputs the PM discharge amount QPM (S614). The mapping according to the present embodiment includes a neural network in which the number of intermediate layers is one, an activation function h1 of the intermediate layer is a hyperbolic tangent, and an activation function h2 of the output layer is ReLU. Note that, the ReLU is a function that outputs the greater of the input and zero, or zero when the input is zero.

Here, the value of each node in the intermediate layer is generated by inputting each of “nh”-dimensional output values when the input variables x(1) to x(8) are input to the linear mapping defined by coefficients wF(1)jk (j=1 to nh, k=0 to 8) to the activation function h1. Incidentally, wF(1)j0 is a bias parameter, and the input variable x(0) is defined as “1”. Further, the output layer is generated by inputting the output when the value of the node of the intermediate layer is input to the linear mapping defined by the coefficient wF(2)1j to the activation function h2. Here, the coefficient wF(2)10 is a bias parameter.

Next, the CPU 72 calculates a collection rate RPM, which is a proportion of the PM in the exhaust gas discharged into the exhaust passage 28 to be collected by the upstream catalyst 34 as a filter, based on the previous value of the PM accumulation amount DPM acquired in the process of S610 (S616). Specifically, the CPU 72 performs a map calculation of the collection rate RPM in a state where map data having the previous value of the PM accumulation amount DPM as an input variable and the collection rate RPM as an output variable is stored in the ROM 74 in advance.

Next, the CPU 72 sets some variables acquired in the process of S610 as input variables of the mapping that is defined by the mapping data 76a stored in the storage device 76 illustrated in FIG. 1 and that outputs a PM oxidation amount OPM which is an oxidation amount of PM by the upstream catalyst 34 (S618). That is, the CPU 72 assigns the rotation speed NE to the input variable x(1), assigns the charging efficiency η to the input variable x(2), assigns the upstream catalyst temperature Tcat to the input variable x(3), assigns the upstream average value Afuave to the input variable x(4), and assigns the previous value of the PM accumulation amount DPM to the input variable x(5).

Next, the CPU 72 calculates the PM oxidation amount OPM by inputting the input variables x(1) to x(5) generated by the process of S618 into the mapping that outputs the PM oxidation amount OPM (S620). The mapping according to the present embodiment includes a neural network in which the number of intermediate layers is one, an activation function g1 of the intermediate layer is a hyperbolic tangent, and an activation function g2 of the output layer is ReLU.

Here, the value of each node in the intermediate layer is generated by inputting each of “ng”-dimensional output values when the input variables x(1) to x(5) by the process of S618 are input to the linear mapping defined by coefficients wS(1)jk (j=1 to ng, k=0 to 5) to the activation function g1. Incidentally, wS(1)j0 is a bias parameter, and the input variable x(0) is defined as “1”. Further, the output layer is generated by inputting the output when the value of the node of the intermediate layer is input to the linear mapping defined by the coefficient wS(2)lj to the activation function g2. Note that, the coefficient wS(2)10 is a bias parameter.

Next, the CPU 72 adds a value obtained by subtracting the PM oxidation amount OPM from a value obtained by multiplying the PM discharge amount QPM by the collection rate RPM to the previous value of the PM accumulation amount DPM acquired in the process of S610, thereby updating the PM accumulation amount DPM (S622). Then, the CPU 72 determines whether or not the PM accumulation amount DPM is equal to or greater than a predetermined amount DPMthH (S624). When determination is made that the PM accumulation amount DPM is equal to or greater than the predetermined amount DPMthH (S624: YES), the CPU 72 assigns “1” to a reproduction flag FR (S626). Incidentally, an initial value of the reproduction flag FR is “0”.

Note that, when the process of S626 is completed, or when a negative determination is made in the process of S624, the CPU 72 temporarily ends the series of processes illustrated in FIG. 14. When the value acquired in S610 exceeds the upper limit guard value (S611: NO), the CPU 72 performs a guard process of matching the acquired value to the upper limit guard value (S630). As a result, the acquired value exceeding the upper limit guard value is set as the value of the upper limit guard value, and then the above-described processes of S613 to S626 are performed.

When the value acquired in S610 is less than the lower limit guard value (S612: NO), the CPU 72 performs a guard process of matching the acquired value to the lower limit guard value (S632). As a result, the acquired value less than the lower limit guard value is set as the value of the lower limit guard value, and then the above-described processes of S613 to S626 are performed.

Next, a method of generating the mapping data 76a will be described focusing on differences from the first embodiment. The sensor group 102 illustrated in FIG. 3 includes a PM sensor that detects a flow rate of PM discharged into the exhaust passage 28.

In addition, data to be acquired for generating mapping data 76a are different. In the present embodiment, based on the detection result of the sensor group 102, the adaptation device 104 acquires the same data as those acquired in the process of S610 as training data, and also acquires a PM discharge amount QPMt detected by the PM sensor as teacher data in the training data.

Next, the operation and effect of the present embodiment will be described. According to the above embodiment, the technique for the guard process can be applied in determining an estimated value of the amount of PM collected by the filter that collects PM in the exhaust gas discharged into the exhaust passage 28 of the internal combustion engine 10, as the state of the internal combustion engine 10.

### Ninth Embodiment

Hereinafter, a ninth embodiment will be described with reference to the drawings, focusing on differences from the above-described first embodiment.

In the present embodiment, the state determination device for an internal combustion engine is configured as a device that determines the presence or absence of an abnormality of the upstream air-fuel ratio sensor 83 provided in the exhaust passage 28 of the internal combustion engine 10. In the ROM 74 of the state determination device for the internal combustion engine 10 according to the present embodiment, a program for determining the presence or absence of an abnormality of the upstream air-fuel ratio sensor 83 provided in the exhaust passage 28 of the internal combustion engine 10 is stored as the determination program 74a.

The CPU 72 executes a base injection amount calculation process. The base injection amount calculation process is a process of calculating the base injection amount Qb, which is a base value of a fuel amount for setting the air-fuel ratio of the air-fuel mixture in the combustion chamber 18 to the target air-fuel ratio, based on the charging efficiency η Specifically, in the base injection amount calculation process, for example, when the charging efficiency η is expressed as a percentage, a fuel amount QTH per 1% of the charging efficiency η for setting the air-fuel ratio to the target air-fuel ratio is multiplied by the charging efficiency and thereby a process of calculating the base injection amount Qb may be performed. The base injection amount Qb is a fuel amount calculated for controlling the air-fuel ratio to the target air-fuel ratio based on the amount of air charged into the combustion chamber 18. Incidentally, in the present embodiment, a stoichiometric air-fuel ratio is exemplified as the target air-fuel ratio.

The CPU 72 executes a main feedback process. The main feedback process is a process of calculating a feedback correction coefficient KAF by adding “1” to a correction ratio δ that is an operation amount for performing feedback control of the upstream detection value Afu that is a feedback control amount to the target value Af*. The feedback correction coefficient KAF is a correction coefficient for the base injection amount Qb. Here, when the correction ratio δ is “0”, the base injection amount Qb is not corrected. When the correction ratio δ is larger than “0”, the base injection amount Qb is corrected in an increased manner, and when the correction ratio δ is smaller than “0”, the base injection amount Qb is corrected in a decreased manner. In the present embodiment, the sum of the sum of output values of a proportional element and a differential element, which uses the difference between the target value AP and the upstream detection value Afu as an input, and an output value of an integral element, which uses the integrated value of the value corresponding to the difference between the target value Af* and the upstream detection value Afu as an output, is set as the correction ratio δ.

The CPU 72 executes a sub-feedback process. The sub-feedback process is a process of, when the downstream detection value Afd becomes rich with respect to the stoichiometric air-fuel ratio Afs by a predetermined amount εr or more, making the target value Af* lean by a specified amount δ1 with respect to the stoichiometric air-fuel ratio Afs. In addition, the sub-feedback process is a process of, when the downstream detection value Afd becomes lean with respect to the stoichiometric air-fuel ratio Afs by a predetermined amount el or more, making the target value Af* rich by a specified amount or with respect to the stoichiometric air-fuel ratio Afs.

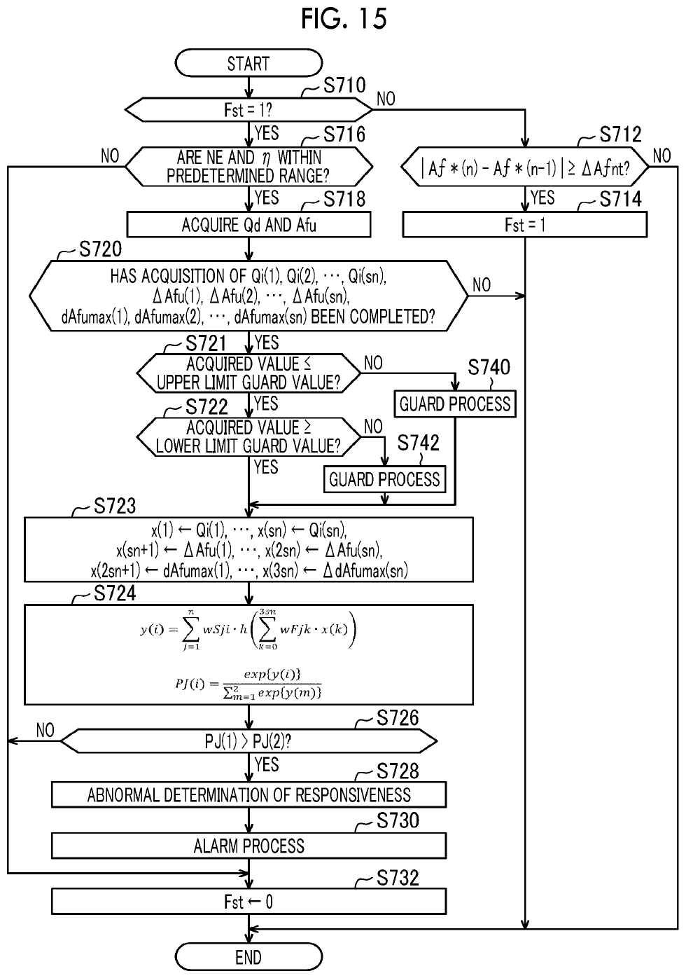

FIG. 15 illustrates a procedure of processes executed by the control device 70 in the present embodiment. The process illustrated in FIG. 15 is realized by the CPU 72 repeatedly executing the determination program 74a stored in the ROM 74 illustrated in FIG. 1 at a predetermined cycle, for example.

In the series of processes illustrated in FIG. 15, the CPU 72 first determines whether or not a start flag Fst is “1” (S710). When the start flag Fst is “1”, it indicates that sampling of a sensor detection value related to an input variable for determining the presence or absence of an abnormality of the upstream air-fuel ratio sensor 83 is started. When the start flag Fst is “0”, it indicates that the sampling is not started.

When determination is made that the start flag Fst is “0” (S710: NO), the CPU 72 determines whether or not the absolute value of a value obtained by subtracting the previous value Af*(n−1) from a current value Af*(n) of the target value Af* is equal to or greater than a predetermined value ΔAfth (S712). Here, the current value Af*(n) is a target value Af* at the current execution timing of the series of processes illustrated in FIG. 15, and the previous value Af*(n−1) is a target value AP at the previous execution timing of the series of processes illustrated in FIG. 15. The predetermined value ΔAfth is set to a value equal to or less than the sum of the specified amount 61 and the specified amount δr.

At the time when the target value Af* switches from one of two states, a state in which the target value Af* is lean with respect to the stoichiometric air-fuel ratio Afs by the specified amount δ1 and a state in which the target value AP is rich with respect to the stoichiometric air-fuel ratio Afs by the specified amount δr, to the other, the CPU 72 determines that the value is equal to or greater than the predetermined value ΔAfth (S712: YES), and assigns “1” to the start flag Fst (S714).

On the other hand, when determination is made that the start flag Fst is “1” (S710: YES), the CPU 72 determines whether or not the operating points of the internal combustion engine 10, which are defined by the rotation speed NE and the charging efficiency η, are within a predetermined range (S716). The process is a process of determining whether or not one of the execution conditions of the process of determining the presence or absence of an abnormality of the upstream air-fuel ratio sensor 83 is satisfied.

When determination is made that the operating points of the internal combustion engine are within a predetermined range (S716: YES), the CPU 72 acquires the requested injection amount Qd and the upstream detection value Afu (S718). Note that, in the present embodiment, it is assumed that the CPU 72 samples the upstream detection value Afu a plurality of times during an execution cycle that is a time interval between execution timings of the process of S718. Then, in the process of S718, for the upstream detection value Afu, it is assumed that the CPU 72 acquires a plurality of the upstream detection values Afu sampled during the period from the execution timing of the previous process of S718 to the execution timing of the current process of S718. Note that, in the process of S718, the CPU 72 acquires one latest value of the requested injection amount Qd.

Then, the CPU 72 determines whether or not acquisition of “sn” sampling values of the fuel excess or deficiency amount Qi, “sn” sampling values of a difference variable ΔAfu, and “sn” sampling values of a time difference maximum value dAfumax has been completed (S720). Here, the fuel excess or deficiency amount Qi is an excess amount of the actual injection amount with respect to the amount of fuel needed for setting the air-fuel ratio of the air-fuel mixture in the combustion chamber 18 to the stoichiometric air-fuel ratio, and is set to “Qd−Qb·(1+LAF+Dp)” in the present embodiment. Note that, the fuel excess or deficiency amount Qi can be a negative value, and in that case, the absolute value of the fuel excess or deficiency amount Qi indicates the deficiency amount of the actual injection amount with respect to the needed fuel amount. The fuel excess or deficiency amount Qi is calculated each time the process of S718 is performed once. That is, sampling is performed once in the execution cycle of the process of S718.

The difference variable ΔAfu is a difference between the maximum value and the minimum value of the upstream detection value Afu in one cycle of the execution of the process of S718. The time difference maximum value dAfumax is the maximum value of a time difference value dAfu calculated by a difference between adjacent data of the time-series data of the upstream detection value Afu in one cycle of the execution of the process of S718. The difference variable ΔAfu and the time difference maximum value dAfumax are calculated each time the process of S718 is performed once. That is, sampling is performed once in the execution cycle of the process of S718. Accordingly, assuming that “m=1 to sn”, for example, the difference variable ΔAfu(m) is a difference between the maximum value and the minimum value of the upstream detection values Afu in the sampling cycle of each difference variable ΔAfu constituting “sn” pieces of time-series data of the difference variable ΔAfu.

When the process of S718 is performed “sn” times during the period in which an affirmative determination is made in the process of S716, the CPU 72 determines that the acquisition of the time-series data constituted by “sn” values of each variable has been completed (S720: YES). Note that, when a process of S726 to be described later is performed, the CPU 72 deletes all “sn” values of each variable and initializes the acquired number of the values of each variable.

Next, the CPU 72 determines whether or not each of the values acquired in S720 is equal to or less than an upper limit guard value determined according to each acquired value (S721). The upper limit guard value is set for each type of acquired values, and an upper limit guard value of the fuel excess or deficiency amount Qi, an upper limit guard value of the difference variable ΔAfu, and an upper limit guard value of the time difference maximum value dAfumax are set. Note that, each upper limit guard value is within the range of data input when mapping data 76a stored in the storage device 76 is learned by machine learning, and is defined as the upper limit value of the input data.

When the acquired value is equal to or less than the upper limit guard value (S721: YES), the CPU 72 determines whether or not each of the values acquired in S720 is equal to or greater than a lower limit guard value determined according to each acquired value (S722). The lower limit guard value is set for each type of acquired values, and a lower limit guard value of the fuel excess or deficiency amount Qi, a lower limit guard value of the difference variable ΔAfu, and a lower limit guard value of the time difference maximum value dAfumax are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S722: YES), the CPU 72 assigns values of variables determined to have been acquired in the process of S720 to input variables x(1) to x(3sn) of a mapping that outputs abnormality determination variables PJ(1), PJ(2), which are variables indicating the presence or absence of an abnormality of the upstream air-fuel ratio sensor 83 (S723). That is, assuming that m=1 to sn, the CPU 72 assigns the fuel excess or deficiency amount Qi to the input variable x(m), assigns the difference variable ΔAfu(m) to the input variable x(sn+m), and assigns the time difference maximum value dAfumax(m) to the input variable x(2sn+m). Note that, the abnormality determination variable PJ(1) is a variable having a larger value when there is a high possibility that an abnormality has occurred than when the possibility is low, and the abnormality determination variable PJ(2) is a variable having a larger value when there is a high possibility that no abnormality has occurred than when the possibility is low.

Next, the CPU 72 calculates the values of the abnormality determination variables PJ(1), PJ(2), which are the output values of the mapping, by inputting the input variables x(1) to x(3sn) to the mapping defined by the mapping data 76a stored in the storage device 76 illustrated in FIG. 1 (S724).

In the present embodiment, the mapping includes a neural network having a single intermediate layer. The neural network includes an input-side coefficient wFjk (j=0 to n, k=0 to 3sn) and an activation function h(x) as an input-side nonlinear mapping that nonlinearly transforms each output of an input-side linear mapping, which is a linear mapping defined by the input-side coefficient wFjk. In the present embodiment, ReLU is exemplified as the activation function h(x). Note that, the ReLU is a function that outputs the greater of the input and “0”, or “0” when the input is “0”. Incidentally, wFj0 and the like are bias parameters, and the input variable x(0) is defined as “1”.

The neural network includes a softmax function that outputs the abnormality determination variables PJ(1), PJ(2) by using the output-side coefficient wSij (i=1 to 2, j=0 to n) and each of the probability prototypes y(1), y(2) which are outputs of an output-side linear mapping, which is a linear mapping defined by the output-side coefficient wSij, as an input.

Next, the CPU 72 determines whether or not the value of the abnormality determination variable PJ(1) is greater than the value of the abnormality determination variable PJ(2) (S726). The process is a process of determining whether or not the upstream air-fuel ratio sensor 83 has an abnormality. Then, when determination is made that the value of the abnormality determination variable PJ(1) is greater than the value of the abnormality determination variable PJ(2) (S726: YES), the CPU 72 determines that there is an abnormality (S728). Then, the CPU 72 executes an alarm process, which is a process of operating the warning light 98 illustrated in FIG. 1, in order to prompt the user for repair (S730).

When the process of S730 is completed, or when a negative determination is made in the processes of S716 and S726, the CPU 72 assigns “0” to the start flag Fst (S732). Note that, when the processes of S714 and S732 are completed, or when a negative determination is made in the processes of S712 and S720, the CPU 72 temporarily ends the series of processes illustrated in FIG. 15.

When the value acquired in S720 exceeds the upper limit guard value (S721: NO), the CPU 72 performs a guard process of matching the acquired value to the upper limit guard value (S740). As a result, the acquired value exceeding the upper limit guard value is reset as the same value as the upper limit guard value, and then the above-described processes of S723 to S732 are performed.

When the value acquired in S720 is less than the lower limit guard value (S722. NO), the CPU 72 performs a guard process of matching the acquired value to the lower limit guard value (S742). As a result, the acquired value less than the lower limit guard value is reset as the same value as the lower limit guard value, and then the above-described processes of S723 to S732 are performed.

Note that, the input-side coefficient wFjk and the output-side coefficient wSij of the mapping data 76a are obtained by learning, as training data, each variable used in the process of S722 when the internal combustion engine 10 is operated using each of the upstream air-fuel ratio sensor 83 of which responsiveness is known in advance to be reduced and the normal upstream air-fuel ratio sensor 83, for example.

Next, the operation and effect of the present embodiment will be described. According to the above embodiment, the technique for the guard process can be applied in determining the presence or absence of an abnormality of the upstream air-fuel ratio sensor 83 provided in the exhaust passage 28 of the internal combustion engine 10, as the state of the internal combustion engine 10.

### Tenth Embodiment

Hereinafter, a tenth embodiment will be described with reference to the drawings, focusing on differences from the above-described first embodiment.

In the present embodiment, the state determination device for an internal combustion engine is configured as a device that determines the presence or absence of an abnormality in a response delay of the EGR valve 33. In the ROM 74 of the state determination device for the internal combustion engine 10 according to the present embodiment, a program for determining the presence or absence of an abnormality in the response delay of the EGR valve 33 is stored as the determination program 74a.

The CPU 72 calculates a target EGR rate RAO, which is a target ratio of EGR supplied to the EGR valve 33 via the EGR passage 32, based on the rotation speed NE and the charging efficiency η. Then, the CPU 72 operates an opening degree of the EGR valve 33 that adjusts the flow passage cross-sectional area of the EGR passage 32 based on the target EGR rate RAO. In the present embodiment, the target EGR rate RAO is calculated based on predetermined map data.

Note that, the map data is set data of discrete values of the input variables and values of output variables corresponding to respective values of the input variables. In the map calculation, for example, when the value of the input variable matches any of the values of the input variables of the map data, the corresponding value of the output variable of the map data is used as the calculation result. Alternatively, when the value of the input variable does not match any of the values of the input variables of the map data, the map calculation may be a process in which values obtained by interpolating values of a plurality of output variables included in map data are used as calculation results.

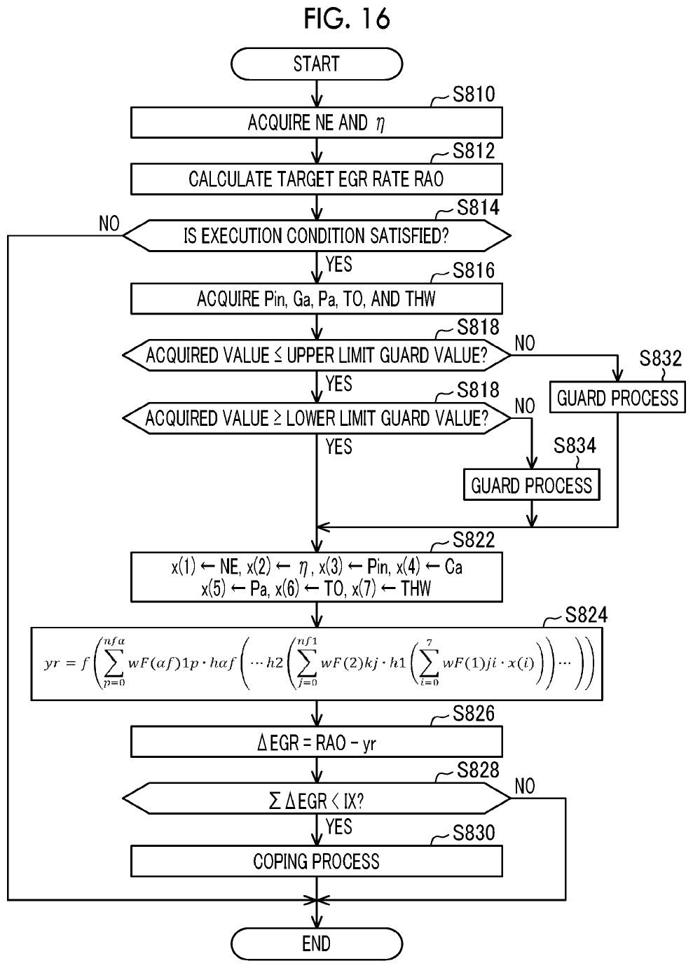

FIG. 16 illustrates a procedure of processes executed by the control device 70 in the present embodiment. The process illustrated in FIG. 16 is realized by the CPU 72 repeatedly executing the determination program 74a stored in the ROM 74 illustrated in FIG. 1 at a predetermined cycle, for example.

In the series of processes illustrated in FIG. 16, the CPU 72 first acquires the rotation speed NE and the charging efficiency η (S810). Next, the CPU 72 calculates the target EGR rate RAO based on the rotation speed NE and the charging efficiency η, according to the above-described map data (S812).

Next, the CPU 72 determines whether or not the execution condition of the process of determining an abnormality of the EGR passage 32 and the EGR valve 33 is satisfied (S814). Specifically, when the increase change amount of the target EGR rate RAO calculated by the difference between the currently calculated target EGR rate RAO and the previously calculated target EGR rate RAO is greater than a predetermined threshold, the execution condition is satisfied.

When the execution condition is satisfied (S814: YES), the CPU 72 acquires the intake pressure Pin, the intake air amount Ga, the atmospheric pressure Pa, the intake air temperature TO, and the coolant temperature THW (S816). Next, the CPU 72 determines whether or not each of the values acquired in S812 and S816 is equal to or less than an upper limit guard value determined according to each acquired value (S818). The upper limit guard value is set for each type of the acquired values, and an upper limit guard value of the rotation speed NE, an upper limit guard value of the charging efficiency η, an upper limit guard value of the intake pressure Pin, an upper limit guard value of the intake air amount Ga, an upper limit guard value of the atmospheric pressure Pa, an upper limit guard value of the intake air temperature TO, and an upper limit guard value of the coolant temperature THW are set. Note that, each upper limit guard value is within the range of data input when mapping data 76a stored in the storage device 76 is learned by machine learning, and is defined as the upper limit value of the input data.

When the acquired value is equal to or less than the upper limit guard value (S818: YES), the CPU 72 determines whether or not each of the values acquired in S812 and S816 is equal to or greater than a lower limit guard value determined according to each acquired value (S820). The lower limit guard value is set for each type of the acquired values, and a lower limit guard value of the rotation speed NE, a lower limit guard value of the charging efficiency η, a lower limit guard value of the intake pressure Pin, a lower limit guard value of the intake air amount Ga, a lower limit guard value of the atmospheric pressure Pa, a lower limit guard value of the intake air temperature TO, and a lower limit guard value of the coolant temperature THW are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S820: YES), the CPU 72 assigns each acquired value to an input variable of a mapping that outputs an estimated value yr of the target EGR rate RAO (S822). That is, the CPU 72 assigns the rotation speed NE to the input variable x(1), assigns the charging efficiency η to the input variable x(2), assigns the intake pressure Pin to the input variable x(3), and assigns the intake air amount Ga to the input variable x(4). In addition, the CPU 72 assigns the atmospheric pressure Pa to the input variable x(5), assigns the intake air temperature TO to the input variable x(6), and assigns the coolant temperature THW to the input variable x(7).

Next, the CPU 72 calculates the estimated value yr of the target EGR rate RAO by inputting the input variables x(1) to x(7) to the mapping that outputs the estimated value yr of the target EGR rate RAO (S824). The mapping includes a neural network in which the number of intermediate layers is “αf”, activation functions h1 to hαf of each intermediate layer are hyperbolic tangents, and an activation function f of the output layer is ReLU. Note that, the ReLU is a function that outputs the greater of the input value and zero, or zero when the input value is zero.

For example, the value of each node in the first intermediate layer is generated by inputting the output when the input variables x(1) to x(7) are input to the linear mapping defined by coefficients wF(1)ji (j=0 to nf1, i=0 to 7) to the activation function h1. That is, assuming that m=1, 2, . . . , αf, the value of each node of the m-th intermediate layer is generated by inputting the output of the linear mapping defined by the coefficient wF(m) to the activation function hm. Here, the values nf1, nf2, . . . , nfα are the numbers of nodes of the first, second, . . . , αf-th intermediate layers, respectively. Incidentally, wF(1)j0 and the like are bias parameters, and the input variable x(0) is defined as “1”.

Next, the CPU 72 calculates ΔEGR, which is a difference between the target EGR rate RAO calculated based on the map data and the estimated value yr of the target EGR rate RAO output by mapping (S826).

Next, the CPU 72 determines whether or not an integrated value ΣΔEGR of ΔEGR at each time from the time when the target EGR rate RAO starts increasing to the current time is greater than a preset threshold IX (S826).

When the integrated value ΔEGR is greater than the threshold IX (S828: YES), the CPU 72 executes a coping process according to the coping program 74b illustrated in FIG. 1. Specifically, the warning light 98 is turned on (S830).

When the process of S830 is completed, or when a negative determination is made in the processes of S814 and S828, the CPU 72 temporarily ends the series of processes illustrated in FIG. 16. When the values acquired in S812 and S816 exceed the upper limit guard value (S818: NO), the CPU 72 performs a guard process of matching the acquired value to the upper limit guard value (S832). As a result, the acquired value exceeding the upper limit guard value is reset as the same value as the upper limit guard value, and then the above-described processes of S822 to S830 are performed.

When the values acquired in S812 and S816 are less than the lower limit guard value (S820: NO), the CPU 72 performs a guard process of matching the acquired value to the lower limit guard value (S834). As a result, the acquired value less than the lower limit guard value is reset as the same value as the lower limit guard value, and then the above-described processes of S822 to S830 are performed.

Note that, the input-side coefficient wFjk and the output-side coefficient wSij of the mapping data 76a according to the present embodiment are obtained by, for example, learning the target EGR rate RAO calculated by the map data as teacher data, and the values acquired in S812 and S816 as training data.

Next, the operation and effect of the present embodiment will be described. In the above embodiment, in a case where the target EGR rate RAO sharply increases, when the response delay occurs in the EGR valve 33, the difference between the target EGR rate RAO calculated based on the map data and the estimated value yr of the target EGR rate RAO output by the mapping increases. Here, in order for the difference of ΔFGR to be large to some extent, it is needed that the change amount of the target EGR rate RAO is large to some extent and the increase change amount of the target EGR rate RAO is large. Therefore, in the present embodiment, the threshold is set so that the execution condition is satisfied in such a case. According to the above embodiment, the technique for the guard process can be applied in determining the presence or absence of an abnormality in a response delay of the EGR valve 33 as the state of the internal combustion engine 10.

### Eleventh Embodiment

Hereinafter, an eleventh embodiment will be described with reference to the drawings, focusing on differences from the above-described first embodiment.

In the present embodiment, the state determination device for an internal combustion engine is configured as a device that determines an estimated value of a knocking intensity of the internal combustion engine 10. In the ROM 74 of the state determination device for the internal combustion engine 10 according to the present embodiment, a program for determining an estimated value of the knocking intensity of the internal combustion engine 10 is stored as the determination program 74a.

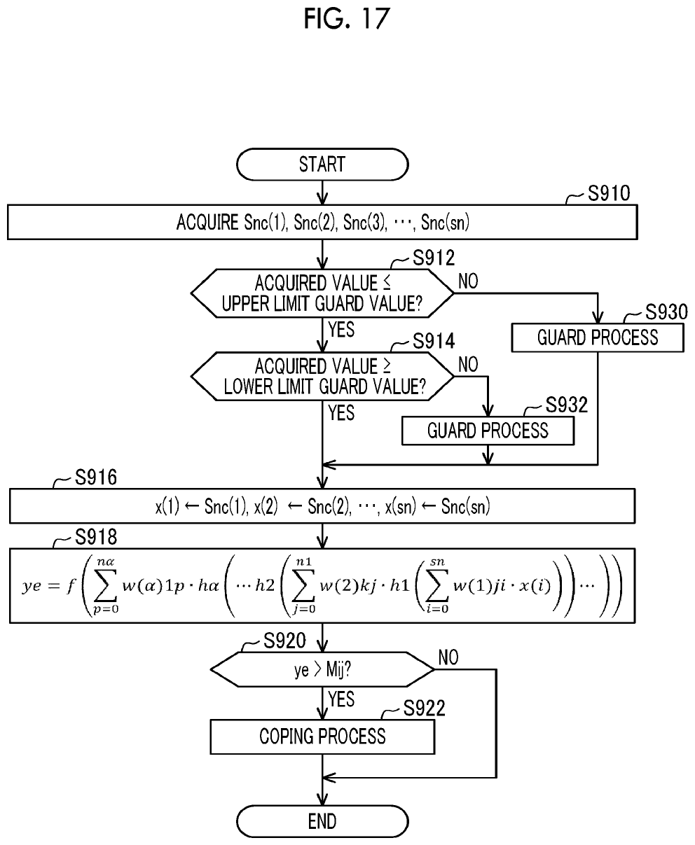

FIG. 17 illustrates a procedure of processes executed by the control device 70 in the present embodiment. The process illustrated in FIG. 17 is realized by the CPU 72 repeatedly executing the determination program 74a stored in the ROM 74 illustrated in FIG. 1 at a predetermined cycle, for example.

First, the CPU 72 acquires “sn” sampling values of the detection signal Snc of the knocking sensor 92 (S910). Next, the CPU 72 determines whether or not each of the values acquired in S910 is equal to or less than an upper limit guard value determined according to each acquired value (S912). In the present embodiment, an upper limit guard value of the detection signal Snc of the knocking sensor 92 is set. Note that, each upper limit guard value is within the range of data input when mapping data 76a stored in the storage device 76 is learned by machine learning, and is defined as the upper limit value of the input data.

When the acquired value is equal to or less than the upper limit guard value (S912: YES), the CPU 72 determines whether or not each of the values acquired in S910 is equal to or greater than a lower limit guard value determined according to each acquired value (S914). In the present embodiment, a lower limit guard value of the detection signal Snc of the knocking sensor 92 is set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S914: YES), the CPU 72 assigns each acquired value to an input variable of a mapping that outputs a representative value of the knocking intensity (S916). That is, the CPU 72 assigns the detection signals Snc(1) to Snc(sn) of the knocking sensor 92 to the input variables x(1) to x(sn), respectively.

Next, the CPU 72 calculates an estimated value ye of the representative value of the knocking intensity, which is the output value of the mapping, by inputting the input variables x(1) to x(sn) to the mapping defined by the mapping data 76a stored in the storage device 76 illustrated in FIG. 1 (S918).

In the present embodiment, the mapping includes a neural network in which the number of intermediate layers is “α”, activation functions h1 to hα of each intermediate layer are hyperbolic tangents, and an activation function f of the output layer is ReLU. Note that, the ReLU is a function that outputs the greater of the input and zero, or zero when the input is zero. For example, the value of each node in the first intermediate layer is generated by inputting the output when the input variables x(1) to x(sn) are input to the linear mapping defined by coefficients w(1)ji (j=0 to n1, i=0 to sn) to the activation function h1. That is, assuming that m=1, 2, . . . , α, the value of each node of the m-th intermediate layer is generated by inputting the output of the linear mapping defined by the coefficient w(m) to the activation function hm. Here, the values n1, n2, . . . , nα are the numbers of nodes of the first, second, . . . , α-th intermediate layers, respectively. Incidentally, w(1)j0 and the like are bias parameters, and the input variable x(0) is defined as “1”.

Next, the CPU 72 determines whether or not the estimated value ye of the representative value of the knocking intensity is greater than the corresponding threshold Mij (S920). When determination is made that the estimated value ye of the representative value of the knocking intensity is greater than the threshold Mij (S920: YES), the CPU 72 determines that knocking has occurred, and executes a coping process (S922). In the present embodiment, the ignition timing of the ignition device 22 is allowed to be retarded for a cylinder determined to be knocking.

When the process of S922 is completed, or when a negative determination is made in the process of S920, the CPU 72 temporarily ends the series of processes illustrated in FIG. 17. When the value acquired in S910 exceeds the upper limit guard value (S912: NO), the CPU 72 performs a guard process of matching the acquired value to the upper limit guard value (S930). As a result, the acquired value exceeding the upper limit guard value is reset as the same value as the upper limit guard value, and then the above-described processes of S916 to S922 are performed.

When the value acquired in S910 is less than the lower limit guard value (S914: NO), the CPU 72 performs a guard process of matching the acquired value to the lower limit guard value (S932). As a result, the acquired value less than the lower limit guard value is reset as the same value as the lower limit guard value, and then the above-described processes of S916 to S922 are performed.

Note that, in the system that generates the mapping data 76a according to the present embodiment, the sensor group 102 includes a pressure sensor that detects the pressure in the combustion chamber 18. In generating the mapping data 76a, a peak value of the output value detected by the pressure sensor within a preset period is used as teacher data. For example, the preset period is a fixed crank angle range or a range from the compression top dead center to 90° after the compression top dead center.

According to the above embodiment, the technique for the guard process can be applied in determining an estimated value of the knocking intensity of the internal combustion engine 10 as the state of the internal combustion engine 10.

### Twelfth Embodiment

Hereinafter, a twelfth embodiment will be described with reference to the drawings, focusing on differences from the above-described first embodiment.

In the present embodiment, the state determination device for an internal combustion engine is configured as a device that determines the presence or absence of a leakage abnormality of blow-by gas from the blow-by gas delivery path 15 of the internal combustion engine 10. In the ROM 74 of the state determination device for the internal combustion engine 10 according to the present embodiment, a program for determining the presence or absence of a leakage abnormality of the blow-by gas from the blow-by gas delivery path 15 of the internal combustion engine 10 is stored as the determination program 74a.

The CPU 72 calculates the amount of intake air passing through the throttle valve 14. Then, an intake air amount difference Δm between a calculated value mt of the amount of intake air passing through the throttle valve 14 and the intake air amount Ga detected by the air flow meter 82 is used as a value representing the amount of blow-by gas flowing into the intake passage 12.

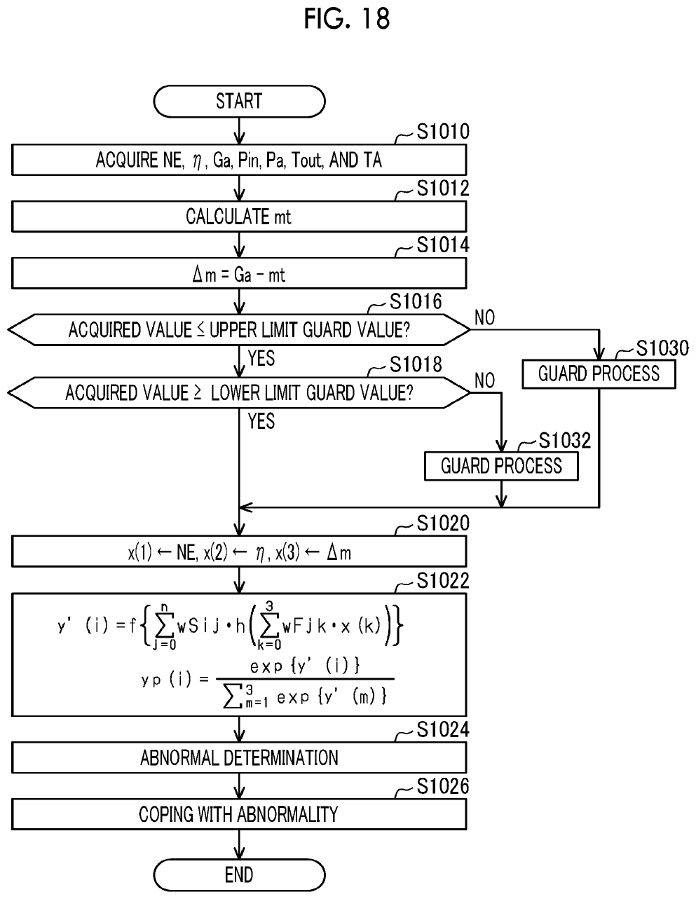

FIG. 18 illustrates a procedure of processes executed by the control device 70 in the present embodiment. The process illustrated in FIG. 18 is realized by the CPU 72 repeatedly executing the determination program 74a stored in the ROM 74 illustrated in FIG. 1 at a predetermined cycle, for example.

First, the CPU 72 acquires the rotation speed NE, the charging efficiency 11, the intake air amount Ga, the intake pressure Pin, the atmospheric pressure Pa, the outside air temperature Tout, and an opening area TA of the throttle valve 14 (S1010). The opening area TA of the throttle valve 14 is calculated by the CPU 72 based on the rotation speed NE and the charging efficiency η.

Next, the CPU 72 calculates the calculated value mt of the amount of intake air passing through the throttle valve 14 (S1012). The calculated value mt is calculated by a predetermined mathematical formula based on the values acquired in S1010.

Next, the CPU 72 acquires the intake air amount difference Δm between the calculated value mt of the amount of intake air passing through the throttle valve 14 and the intake air amount Ga detected by the air flow meter 82 (S1014).

Next, the CPU 72 determines whether or not the rotation speed NE and the charging efficiency η among the values acquired in S1010 and the intake air amount difference Δm acquired in S1014 are equal to or less than an upper limit guard value determined according to each acquired value (S1016). The upper limit guard value is set for each type of acquired values, and an upper limit guard value of the rotation speed NE, an upper limit guard value of the charging efficiency and an upper limit guard value of the intake air amount difference Δm are set.

When the acquired value is equal to or less than the upper limit guard value (S1016: YES), the CPU 72 determines whether or not each of the values acquired in S1010 is equal to or greater than a lower limit guard value determined according to each acquired value (S1018). In the present embodiment, a lower limit guard value of the rotation speed NE, a lower limit guard value of the charging efficiency η, and a lower limit guard value of the intake air amount difference Δm are set. Note that, each upper limit guard value is within the range of data input when mapping data 76a stored in the storage device 76 is learned by machine learning, and is defined as the upper limit value of the input data.

When the acquired value is equal to or greater than the lower limit guard value (S1018: YES), the CPU 72 assigns the rotation speed NE and the charging efficiency 11 among the values acquired in S1010 and the intake air amount difference Δm acquired in S1014 to the input variables x(1) to x(3) of a mapping for calculating a probability that a misfire has occurred (S1020). Specifically, the CPU 72 assigns the rotation speed NE to the input variable x(1), assigns the charging efficiency η to the input variable x(2), and assigns the intake air amount difference Δm to the input variable x(3). Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

Next, the CPU 72 outputs state probabilities yp(1), yp(2), yp(3) indicating the establishment of each leakage state of the blow-by gas by inputting the input variables x(1) to x(3) to the mapping defined by the mapping data 76a stored in the storage device 76 illustrated in FIG. 1 (S1022). In the present embodiment, the state probability yp(1) indicates a probability that there is a blow-by gas leakage abnormality. The blow-by gas leakage abnormality means that the amount of the blow-by gas flowing into the intake passage 12 increases when a hose serving as the blow-by gas delivery path 15 is disconnected from the PCV valve 13 or a hole is formed in the hose serving as the blow-by gas delivery path 15. The state probability yp(2) indicates a probability that the PCV valve 13 has a sticking abnormality. The sticking abnormality of the PCV valve 13 means that the valve body of the PCV valve 13 is stuck. In this case, since the valve cannot be opened with the valve closed, the amount of blow-by gas flowing into the intake passage 12 is different from the amount of flow determined from the operating state of the internal combustion engine 10. Further, the state probability yp(3) indicates a probability of a normal state without the above-described abnormality.

Note that, in the present embodiment, the mapping includes a neural network having a single intermediate layer and a softmax function for setting the sum of the state probabilities yp(1) to yp(3) to “1” by standardizing an output y′(i) of the neural network.

Next, the CPU 72 selects a maximum value yp(i) from the state probabilities yp(1) to yp(3) output in S1022 (S1024). When the selected maximum value yp(i) is the state probability yp(1), the CPU 72 determines that there is a blow-by gas leakage abnormality. When the selected maximum value yp(i) is the state probability yp(2), the CPU 72 determines that the PCV valve 13 has a sticking abnormality. When the selected maximum value yp(i) is the state probability yp(3), the CPU 72 determines that the state is normal.

Next, the CPU 72 executes a coping process based on the states determined in S1024 (S1026). For example, the CPU 72 turns on the warning light 98 when the determined state is a blow-by gas leakage abnormality or a sticking abnormality of the PCV valve 13.

When the process of S1026 is completed, the CPU 72 temporarily ends the series of processes illustrated in FIG. 18. When the values acquired in S1010 and S1014 exceed the upper limit guard value (S1016: NO), the CPU 72 performs a guard process of matching the acquired value to the upper limit guard value (S1030). As a result, the acquired value exceeding the upper limit guard value is reset as the same value as the upper limit guard value, and then the above-described processes of S1020 to S1026 are performed.

When the values acquired in S1010 and S1014 are less than the lower limit guard value (S1018: NO), the CPU 72 performs a guard process of matching the acquired value to the lower limit guard value (S1032). As a result, the acquired value less than the lower limit guard value is reset as the same value as the lower limit guard value, and then the above-described processes of S1020 to S1026 are performed.

Note that, in the generation of the mapping data 76a according to the present embodiment, for example, a state probability ypt(1) in a state where the blow-by gas delivery path 15 is disconnected, a state probability ypt(2) in a state where the valve body of the PCV valve 13 is stuck, and a state probability ypt(3) of the normal state are used as teacher data. The mapping data 76a according to the present embodiment is obtained by learning the teacher data and the values acquired in S1010 and S1014 as training data.

According to the above embodiment, the technique for the guard process can be applied in determining the blow-by gas leakage abnormality of the internal combustion engine 10 and the sticking abnormality of the PCV valve 13 as the state of the internal combustion engine 10.

### Thirteenth Embodiment

Hereinafter, a thirteenth embodiment will be described with reference to the drawings, focusing on differences from the above-described first embodiment.

In the present embodiment, the state determination device for an internal combustion engine is configured as a device that determines the presence or absence of a perforation abnormality that causes fuel vapor of the internal combustion engine 10 to leak. In the ROM 74 of the state determination device for the internal combustion engine 10 according to the present embodiment, a program for determining the presence or absence of a perforation abnormality that causes fuel vapor of the internal combustion engine 10 to leak is stored as the determination program 74a.

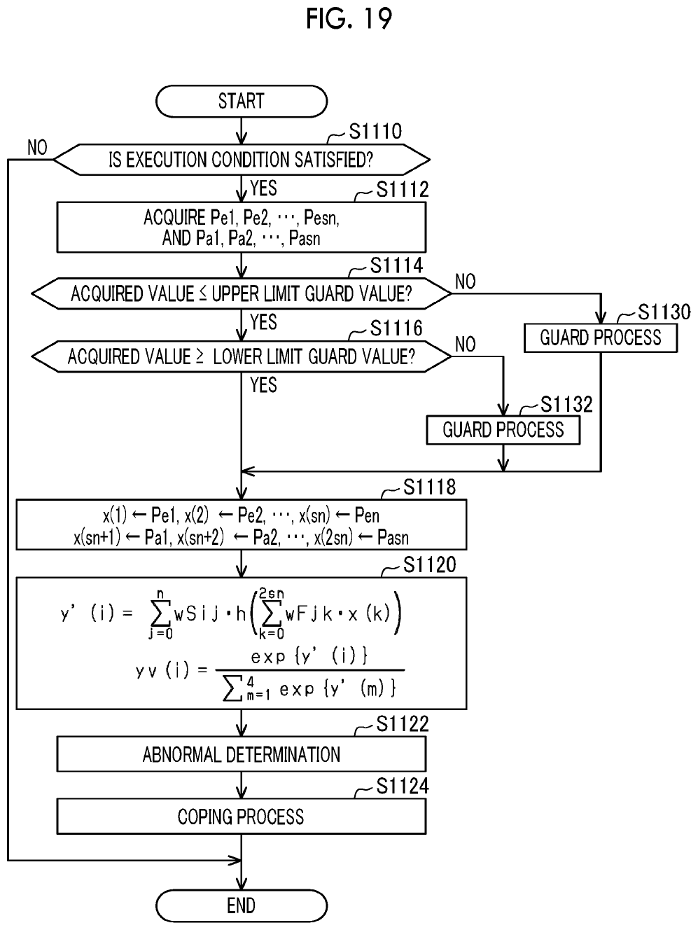

FIG. 19 illustrates a procedure of processes executed by the control device 70 in the present embodiment. The process illustrated in FIG. 19 is realized by the CPU 72 repeatedly executing the determination program 74a stored in the ROM 74 illustrated in FIG. 1 at a predetermined cycle, for example.

In the series of processes illustrated in FIG. 19, the CPU 72 first determines whether or not an execution condition of an imbalance detection process is satisfied (S1110). The execution conditions include that drive of the internal combustion engine 10 is stopped and the inside of the canister 40 and the inside of the fuel tank 38 are controlled to a negative pressure by a suction pump (not illustrated).

Next, the CPU 72 acquires canister internal pressures Pe1, Pe2, . . . , Pen and atmospheric pressures Pa1, Pa2, . . . , Pa3 at a predetermined time interval (S1112). The canister internal pressure Pe is a pressure value detected by the canister internal pressure sensor 93 at a predetermined time interval.

Next, the CPU 72 determines whether or not each of the values acquired in S1112 is equal to or less than an upper limit guard value determined according to each acquired value (S1114). The upper limit guard value is set for each type of acquired values, and an upper limit guard value of the canister internal pressure Pe and an upper limit guard value of the atmospheric pressure Pa are set. Note that, each upper limit guard value is within the range of data input when mapping data 76a stored in the storage device 76 is learned by machine learning, and is defined as the upper limit value of the input data.

When the acquired value is equal to or less than the upper limit guard value (S1114: YES), the CPU 72 determines whether or not each of the values acquired in S1112 is equal to or greater than a lower limit guard value determined according to each acquired value (S1116). The lower limit guard value is set for each type of acquired values, and a lower limit guard value of the canister internal pressure Pe and a lower limit guard value of the atmospheric pressure Pa are set. Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

When the acquired value is equal to or greater than the lower limit guard value (S1116: YES), the CPU 72 assigns the values acquired in S1112 to the input variables x(1) to x(2n) of a mapping for calculating a probability that a misfire has occurred (S1118). Specifically, the CPU 72 assigns the canister internal pressures Pe1 to Pen to the input variables x(1) to x(n), and assigns the atmospheric pressures Pa1 to Pan to the input variables x(n+1) to x(2n).

Next, the CPU 72 outputs state probabilities yv(1), yv(2), yv(3), yv(4) indicating a state of a fuel vapor discharge prevention system by inputting the input variables x(1) to x(2n) to the mapping defined by the mapping data 76a stored in the storage device 76 illustrated in FIG. 1 (S1120). In the present embodiment, the state probability yv(1) indicates a perforation abnormality in which perforation in which fuel vapor leaks has occurred. The state probability yv(2) indicates a valve opening abnormality in which the purge valve 44 keeps opening. The state probability yv(3) indicates a valve closing abnormality in which the purge valve 44 keeps closing. The state probability yv(4) indicates a probability of a normal state without the above-described abnormality.

Note that, in the present embodiment, the mapping includes a neural network having a single intermediate layer and a softmax function for setting the sum of the state probabilities yv(1) to yv(4) to “1” by standardizing the output y′(i) of the neural network.

Next, the CPU 72 selects a maximum value yv(i) from the state probabilities yv(1) to yv(4) output in S1120 (S1122). When the selected maximum value yv(i) is the state probability yv(1), the CPU 72 determines that a perforation abnormality in which fuel vapor leaks into the purge passage 42 has occurred. When the selected maximum value yv(i) is the state probability yv(2), the CPU 72 determines that the purge valve 44 has a valve opening abnormality. When the selected maximum value yv(i) is the state probability yv(3), the CPU 72 determines that the purge valve 44 has a valve closing abnormality. When the selected maximum value yv(i) is the state probability yv(4), the CPU 72 determines that the state is normal.

Next, the CPU 72 executes a coping process based on the states determined in S1122 (S1124). For example, the CPU 72 turns on the warning light 98 corresponding to each abnormal state so as to transmit the determined abnormal state.

When the process of S1124 is completed, or when a negative determination is made in the process of S1110, the CPU 72 temporarily ends the series of processes illustrated in FIG. 19. When the value acquired in S1112 exceeds the upper limit guard value (S1114: NO), the CPU 72 performs a guard process of matching the acquired value to the upper limit guard value (S1130). As a result, the acquired value exceeding the upper limit guard value is reset as the same value as the upper limit guard value, and then the above-described processes of S1118 to S1124 are performed.

When the value acquired in S1112 is less than the lower limit guard value (S1116: NO), the CPU 72 performs a guard process of matching the acquired value to the lower limit guard value (S1132). As a result, the acquired value less than the lower limit guard value is reset as the same value as the lower limit guard value, and then the above-described processes of S1118 to S1124 are performed.

Note that, in the generation of the mapping data 76a according to the present embodiment, the data is learned using correct answer labels yvt(1) to yvt(4) as teacher data. The correct answer label yvt(1) indicates the correct answer label in a state where a hole is generated in the purge passage 42. The correct answer label yvt(2) indicates the correct answer label in a state where the purge valve 44 keeps opening. The correct answer label yvt(3) indicates the correct answer label in a state where the purge valve 44 keeps closing. The correct answer label yvt(4) indicates the correct answer label in a normal state.

According to the above embodiment, the technique for the guard process can be applied in determining the abnormality of the purge passage 42 and the purge valve 44 of the internal combustion engine 10 as the state of the internal combustion engine 10.

### Fourteenth Embodiment

Hereinafter, a fourteenth embodiment will be described with reference to the drawings, focusing on differences from the above-described first embodiment.

In the present embodiment, the state determination device for an internal combustion engine is configured as a device that determines an estimated value of a discharge fuel temperature TF of the high-pressure fuel pump 39 for fuel injection of the internal combustion engine 10 after a predetermined time. In the ROM 74 of the state determination device for the internal combustion engine 10 according to the present embodiment, a program for determining an estimated value of the discharge fuel temperature TF of the high-pressure fuel pump 39 after a predetermined time is stored as the determination program 74a.

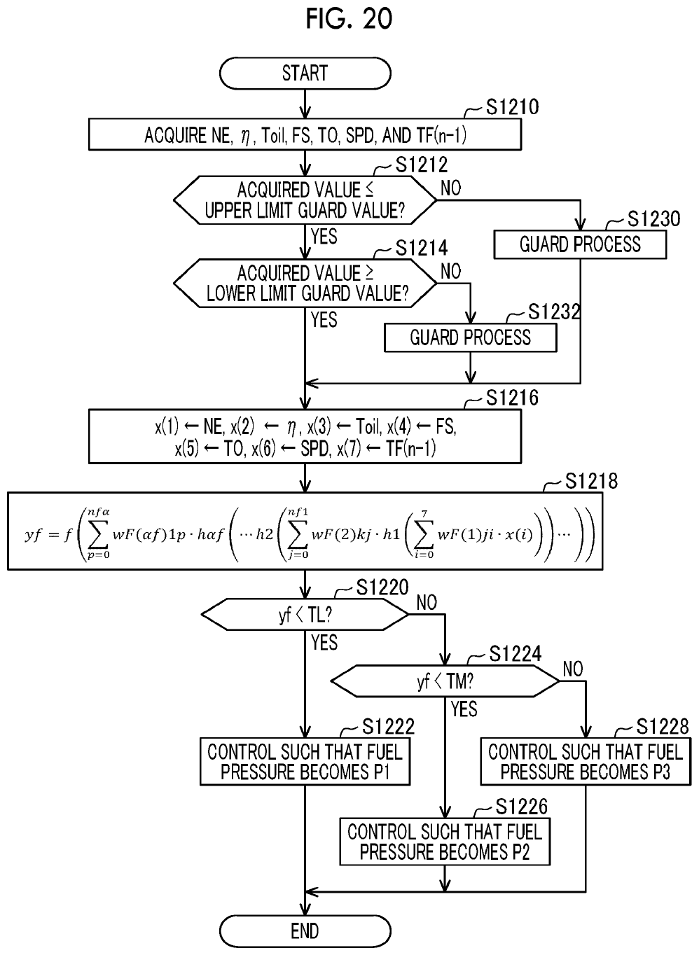

FIG. 20 illustrates a procedure of processes executed by the control device 70 in the present embodiment. The process illustrated in FIG. 20 is realized by the CPU 72 repeatedly executing the determination program 74a stored in the ROM 74 illustrated in FIG. 1 at a predetermined cycle, for example.

First, the CPU 72 acquires the rotation speed NE, the charging efficiency 11, a lubricating oil temperature Toil, a supply fuel amount FS to the high-pressure fuel pump 39, the intake air temperature TO, the vehicle speed SPD, a previous value TF(n−1) of the discharge fuel temperature TF from the high-pressure fuel pump 39 (S1210). The supply fuel amount FS to the high-pressure fuel pump 39 is calculated, for example, from the drive electric power of the low-pressure fuel pump 37.

Next, the CPU 72 determines whether or not each of the values acquired in S1210 is equal to or less than an upper limit guard value determined according to each acquired value (S1212). The upper limit guard value is set for each type of the acquired values, and an upper limit guard value of the rotation speed NE, an upper limit guard value of the charging efficiency η, an upper limit guard value of the lubricating oil temperature Toil, an upper limit guard value of the supply fuel amount FS, an upper limit guard value of the intake air temperature TO, an upper limit guard value of the vehicle speed SPD, and an upper limit guard value of the discharge fuel temperature TF are set.

When the acquired value is equal to or less than the upper limit guard value (S1212: YES), the CPU 72 determines whether or not each of the values acquired in S1210 is equal to or greater than a lower limit guard value determined according to each acquired value (S1214). The lower limit guard value is set for each type of the acquired values, and a lower limit guard value of the rotation speed NE, a lower limit guard value of the charging efficiency η, a lower limit guard value of the lubricating oil temperature Toil, a lower limit guard value of the supply fuel amount FS, a lower limit guard value of the intake air temperature TO, a lower limit guard value of the vehicle speed SPD, and a lower limit guard value of the discharge fuel temperature TF are set. Note that, each upper limit guard value is within the range of data input when mapping data 76a stored in the storage device 76 is learned by machine learning, and is defined as the upper limit value of the input data.

When the acquired value is equal to or greater than the lower limit guard value (S1214: YES), the CPU 72 assigns each acquired value to an input variable of a mapping that outputs an estimated value of the discharge fuel temperature TF of the high-pressure fuel pump 39 after a predetermined time (S1216). That is, the CPU 72 inputs the rotation speed NE to the input variable x(1), inputs the charging efficiency η to the input variable x(2), and inputs the lubricating oil temperature Toil to the input variable x(3). The CPU 72 inputs the supply fuel amount FS to the input variable x(4), inputs the intake air temperature TO to the input variable x(5), inputs the vehicle speed SPD to the input variable x(6), and inputs the previous estimated value of the discharge fuel temperature TF to the input variable x(7). Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

Next, the CPU 72 calculates an estimated value yf of the discharge fuel temperature TF of the high-pressure fuel pump 39, which is the output value of the mapping, by inputting the input variables x(1) to x(7) to the mapping defined by the mapping data 76a stored in the storage device 76 illustrated in FIG. 1 (S1218).

In the present embodiment, the mapping includes a neural network in which the number of intermediate layers is “a”, activation functions h1 to hoc of each intermediate layer are hyperbolic tangents, and an activation function f of the output layer is ReLU. Note that, the ReLU is a function that outputs the greater of the input and zero, or zero when the input is zero. For example, the value of each node in the first intermediate layer is generated by inputting the output when the input variables x(1) to x(sn) are input to the linear mapping defined by coefficients w(1)ji (j=0 to n1, i=0 to sn) to the activation function h1. That is, assuming that m=1, 2, . . . , α, the value of each node of the m-th intermediate layer is generated by inputting the output of the linear mapping defined by the coefficient w(m) to the activation function hm. Here, the values n1, n2, . . . , nα are the numbers of nodes of the first, second, . . . , α-th intermediate layers, respectively. Incidentally, w(1)j0 and the like are bias parameters, and the input variable x(0) is defined as “1”.

Next, the CPU 72 determines whether or not the estimated value yf of the discharge fuel temperature TF is lower than a first set temperature TL (S1220). When determination is made that the estimated value yf of the discharge fuel temperature TF is lower than the first set temperature TL (S1220: YES), the CPU 72 performs a coping process such that a fuel pressure PT downstream of the high-pressure fuel pump 39 and upstream of the fuel injection valve 20 becomes a fuel pressure P1 (S1222).

Meanwhile, when determination is made that the estimated value yf of the discharge fuel temperature TF is equal to or higher than the first set temperature TL (S1220: NO), the CPU 72 determines whether or not the estimated value yf of the discharge fuel temperature TF is lower than a second set temperature TM which is higher than the first set temperature TL (S1224). When determination is made that the estimated value yf of the discharge fuel temperature TF is lower than the second set temperature TM (S1224: YES), the CPU 72 performs a coping process such that the fuel pressure PT downstream of the high-pressure fuel pump 39 and upstream of the fuel injection valve 20 becomes a fuel pressure P2 higher than the fuel pressure P1 (S1226).

When determination is made that the estimated value yf of the discharge fuel temperature TF is equal to or higher than the second set temperature TM (S1224: NO), the CPU 72 performs a coping process such that the fuel pressure PT downstream of the high-pressure fuel pump 39 and upstream of the fuel injection valve 20 becomes a fuel pressure P3 higher than the second fuel pressure P2 (S1228).

When the process of S1222 is completed, or when the processes of S1226 and S1228 are completed, the CPU 72 temporarily ends the series of processes illustrated in FIG. 20. When the value acquired in S1210 exceeds the upper limit guard value (S1212: NO), the CPU 72 performs a guard process of matching the acquired value to the upper limit guard value (S1230). As a result, the acquired value exceeding the upper limit guard value is reset as the same value as the upper limit guard value, and then the above-described processes of S1216 to S1228 are performed.

When the value acquired in S1210 is less than the lower limit guard value (S1214: NO), the CPU 72 performs a guard process of matching the acquired value to the lower limit guard value (S1232). As a result, the acquired value less than the lower limit guard value is reset as the same value as the lower limit guard value, and then the above-described processes of S1216 to S1228 are performed.

Note that, in the system that generates the mapping data 76a according to the present embodiment, the sensor group 102 includes a fuel temperature sensor that detects the temperature of the fuel injected by the high-pressure fuel pump 39. Then, in generating the mapping data 76a, the fuel temperature detected by the fuel temperature sensor after a predetermined time is used as teacher data.

According to the above embodiment, the technique for the guard process can be applied in determining an estimated value of the discharge fuel temperature TF of the high-pressure fuel pump 39 of the internal combustion engine 10 after a predetermined time as the state of the internal combustion engine 10.

### Fifteenth Embodiment

Hereinafter, a fifteenth embodiment will be described with reference to the drawings, focusing on differences from the above-described first embodiment.

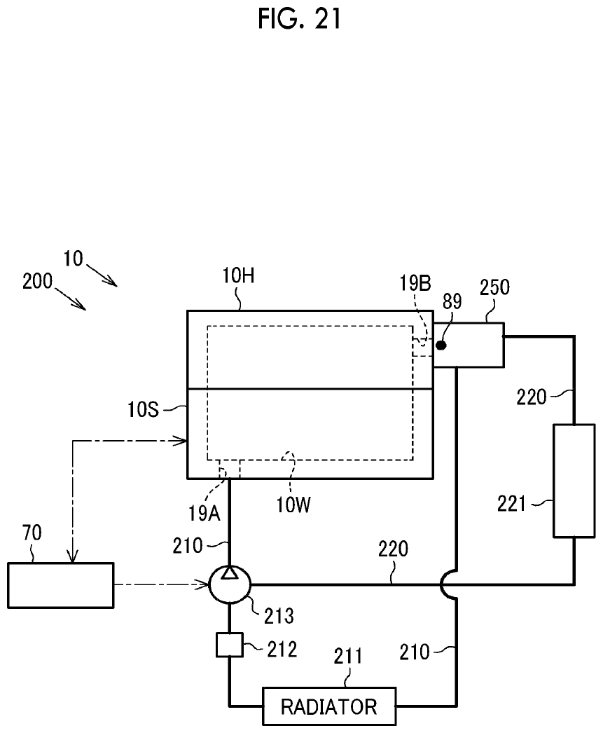

FIG. 21 illustrates an engine coolant circulation system 200 for cooling the internal combustion engine 10. As illustrated in FIG. 21, a water jacket 10W through which coolant flows is provided in a cylinder block 10S and a cylinder head 10H of the internal combustion engine 10. Note that, the water jacket 10W provided in the cylinder head 10H cools a wall on an intake port and a wall on a top surface of the combustion chamber 18.

An outlet 19B of the water jacket 10W provided in the cylinder head 10H is connected to a branch portion 250 for diverting the coolant that has passed through the water jacket 10W of the internal combustion engine 10. In addition, the coolant temperature sensor 89 that detects the coolant temperature THW, which is a temperature of the coolant, is provided near the outlet 19B.

An inlet 19A of the water jacket 10W provided in the cylinder block 10S and the branch portion 250 are connected by a first pipe 210. The first pipe 210 is provided with a radiator 211 for cooling the coolant through heat exchange with the outside air, a thermostat 212, and an electric water pump 213 in order from the upstream in the flow direction of the coolant. When the thermostat 212 is open, the coolant that has passed through the water jacket 10W returns to the water jacket 10W via the branch portion 250, the radiator 211, the thermostat 212, and the water pump 213. When the thermostat 212 is closed, the circulation of the coolant in the first pipe 210 stops.

Further, the branch portion 250 and the water pump 213 are connected by a second pipe 220. The second pipe 220 is provided with a heat exchanger 221 that exchanges heat with coolant. The heat exchanger 221 includes, for example, a heater core that heats air blown into a vehicle cabin, or the like. The coolant that has passed through the water pump 213 returns to the water jacket 10W via the branch portion 250, the heat exchanger 221, and the water pump 213, and during the operation of the water pump 213, the coolant in the second pipe 220 circulates regardless of whether the thermostat 212 is open or closed. In the present embodiment, the first pipe 210 functions as a bypass passage, and the second pipe 220 functions as a main passage.

In the present embodiment, the state determination device for an internal combustion engine is configured as a device that determines the presence or absence of an abnormality of the thermostat 212 of the internal combustion engine 10. In the ROM 74 of the state determination device for the internal combustion engine 10 according to the present embodiment, a program for determining the presence or absence of an abnormality of the thermostat 212 of the internal combustion engine 10 is stored as the determination program 74a.

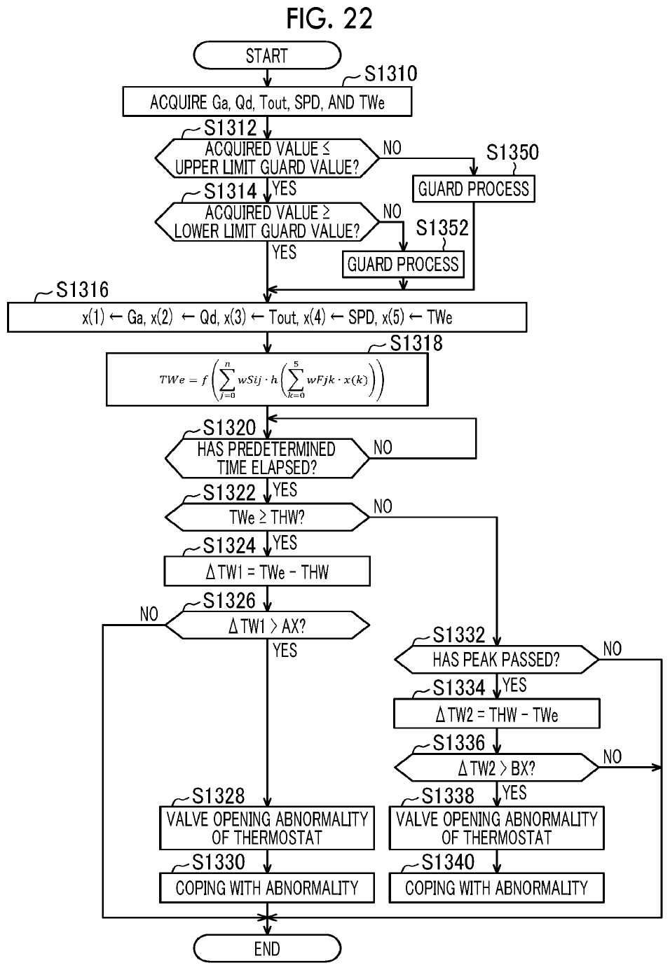

FIG. 22 illustrates a procedure of processes executed by the control device 70 in the present embodiment. The process illustrated in FIG. 22 is realized by the CPU 72 repeatedly executing the determination program 74a stored in the ROM 74 illustrated in FIG. 1 at a predetermined cycle, for example.

First, the CPU 72 acquires the intake air amount Ga, the requested injection amount Qd, the outside air temperature Tout, the vehicle speed SPD, and a previous value of an estimated value TWe of the coolant temperature THW, which is previously estimated (S1310). Note that, when the process of S1310 is first performed after the internal combustion engine 10 is started, the coolant temperature THW obtained by the coolant temperature sensor 89 at the time of starting the internal combustion engine 10 is acquired as the previous value of the estimated value TWe of the coolant temperature THW.

Next, the CPU 72 determines whether or not each of the values acquired in S1310 is equal to or less than an upper limit guard value determined according to each acquired value (S1312). The upper limit guard value is set for each type of the acquired values, and an upper limit guard value of the intake air amount Ga, an upper limit guard value of the requested injection amount Qd, an upper limit guard value of the outside air temperature Tout, an upper limit guard value of the vehicle speed SPD, and an upper limit guard value of the coolant temperature THW are set.

When the acquired value is equal to or less than the upper limit guard value (S1312: YES), the CPU 72 determines whether or not each of the values acquired in S1310 is equal to or greater than a lower limit guard value determined according to each acquired value (S1314). The lower limit guard value is set for each type of the acquired values, and a lower limit guard value of the intake air amount Ga, a lower limit guard value of the requested injection amount Qd, a lower limit guard value of the outside air temperature Tout, a lower limit guard value of the vehicle speed SPD, and a lower limit guard value of the coolant temperature THW are set. Note that, each upper limit guard value is within the range of data input when mapping data 76a stored in the storage device 76 is learned by machine learning, and is defined as the upper limit value of the input data.

When the acquired value is equal to or greater than the lower limit guard value (S1314: YES), the CPU 72 assigns each acquired value to an input variable of a mapping that outputs the estimated value TWe of the coolant temperature THW after a predetermined time (S1316). That is, the CPU 72 inputs the intake air amount Ga to the input variable x(1), inputs the requested injection amount Qd to the input variable x(2), inputs the outside air temperature Tout to the input variable x(3), inputs the vehicle speed SPD to the input variable x(4), and inputs the previous value of the estimated value TWe of the coolant temperature THW to the input variable x(5). Note that, each lower limit guard value is within the range of data input when mapping data 76a stored in the storage device 76 is learned by machine learning, and is defined as the lower limit value of the input data. In the embodiment, for each of the input values, the range from the lower limit guard value to the upper limit guard value is an allowable range of the input value, and the allowable range matches the range of data input when the data is learned by machine learning.

Next, the CPU 72 calculates an estimated value TWe of the coolant temperature THW after a predetermined time, which is the output value of the mapping, by inputting the input variables x(1) to x(5) to the mapping defined by the mapping data 76a stored in the storage device 76 illustrated in FIG. 1 (S1318).

Next, the CPU 72 determines whether or not a predetermined time has elapsed (S1320). When the predetermined time has not elapsed (S1320: NO), the CPU 72 repeats the process of S1320. On the other hand, when the predetermined time has elapsed (S1320: YES), the CPU 72 determines whether or not the estimated value TWe of the coolant temperature THW after the predetermined time is equal to or higher than the coolant temperature THW at the same time, which is detected by the coolant temperature sensor 89. (S1322).

When the estimated value TWe of the coolant temperature THW is equal to or higher than the coolant temperature THW at the same time (S1322: YES), the CPU 72 calculates a coolant temperature difference ATW1 by subtracting the coolant temperature THW from the estimated value TWe (S1324). Next, the CPU 72 determines whether or not the coolant temperature difference ATW1 is greater than a threshold AX at the time of temperature increase (S1326). When the coolant temperature difference ΔTW1 is greater than the threshold AX at the time of temperature increase (S1326: YES), the CPU 72 determines that a valve opening abnormality in which the thermostat 212 keeps opening has occurred (S1328). Then, the CPU 72 executes a coping process corresponding to the valve opening abnormality of the thermostat 212 (S1330).

On the other hand, when the estimated value TWe of the coolant temperature THW is lower than the coolant temperature THW at the same time (S1322: NO), the CPU 72 determines whether or not the estimated value TWe of the coolant temperature THW has passed a peak of the value calculated from the start of the internal combustion engine 10 to the current time (S1332).

When the estimated value TWe has passed the peak (S1332: YES), that is, when the transition of the estimated value TWe is decreasing, the CPU 72 calculates a coolant temperature difference ΔTW2 by subtracting the estimated value TWe from the coolant temperature THW detected by the coolant temperature sensor 89 (S1334). Next, the CPU 72 determines whether or not the coolant temperature difference ΔTW2 is greater than a threshold BX at the time of temperature drop (S1336). When the coolant temperature difference ΔTW2 is greater than the threshold BX at the time of temperature drop (S1336: YES), the CPU 72 determines that a valve opening abnormality in which the thermostat 212 keeps opening has occurred (S1338). Then, the CPU 72 executes a coping process corresponding to the valve opening abnormality of the thermostat 212 (S1340).

When the processes of S1330 and S1340 are completed, or when a negative determination is made in the processes of S1326, S1332, and S1336, the CPU 72 temporarily ends the series of processes illustrated in FIG. 22.

When the value acquired in S1310 exceeds the upper limit guard value (S1312: NO), the CPU 72 performs a guard process of matching the acquired value to the upper limit guard value (S1350). As a result, the acquired value exceeding the upper limit guard value is set as the value of the upper limit guard value, and then the above-described processes of S1316 to S1340 are performed.

When the value acquired in S1310 is less than the lower limit guard value (S1314: NO), the CPU 72 performs a guard process of matching the acquired value to the lower limit guard value (S1352). As a result, the acquired value less than the lower limit guard value is set as the value of the lower limit guard value, and then the above-described processes of S1316 to S1340 are performed.

Note that, in the system that generates the mapping data 76a according to the present embodiment, the sensor group 102 includes the coolant temperature sensor 89. Then, in generating the mapping data 76a, the coolant temperature THW detected by the coolant temperature sensor 89 after a predetermined time is used as teacher data.

According to the above embodiment, the technique for the guard process can be applied in determining the presence or absence of an abnormality of the thermostat 212 of the internal combustion engine 10 as the state of the internal combustion engine 10. Correspondence

The correspondence between the matters in the above embodiments and the matters described in the “SUMMARY” section is as follows. The following shows the correspondence between the solutions described in the “SUMMARY”. [1] A state determination device corresponds to the control device 70. An execution device corresponds to the CPU 72 and the ROM 74 in the first and third to fifteenth embodiments, and corresponds to the CPUs 72, 122 and the ROMs 74, 124 in the second embodiment. A storage device corresponds to the storage device 76 in the first and third to fifteenth embodiments, and corresponds to the storage device 126 in the second embodiment. A guard process corresponds to, for example, S15 and S16 of the first embodiment. [2] An allowable range corresponds to a range equal to or greater than the lower limit guard value and equal to or less than the upper limit guard value. [3] An upper limit value of the allowable range corresponds to the upper limit guard value. A lower limit value of the allowable range corresponds to the lower limit guard value. [4] A catalyst corresponds to the upstream catalyst 34. A fluid energy variable corresponds to the set data of the exhaust temperature average value Texuave and the intake air amount Ga, and the like. An outside air temperature variable corresponds to the outside air temperature Tout, and an excess amount variable corresponds to the set data of the upstream average value Afuave and the intake air amount Ga, and the fuel excess or deficiency amount average value Qiave. An acquisition process corresponds to the process of S10. [5] A first interval corresponds to 720° CA, a second interval corresponds to 30° CA, and an instantaneous speed parameter corresponds to minute rotation time T30. An acquisition process corresponds to the processes of S110 and S111. [6] A predetermined rotation angle interval corresponds to 720° CA. An air-fuel ratio detection variable corresponds to the upstream average value Afuave. An instantaneous speed variable corresponds to the minute rotation time T30. A plurality of rotation waveform variables corresponds to the minute rotation times T30(1) to T30(24). A third interval corresponds to 30° CA, and a fourth interval corresponds to 30° CA. An acquisition process corresponds to the process of S211. [7] time-series data related to the excess amount variable corresponds to the respective time-series data of the upstream average value Afuave, the rotation speed NE, and the charging efficiency η. An acquisition process corresponds to the process of S310. [8] A warm-up operation amount variable corresponds to the ignition timing average value aigave and an amplitude value average value αave. Association data corresponds to data defining the processes of S430 to S442. An acquisition process corresponds to the process of S410. [9] An excess or deficiency amount variable corresponds to the fuel excess or deficiency amount-integrated value InQi. An acquisition process corresponds to the process of S510. [10] An intake air temperature variable corresponds to the intake air temperature TO, a wall variable corresponds to the coolant temperature THW, and a flow rate variable corresponds to the rotation speed NE and the charging efficiency η. An acquisition process corresponds to the process of S610. [11] An excess amount variable corresponds to the fuel excess or deficiency amount Qi, and a first predetermined period corresponds to the sampling period of Qd(1) to Qd(sn). An air-fuel ratio detection variable corresponds to the difference variable ΔAfu or the time difference maximum value dAfumax, and a second predetermined period corresponds to the sampling period of ΔAfu(1) to ΔAfu(sn) or dAfumax(1) to dAfumax(sn). An acquisition process corresponds to the processes of S718 and S720. [12] A variable related to the engine load corresponds to the charging efficiency η. An acquisition process corresponds to the processes of S810 and S816. [13] A variable representing the vibration of the internal combustion engine corresponds to the detection signal Snc from the knocking sensor 92. An acquisition process corresponds to the process of S910. [14] An intake air amount detector corresponds to the air flow meter 82. An intake air amount difference Δm corresponds to a difference between the calculated value mt of the amount of intake air passing through the throttle valve 14 and the intake air amount Ga detected by the air flow meter 82. An acquisition process corresponds to the process of S1010. [15] An acquisition process corresponds to the process of S1112. [16] A plurality of variables corresponds to the rotation speed NE, the charging efficiency η, the lubricating oil temperature Toil, the supply fuel amount FS to the high-pressure fuel pump 39, the intake air temperature TO, the vehicle speed SPD, the previous discharge fuel temperature TF from the high-pressure fuel pump 39. An acquisition process corresponds to the process of S1210. [17] An acquisition process corresponds to the process of S1310. [18] A first execution device corresponds to the CPU 72 and the ROM 74. A second execution device corresponds to the CPU 122 and the ROM 124. A vehicle-side transmission process corresponds to the process of S80 in FIG. 6. An external reception process corresponds to the process of S96 in FIG. 6. A “signal based on an output calculated in an output calculation process” corresponds to the signal related to the determination result. [19] A data analysis device corresponds to the center 120. [20] A control device for the internal combustion engine corresponds to the control device 70 illustrated in FIG. 5.

### Other Embodiments

Note that, the present embodiment can be modified and implemented as follows. The present embodiment and the following modification examples can be implemented in combination with each other within a technically consistent range.

### Regarding Guard Process

In the above embodiments, when the acquired value exceeds the upper limit guard value, the value is reset to the same value as the upper limit guard value. However, the value to be reset may be set closer to the upper limit guard value. In this regard, when the acquired value is less than the lower limit guard value, the value to be reset may be set closer to the lower limit guard value. That is, when the acquired value is out of the allowable range, the value to be reset may be set to a value close to or within the allowable range. In this case, for example, when the acquired value is an extremely large value or small value due to a sensor abnormality or the like, the value to be input can be made closer to the allowable range.

### Regarding Allowable Range

In the above embodiments, the allowable range matches the range of data input when the data is learned by machine learning, but the size of the allowable range is not limited thereto. For example, the size of the allowable range may be within the range of data input when the data is learned by machine learning. In this case, the output value from the mapping tends to fall within the range of the output at the time of the learning.

### Regarding Internal Combustion Engine State Variable

In the above embodiments, the internal combustion engine state variables input to the mapping are not limited to the examples of the above embodiments. The internal combustion engine state variable is not particularly limited as long as it is a parameter indicating the state of the internal combustion engine 10. For example, in the first embodiment, the outside air temperature Tout that functions as an outside air temperature variable, which is a variable related to the temperature of the outside air around the internal combustion engine 10, may be used instead of the upstream average value Afuave.

### Regarding State of Internal Combustion Engine

In the above embodiments, the state of the internal combustion engine 10 determined by the CPU 72 is not limited to the example of each of the embodiments.

### Regarding First Interval and Second Interval

In the above embodiments, the minute rotation time T30 as an instantaneous speed parameter at each of a plurality of continuous second intervals within a rotation angle interval of 720° CA, which is one combustion cycle, is used as an input parameter of a mapping for determining the presence or absence of a misfire. That is, the example in which the first interval is 720° CA and the second interval is 30° CA has been described, but the embodiment is not limited thereto. For example, the first interval may be a rotation angle interval longer than 720° CA. However, it is also not indispensable that the first interval is 720° CA or more. For example, an input of a mapping or the like that outputs data related to the probability that a misfire has occurred or a generated torque in a specific cylinder may be an interval of 720° CA or less, such as setting the first interval to 480° CA. At this time, it is desirable to set the rotation angle interval longer than the appearance interval of the compression top dead center. Note that, the above first interval includes the compression top dead center of the cylinder for which the probability that a misfire has occurred is to be obtained.

The second interval is not limited to 30° CA. For example, the angle interval may be less than 30° CA, such as 10° CA. However, the angle interval is not limited to 30° CA or less, but may be 45° CA or the like, for example.

### Regarding Third Interval and Fourth Interval

In the above embodiments, the third interval that is the sampling interval of the upstream average value Afuave used as the input of the mapping is not limited to 30° CA. For example, the angle interval may be less than 30° CA, such as 10° CA. However, the angle interval is not limited to 30° CA or less, but may be 45° CA or the like, for example.

The fourth interval that is a sampling interval of the minute rotation time T30 used as an input of the mapping is not limited to 30° CA. For example, the angle interval may be less than 30° CA, such as 10° CA. However, the angle interval is not limited to 30° CA or less, but may be 45° CA or the like, for example. Note that, it is not indispensable that the third interval and the fourth interval have the same size.

### Regarding Input of Mapping

In each of the above embodiments, the input of the mapping is not limited to the examples of the embodiments. For example, for some of a plurality of types of physical quantities used as the input of the mapping for detecting in the above embodiments and the like, instead of being directly input to a neural network or a regression equation, some principal components obtained by the principal component analysis thereof may be directly input to the neural network or the regression equation. However, when the principal component is used as the input of the neural network or the regression equation, it is not indispensable that merely a part of the input to the neural network or the regression equation is the principal component, and the entire input may be the principal component. Note that, when the principal component is used as the input of the mapping for detecting, the mapping data 76a, 126a include data defining the mapping for detecting that determines the principal component.

### Regarding State Determination System for Internal Combustion Engine

In the third to fifteenth embodiments, when the process of determining the state of the internal combustion engine 10 is performed, a state determination system for an internal combustion engine may be configured as in the second embodiment.

### Regarding Coping Process

The configuration of the coping process in the above embodiments is not limited to the examples of the above embodiments. For example, by operating the warning light 98, the fact that a misfire has occurred is alarmed through visual information, but the coping process is not limited thereto. For example, by operating a speaker, the fact that a misfire has occurred may be alarmed through auditory information. For example, the control device 70 illustrated in FIG. 1 may include the communicator 129, and may operate the communicator 129 to transmit a signal indicating that a misfire has occurred to a portable terminal of a user. This can be realized by installing an application program for performing the alarm process in the portable terminal of the user. As the coping process in the first embodiment, a part or all of the processes illustrated in FIG. 4 may be omitted. In this regard, the same applies to the variation in air-fuel ratio between the cylinders.

### Regarding Mapping Data

In each of the above embodiments, the configuration of the mapping data is not limited to the examples of the embodiments.

### Regarding Algorithms of Machine Learning

Algorithms of machine learning are not limited to those using neural networks. For example, a regression equation may be used. This corresponds to the above neural network having no intermediate layer. For example, a support vector machine may be used. In this case, the magnitude itself of the output value has no meaning, and whether or not a misfire has occurred is expressed according to whether or not the value is positive. In other words, a combustion state variable value has three or more values, and the magnitude of those values is different from the one expressing the magnitude of the probability of a misfire.

### Regarding Method of Generating Mapping Data

In the above embodiment, the method of generating the mapping data is not limited to the method of learning the data based on the rotation behavior of the crankshaft 24 when the dynamometer of the crankshaft 24 is connected and the internal combustion engine 10 is operated. For example, the data may be learned based on the rotation behavior of the crankshaft 24 when the internal combustion engine 10 is mounted on a vehicle and the vehicle travels. According to this, the influence of the rotation behavior of the crankshaft 24 due to the state of the road surface on which the vehicle travels can be reflected in the learning.

### Regarding Data Analysis Device

In the second embodiment, the processes in FIG. 6 may be performed by, for example, a portable terminal carried by a user. This can be realized by installing an application program for performing the processes in FIG. 6 in the portable terminal. Note that, at this time, the transmission and reception process of the vehicle ID may be deleted, for example, by setting the distance in which the data transmission is effective in the process of S80 to about the length of the vehicle.

### Regarding Execution Device

The execution device in each of the embodiments is not limited to a device that includes the CPUs 72, 122 and the ROMs 74, 124 and that executes software processing. For example, a dedicated hardware circuit (for example, an ASIC) that performs hardware processing on at least a part of the software-processed data in the above embodiments may be provided. That is, the execution device may have any one of the following configurations (a) to (c). (a) A processor that executes all of the above processing in accordance with a program, and a program storage device such as a ROM that stores the program are provided. (b) A processor and a program storage device that execute a part of the above processing in accordance with a program, and a dedicated hardware circuit that executes the remaining processing are provided. (c) A dedicated hardware circuit that executes all of the above processing is provided. Here, there may be a plurality of software execution devices provided with the processor and the program storage device, and a plurality of dedicated hardware circuits.

### Regarding Storage Device

In the first and second embodiments, the storage devices that store mapping data 76a, 126a and the ROMs 74, 124 which are storage devices that store the determination program 74a and the temperature estimation main program 124a are used as separate storage devices. However, the embodiments are not limited thereto. In this regard, the same applies to the storage device in the other embodiments.

### Regarding State of Internal Combustion Engine

The state of the internal combustion engine 10 determined by the determination process may be a state other than a misfire or an inter-cylinder air-fuel ratio imbalance. For example, even when a so called compression loss, in which the intake valve or the exhaust valve is stuck open to cause insufficient compression of the intake air in the cylinder, occurs in a specific cylinder, a variation occurs in the combustion state between the cylinders, and thus the rotation fluctuation of the crankshaft 24 increases. Therefore, when such a detection of the compression loss is performed using a mapping in which the above-described internal combustion engine state variables are used as inputs, the compression loss can be determined in a manner that reflects the influence on the rotation behavior of the crankshaft 24.

### Regarding Combination of Embodiments

A plurality of the determination programs 74a in each embodiment is installed, and the CPU 72 may determine a plurality of states of the internal combustion engine 10.

By combining the first and second embodiments, the vehicle VC may determine the misfire, while the center 120 may determine the misfire. By combining the second and third embodiments, the center 120 may determine the state of the misfire, while the vehicle VC may determine the state of the inter-cylinder air-fuel ratio imbalance.

### Regarding Center

In the second embodiment, the center 120 may not transmit the determination result of the misfire state to the vehicle VC. In this case, the determination result can be stored in the center 120 and used for research and development.

### Regarding Internal Combustion Engine

In the above embodiments, the in-cylinder injection valve that injects fuel into the combustion chamber 18 is exemplified as the fuel injection valve, but the embodiments are not limited thereto. For example, a port injection valve that injects fuel into the intake passage 12 may be used. For example, both a port injection valve and an in-cylinder injection valve may be provided. The internal combustion engine is not limited to a spark ignition type internal combustion engine, and may be, for example, a compression ignition type internal combustion engine using light oil or the like as fuel.

### Regarding Vehicle

Although the vehicle VC of the above embodiments has a configuration in which the lock-up clutch 62, the torque converter 60, and the transmission 64 are provided in the drive system, the vehicle may have a different drive system configuration.

What is claimed is:

1. An internal combustion engine comprising:
a state determination device including a storage device and an execution device, wherein:
the storage device is configured to store mapping data that is data defining a mapping that outputs a determination result of a state of the internal combustion engine by using, as an input, an internal combustion engine state variable that is a parameter indicating the state of the internal combustion engine;
the execution device is configured to execute an acquisition process of acquiring the internal combustion engine state variable, and a determination process of determining the state of the internal combustion engine based on an output of the mapping using the internal combustion engine state variable as an input;
the mapping data is data that has been learned by machine learning;
the execution device is configured to, when the internal combustion engine state variable acquired in the acquisition process is out of a predetermined allowable range, execute a guard process of bringing the internal combustion engine state variable closer to the allowable range or making the internal combustion engine state variable be a value within the allowable range; and
the execution device is configured to, when the guard process is executed, determine the state of the internal combustion engine based on the internal combustion engine state variable acquired after the guard process, in the subsequent determination process.

2. The internal combustion engine according to claim 1, wherein the allowable range is set within a range of data input when the data is learned by the machine learning.

3. The internal combustion engine according to claim 1, wherein:
the execution device is configured to, when the internal combustion engine state variable acquired in the acquisition process is larger than the allowable range, execute a guard process of matching the internal combustion engine state variable to an upper limit value of the allowable range; and
the execution device is configured to, when the internal combustion engine state variable acquired in the acquisition process is smaller than the allowable range, execute a guard process of matching the internal combustion engine state variable to a lower limit value of the allowable range.

4. The internal combustion engine according to claim 1, wherein:
the state of the internal combustion engine is an estimated value of a temperature of a catalyst provided in an exhaust passage of the internal combustion engine;
the mapping data is data defining a mapping that outputs the estimated value of the temperature of the catalyst by using, as an input, at least one of an outside air temperature variable and an excess amount variable, a fluid energy variable, and a previous value of the estimated value of the temperature of the catalyst, the outside air temperature variable being a variable related to a temperature of outside air around the internal combustion engine, the excess amount variable being a variable corresponding to an excess amount of an actual injection amount with respect to an amount of fuel needed for setting an air-fuel ratio of an air-fuel mixture in a combustion chamber of the internal combustion engine to a stoichiometric air-fuel ratio, the fluid energy variable being a state variable related to an energy of a fluid flowing into the catalyst; and
the execution device is configured to acquire the at least one variable, the fluid energy variable, and the previous value of the estimated value, in the acquisition process.

5. The internal combustion engine according to claim 1, wherein:
the state of the internal combustion engine is a presence or absence of a misfire of the internal combustion engine;
the mapping data is data defining a mapping that outputs a probability that the misfire has occurred in the internal combustion engine by using, as an input, time-series data that is an instantaneous speed parameter at each of a plurality of continuous second intervals included in a first interval;
the execution device is configured to acquire the instantaneous speed parameter based on a detection value of a sensor that detects a rotation behavior of a crankshaft of the internal combustion engine in the acquisition process;
the instantaneous speed parameter is a parameter corresponding to a rotation speed of the crankshaft of the internal combustion engine;
the first interval is a rotation angle interval of the crankshaft and includes a compression top dead center;
the second interval is smaller than an appearance interval of the compression top dead center; and
the mapping outputs a probability that the misfire has occurred in at least one cylinder in which the compression top dead center appears within the first interval.

6. The internal combustion engine according to claim 1, wherein:
the state of the internal combustion engine is a variation in air-fuel ratio between a plurality of cylinders included in the internal combustion engine;
the mapping data is data defining a mapping that outputs an imbalance variable by using, as an input, a rotation waveform variable and an air-fuel ratio detection variable, the imbalance variable being a variable indicating a degree of variation between actual air-fuel ratios when a fuel injection valve is operated to control air-fuel ratios of air-fuel mixtures in the respective cylinders to be equal to each other, the air-fuel ratio detection variable being a variable corresponding to an output of an air-fuel ratio sensor at each of a plurality of third intervals;
the execution device is configured to acquire the rotation waveform variable based on a detection value of a sensor that detects a rotation behavior of a crankshaft, in the acquisition process and the air-fuel ratio detection variable at each of the third intervals;
the rotation waveform variable is a variable indicating a difference between instantaneous speed variables that are variables corresponding to the rotation speed of the crankshaft at each of a plurality of fourth intervals;
both the third interval and the fourth interval are angle intervals of the crankshaft smaller than an appearance interval of a compression top dead center; and
the rotation waveform variable and a plurality of the air-fuel ratio detection variables that are used as an input of the mapping are time-series data within a predetermined angle interval larger than the appearance interval.

7. The internal combustion engine according to claim 1, wherein:
the state of the internal combustion engine is a degree of deterioration of a catalyst provided in an exhaust passage of the internal combustion engine;
the mapping data is data defining a mapping that outputs a deterioration degree variable by using, as an input, time-series data of an excess amount variable in a first predetermined period, and time-series data of a downstream detection variable in a second predetermined period, the deterioration degree variable being a variable related to the degree of deterioration of the catalyst, the excess amount variable being a variable corresponding to an excess amount of an actual injection amount with respect to an amount of fuel needed for setting an air-fuel ratio of an air-fuel mixture in a combustion chamber of the internal combustion engine to a stoichiometric air-fuel ratio, the downstream detection variable being a variable corresponding to a detection value of an air-fuel ratio sensor on a downstream side of the catalyst; and
the execution device is configured to acquire the time-series data of the excess amount variable in the first predetermined period and the time-series data of the downstream detection variable in the second predetermined period, in the acquisition process.

8. The internal combustion engine according to claim 1, wherein:
the state of the internal combustion engine is a presence or absence of an abnormality in a warm-up process of a catalyst provided in an exhaust passage of the internal combustion engine;
the storage device is configured to store association data that associates an integrated value of an intake air amount of the internal combustion engine from a start of the internal combustion engine with a temperature of the catalyst;
the mapping data is data defining a mapping that outputs an estimated value of the temperature of the catalyst by using, as an input, a warm-up operation amount variable and a previous value of the estimated value of the temperature of the catalyst, the warm-up operation amount variable being a variable related to an operation amount of an operation unit of the internal combustion engine that is used for the warm-up process of the catalyst; and
the execution device is configured to
acquire the warm-up operation amount variable and the previous value of the estimated value of the temperature of the catalyst, in the acquisition process, and
determine that the warm-up process is abnormal when a correspondence between the integrated value of the intake air amount of the internal combustion engine from the start of the internal combustion engine and the estimated value of the temperature of the catalyst is different from a correspondence between the integrated value of the intake air amount of the internal combustion engine from the start of the internal combustion engine and the temperature of the catalyst in the association data, in the determination process.

9. The internal combustion engine according to claim 1, wherein:
the state of the internal combustion engine is an estimated value of an oxygen storage amount of a catalyst provided in an exhaust passage of the internal combustion engine;
the mapping data is data defining a mapping that outputs a storage amount variable by using, as an input, an excess or deficiency amount variable and a plurality of variables including some of previous values of the storage amount variable that is a variable related to the oxygen storage amount of the catalyst, the storage amount variable being a variable corresponding to an excess or deficiency amount of an actual fuel amount with respect to an amount of fuel that reacts with an oxygen contained in a fluid flowing into the catalyst without excess or deficiency; and
the execution device is configured to acquire the plurality of variables in the acquisition process.

10. The internal combustion engine according to claim 1, wherein:
the state of the internal combustion engine is an estimated value of an amount of PM collected by a filter that collects PM in an exhaust gas discharged into an exhaust passage of the internal combustion engine;
the mapping data is data defining a mapping that outputs the amount of PM collected by the filter by using, as an input, at least one of an intake air temperature variable and a wall variable, and a flow rate variable, the intake air temperature variable being a variable related to a temperature of air taken into the internal combustion engine, the wall variable being a variable related to a cylinder wall temperature of the internal combustion engine, the flow rate variable being a variable indicating a flow rate of a fluid flowing into the filter; and
the execution device is configured to acquire the at least one variable and the flow rate variable in the acquisition process.

11. The internal combustion engine according to claim 1, wherein:
the state of the internal combustion engine is a presence or absence of an abnormality of an air-fuel ratio sensor provided in an exhaust passage of the internal combustion engine;
the mapping data is data defining a mapping that outputs an abnormality determination variable by using, as an input, time-series data of an excess amount variable in a third predetermined period, and time-series data of an air-fuel ratio detection variable in a fourth predetermined period, the abnormality determination variable being a variable related to a presence or absence of an abnormality in which responsiveness of the air-fuel ratio sensor is reduced, the excess amount variable being a variable corresponding to an excess amount of an actual injection amount with respect to an amount of fuel needed for setting an air-fuel ratio of an air-fuel mixture in a combustion chamber of the internal combustion engine to a stoichiometric air-fuel ratio, the air-fuel ratio detection variable being a variable related to a detection value of the air-fuel ratio sensor; and
the execution device is configured to acquire the time-series data of the excess amount variable in the third predetermined period and the time-series data of the air-fuel ratio detection variable in the fourth predetermined period, in the acquisition process.

12. The internal combustion engine according to claim 1, further comprising:
an exhaust gas recirculation passage connected to an exhaust passage and an intake passage; and
an exhaust gas recirculation valve that adjusts a flow rate of exhaust gas flowing into the intake passage from the exhaust passage via the exhaust gas recirculation passage, wherein
the state of the internal combustion engine is a presence or absence of an abnormality of at least one of the exhaust gas recirculation passage or the exhaust gas recirculation valve,
the storage device is configured to store an exhaust gas recirculation rate as a function of a variable related to an engine load and a variable related to a rotation speed of a crankshaft of the internal combustion engine, the exhaust gas recirculation rate being a ratio of an amount of exhaust gas recirculation to a sum of air taken into the intake passage and the amount of exhaust gas recirculation flowing into the intake passage via the exhaust gas recirculation passage;
an opening degree of the exhaust gas recirculation valve is controlled such that the exhaust gas recirculation rate becomes a target exhaust gas recirculation rate;
the mapping data is data defining a mapping that outputs an estimated value of the target exhaust gas recirculation rate by using, as an input, the variable related to the engine load, the rotation speed of the crankshaft of the internal combustion engine, an intake pressure in the intake passage downstream of a throttle valve, and an intake air amount of the internal combustion engine;
the execution device is configured to acquire the variable related to the engine load, the rotation speed of the crankshaft of the internal combustion engine, the intake pressure in the intake passage downstream of the throttle valve, and the intake air amount of the internal combustion engine, in the acquisition process; and
the execution device is configured to determine a presence or absence of an abnormality of at least one of the exhaust gas recirculation passage or the exhaust gas recirculation valve based on a difference between the estimated value of the target exhaust gas recirculation rate and the target exhaust gas recirculation rate, in the determination process.

13. The internal combustion engine according to claim 1, wherein:
the state of the internal combustion engine is an estimated value of a knocking intensity of the internal combustion engine;
the mapping data is data defining a mapping that outputs an estimated value of the knocking intensity by using, as an input, a variable representing a vibration of the internal combustion engine detected by a knocking sensor that detects the vibration of the internal combustion engine;
in a learning stage, a value representing the knocking intensity is acquired from an output value of a pressure sensor that detects a pressure in a combustion chamber of the internal combustion engine, and machine learning is performed using the acquired value representing the knocking intensity as teacher data; and
the execution device is configured to acquire the variable representing the vibration of the internal combustion engine detected by the knocking sensor, in the acquisition process.

14. The internal combustion engine according to claim 1, further comprising:
an intake air amount detector provided in an intake passage;
a throttle valve provided downstream of the intake air amount detector in the intake passage; and
a blow-by gas delivery path, wherein
the state of the internal combustion engine is a presence or absence of a leakage abnormality of blow-by gas from a blow-by gas delivery path;
the blow-by gas is sent downstream of a throttle valve in the intake passage via the blow-by gas delivery path;
the mapping data is data defining a mapping that outputs a leakage determination value of the blow-by gas from the blow-by gas delivery path by using, as an input, an intake air amount difference between an amount of intake air passing through the throttle valve and an intake air amount detected by the intake air amount detector, a variable related to an engine load, and a variable related to a rotation speed of a crankshaft of the internal combustion engine; and
the execution device is configured to acquire the intake air amount difference, the variable related to the engine load, and the variable related to the rotation speed, in the acquisition process.

15. The internal combustion engine according to claim 1, further comprising:
a canister collecting fuel vapor in a fuel tank that stores fuel injected from a fuel injection valve; a purge passage connecting the canister and an intake passage of the internal combustion engine; and
a purge control valve provided in the purge passage, wherein
the state of the internal combustion engine is a presence or absence of a perforation abnormality that causes the fuel vapor to leak;
the mapping data is data defining a mapping that outputs a leakage determination value of the fuel vapor by using, as an input, a pressure in the canister detected by a pressure sensor at a predetermined time interval and an atmospheric pressure when an inside of the fuel tank and an inside of the canister are controlled to a negative pressure when drive of the internal combustion engine is stopped; and
the execution device is configured to acquire the pressure in the canister detected by the pressure sensor at the predetermined time interval and the atmospheric pressure when the inside of the fuel tank and the inside of the canister are controlled to the negative pressure when drive of the internal combustion engine is stopped, in the acquisition process.

16. The internal combustion engine according to claim 1, further comprising a high-pressure fuel pump for fuel injection that is driven by rotation of a crankshaft and supplies fuel to a fuel injection valve, wherein
the state of the internal combustion engine is an estimated value of a discharge fuel temperature of the high-pressure fuel pump after a predetermined time;
the mapping data is data defining a mapping that outputs the estimated value of the discharge fuel temperature of the high-pressure fuel pump after the predetermined time by using, as an input, a plurality of variables including a variable related to a rotation speed of the crankshaft of the internal combustion engine, a variable related to an engine load, a variable related a lubricating oil temperature, a variable related to a supply fuel amount to the high-pressure fuel pump, a variable related to an intake air temperature of the internal combustion engine, a variable related to the discharge fuel temperature from the high-pressure fuel pump, and a variable related to a vehicle speed; and
the execution device is configured to acquire the variables in the acquisition process.

17. The internal combustion engine according to claim 1, further comprising an engine coolant circulation system for cooling the internal combustion engine, wherein:
the engine coolant circulation system includes a water pump, a main passage through which a coolant flowing out of the water pump returns to the water pump via a water jacket and a radiator inside the internal combustion engine, a bypass passage branched from the main passage and bypassing the radiator, and a thermostat that adjusts a flow of the coolant returning from the main passage and the bypass passage to the water pump;
the state of the internal combustion engine is a presence or absence of an abnormality of the thermostat;
the mapping data is data defining a mapping that outputs an estimated value of a coolant temperature by using, as an input, a previous value of the estimated value of the coolant temperature of the internal combustion engine, an intake air amount of the internal combustion engine, a variable related to a fuel injection amount of the internal combustion engine, an outside air temperature, and a variable related to a vehicle speed; and
the execution device is configured to acquire the previous value of the estimated value of the coolant temperature of the internal combustion engine, the intake air amount of the internal combustion engine, the variable related to the fuel injection amount of the internal combustion engine, the outside air temperature, and the variable related to the vehicle speed, in the acquisition process.

18. A state determination system for an internal combustion engine, the state determination system comprising a state determination device including a storage device and an execution device, wherein:
the storage device is configured to store mapping data that is data defining a mapping that outputs a determination result of a state of the internal combustion engine by using, as an input, an internal combustion engine state variable that is a parameter indicating the state of the internal combustion engine;
the execution device is configured to execute an acquisition process of acquiring the internal combustion engine state variable, and a determination process of determining the state of the internal combustion engine based on an output of the mapping using the internal combustion engine state variable as an input;
the mapping data is data that has been learned by machine learning;
the execution device is configured to, when the internal combustion engine state variable acquired in the acquisition process is out of a predetermined allowable range, execute a guard process of bringing the internal combustion engine state variable closer to the allowable range or making the internal combustion engine state variable be a value within the allowable range;
the execution device is configured to, when the guard process is executed, determine the state of the internal combustion engine based on the internal combustion engine state variable acquired after the guard process, in the subsequent determination process;
the execution device includes a first execution device and a second execution device;
the first execution device is mounted on a vehicle, and is configured to execute the acquisition process, a vehicle-side transmission process of transmitting data acquired in the acquisition process to an outside of the vehicle, a vehicle-side reception process of receiving a signal based on an output determined in the determination process; and
the second execution device is disposed outside the vehicle, and is configured to execute an external reception process of receiving the data transmitted in the vehicle-side transmission process, the determination process, and an external transmission process of transmitting a signal based on an output detected in the determination process to the vehicle.

19. A data analysis device comprising a state determination device including a storage device and an execution device, wherein:
the storage device is configured to store mapping data that is data defining a mapping that outputs a determination result of a state of an internal combustion engine by using, as an input, an internal combustion engine state variable that is a parameter indicating the state of the internal combustion engine;
the execution device is configured to execute a determination process of determining the state of the internal combustion engine based on an output of the mapping using the internal combustion engine state variable as an input;
the mapping data is data that has been learned by machine learning;
the execution device is configured to, when the internal combustion engine state variable acquired in an acquisition process is out of a predetermined allowable range, execute a guard process of bringing the internal combustion engine state variable closer to the allowable range or making the internal combustion engine state variable be a value within the allowable range;
the execution device is configured to, when the guard process is executed, determine the state of the internal combustion engine based on the internal combustion engine state variable acquired after the guard process, in the subsequent determination process;
the execution device is disposed outside a vehicle, and is configured to execute an external reception process of receiving the data that acquired in the acquisition process and transmitted in a vehicle-side transmission process, the determination process, and an external transmission process of transmitting a signal based on an output detected in the determination process to the vehicle.

20. A control device for an internal combustion engine, the control device comprising a state determination device including a storage device and an execution device, wherein:
the storage device is configured to store mapping data that is data defining a mapping that outputs a determination result of a state of the internal combustion engine by using, as an input, an internal combustion engine state variable that is a parameter indicating the state of the internal combustion engine;
the execution device is configured to execute an acquisition process of acquiring the internal combustion engine state variable, and a determination process of determining the state of the internal combustion engine based on an output of the mapping using the internal combustion engine state variable as an input;
the mapping data is data that has been learned by machine learning;
the execution device is configured to, when the internal combustion engine state variable acquired in the acquisition process is out of a predetermined allowable range, execute a guard process of bringing the internal combustion engine state variable closer to the allowable range or making the internal combustion engine state variable be a value within the allowable range;
the execution device is configured to, when the guard process is executed, determine the state of the internal combustion engine based on the internal combustion engine state variable acquired after the guard process, in the subsequent determination process;
the execution device is mounted on a vehicle, and is configured to execute the acquisition process, a vehicle-side transmission process of transmitting data acquired in the acquisition process to an outside of the vehicle, a vehicle-side reception process of receiving a signal based on an output determined in the determination process.
